(19) United States
(12) Patent Application Publication
(10) Pub. No.: US 2025/0149635 A1
(43) Pub. Date: May 8, 2025

(54) SILICATE PLATFORM AS WEAKLY-COORDINATING ANIONS FOR DIVERSE ORGANOMETALLIC TRANSFORMATIONS AND ELECTROCHEMICAL APPLICATIONS

(71) Applicant: California Institute of Technology, Pasadena, CA (US)

(72) Inventors: Tianyi HE, Pasadena, CA (US); Meaghan A. BRUENING, Pasadena, CA (US); Theodor AGAPIE, Pasadena, CA (US)

(73) Assignee: California Institute of Technology, Pasadena, CA (US)

(21) Appl. No.: 18/934,808

(22) Filed: Nov. 1, 2024

Related U.S. Application Data
(60) Provisional application No. 63/547,073, filed on Nov. 2, 2023.

(51) Int. Cl. H01M 10/0568; C07F 19/00; C08F 110/02; H01M 10/054

(52) U.S. Cl. CPC H01M 10/0568; C07F 19/00; C08F 110/02; H01M 10/054; H01M 2300/0025

(57) ABSTRACT

A new class of weakly coordinating anions (WCA) based on silicates is disclosed. Facile tuning of sterics and solubility of the disclosed WCA may be achieved via variation of R groups. The anions support a range of cations employed in chemical reactivity, including ether-free alkali cations, Ag⁺, Ph₃C⁺, Fc⁺, [Ni^{I}(COD)₂]⁺. In one aspect, [Pd(dppe)(NCMe)Me]⁺ may be generated by salt metathesis or protonation of a metal-alkyl bond, showcasing the ability of the anions to support applications in coordination chemistry and catalysis. Electrochemical studies on the [Bu₄N]⁺ variant show an exceptionally wide stability window for the ^{Me}Si^{F}₂₄_{^{−}} anion of 7.5 V in MeCN. CV experiments demonstrate reversible Mg deposition and stripping.

### CROSS-REFERENCE TO RELATED APPLICATIONS

This application claims the benefit of priority to U.S. Provisional Patent Application No. 63/547,073, filed Nov. 2, 2023, which is hereby incorporated by reference in its entirety.

### BACKGROUND OF INVENTION

Weakly-coordinating anions (WCAs) facilitate diverse chemistry stemming from access to highly electrophilic centers for olefin polymerization or C—H bond activation, from redox stability for battery electrolytes and electron transfer reactions, and from Bronsted superacidity. Typically, a WCA features: (1) Weak cation-anion interaction, (2) Low propensity to undergo oxidation/reduction, and (3) Low reactivity towards highly electrophilic fragments. Early examples of WCA include [PF₆]⁻, [BF₄]⁻, [O₃SCF₃]⁻ and [N(SO₂CF₃)₂]. These species typically feature wide redox stability windows and are frequently employed as supporting electrolytes for electrochemical studies of organometallic compounds because of their high redox stability and commercial availability. However, in the presence of highly electrophilic cations, these anions decompose via fluoride abstraction. Less nucleophilic anions such as borates, carboranes, and aluminates have been developed for a variety of transformations.

Borates that feature multiple electron-withdrawing aryl substituents, including tetrakis (pentafluorophenyl)borate ([B(C₆F₅)₄]⁻) and tetrakis-[3,5-(bistrifluoromethyl)phenyl]borate ([BAr^{F}₂₄]⁻), are commercially available. Electron-deficient aryl substituents impart high stability, high solubility, and low propensity to coordinate. The performance of [B(C₆F₅)₄]⁻ as a WCA is highlighted by its tolerance towards highly electrophilic cations such as zirconocene and silylium because of its robust Csₚ2-F bonds. Halogenated carborane anions, such as [HCB₁₂H₅Cl₆]⁻ and [HCB₁₂H₅Br₆]⁻, support Et₃Si⁺-catalyzed hydrodefluorination reactions with higher turnover numbers (TON) and conversion compared to [B(C₆F₅)₄]⁻. Weakly-coordinating aluminates with highly-fluorinated and bulky alkoxide alkoxide ligands support unusual, reactive motifs such as cationic binary P—X species (X=halogen), CS₂Br₃⁺, CX₃⁺(X=Br, I) that are otherwise unknown in the condensed phase. These more modern WCAs also support cations commonly used as reagents in coordination chemistry such as [H(OEt₂)₂]⁺, [Ph₃C]⁺, [Ag]+.

Because of their desirable redox stabilities and weak interactions with cations, WCA-supported alkali- and alkali-earth metal cations have attracted attention from the battery community. Commercially available anions such as [PF₆]⁻, [N(O₃SCF₃)]⁻, and [N(O₃SF)]⁻ are used routinely with Li⁺ and have seen limited success for Na⁺ and K⁺ battery applications. Bulkier, less nucleophilic WCA-supported electrolytes impart higher ionic conductivity, stability, and reversibility. Divalent battery electrolytes (Mg²⁺ and Ca²⁺) supported by traditional WCAs such as [BF₄]⁻, [PF₆]⁻, and [N(O₃SCF₃)]⁻ suffer from electrode surface passivation and high deposition overpotentials. Borates with mixed aryl- and alkyl-substituents have been shown to support reversible Mg deposition and stripping, although anodic stability is severely limited. Aluminates and borates featuring bulky and electron-withdrawing fluorinated alkoxide ligands such as [B(O(CH(CF₃)₂))₄]⁻, [Al(O(CH(CF₃)₂))₄]⁻ and [B(O₂C₂(CF₃)₄)₂]⁻ have been shown to support reversible Mg deposition and stripping, but suffer from synthetic reproducibility issues and require significant electrochemical conditioning in some cases. In addition, [B(O(CH(CF₃)₂))₄]⁻ has been reported to support Ca²⁺ deposition and stripping.

Whereas many reported WCA-based electrolytes are fluorinated, high degree of fluorination does not necessarily entail superior electrolyte performance. For example Mg[BAr^{F}₂₄]₂ decomposes before plating of Mg; similarly, Mg[Al(OC(CF₃)₃)₄]₂ suffers from reductive surface passivation, even in the presence of chloride-containing additives.³⁸ Monocarboranes Mg[HCB₁₁H₁₁]₂, Mg[HCB₉H₉]2, Mg[RCB₁₁H₁₁]₂ in glymes show exceptional electrochemical performance, but the costly and involved synthesis limits their widespread usage in either coordination chemistry or battery science. Therefore, the development of new weakly-coordinating anions including the following properties is of particular interest: 1) facile preparation and functionalization; 2) support of coordination chemistry applications; 3) wide redox window; and 4) support of metal deposition and stripping.

### SUMMARY OF THE INVENTION

Provided herein is new class of silicate anions comprised of a variety of ligands and bearing a variety of R¹ groups, enabling facile tuning of sterics and solubility.

In one embodiment, an electrochemical cell comprises:
an anode;
a cathode; and
an electrolyte in contact with the anode and the cathode, the electrolyte comprising a cation and a weakly coordinating anion in a solvent, the weakly coordinating anion having the formula:

[(R¹)ₘ—Si(Z)₂]⁻ (FX1)
or salts thereof;
wherein each Z is independently:

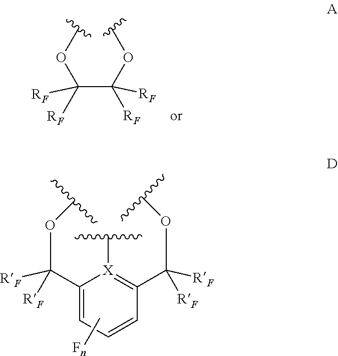

wherein:
   m is 1 when both of Z are A, or m is zero;
   X is C or N;
   Fₙ represents one, two or three F on the indicated ring;
   R_{F} is fluoroalkyl having 1-3 carbon atoms and two to seven fluorine atoms or fluorophenyl having 2-5 fluorine atoms on the ring;
   R′_{F} is fluoroalkyl having 1-3 carbon atoms and two to seven fluorine atoms or fluorophenyl having 2-5 fluorine atoms on the ring;
   R¹ is substituted or unsubstituted alkyl having 1-30 carbon atoms, substituted or unsubstituted alkenyl having 2-30 carbon atoms, substituted or unsubstituted cycloalkyl having 3-30 carbon atoms and at least one carbocyclic ring, substituted or unsubstituted heterocyclic having 3-30 carbon atoms, 1-4 heteroatoms and at least one heterocyclic ring, substituted or unsubstituted aryl having 1 or 2 aromatic rings which are optionally fused rings and having 5-30 carbon atoms, substituted or unsubstituted heteroaryl having 1 or 2 rings of which at least one is aromatic and which are optionally fused and having 3-30 carbon atoms and 1-4 heteroatoms, or substituted or unsubstituted alkoxyalkyl having 2-12 carbon atoms.

In one embodiment, a method of performing a chemical reaction comprises: providing a solution comprising a cation and a weakly coordinating anion reagent of the formula:

[(R¹)ₘ—Si(Z)₂]⁻ (FX1)
wherein each Z is independently:

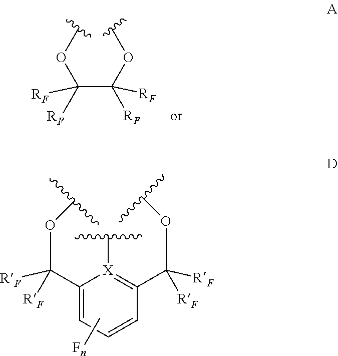

wherein:
   m is 1 when both of Z are A, or m is zero;
   X is C or N;
   Fₙ represents one, two or three F on the indicated ring;
   R_{F} is fluoroalkyl having 1-3 carbon atoms and two to seven fluorine atoms or fluorophenyl having 2-5 fluorine atoms on the ring;
   R′_{F} is fluoroalkyl having 1-3 carbon atoms and two to seven fluorine atoms or fluorophenyl having 2-5 fluorine atoms on the ring;
   R¹ is substituted or unsubstituted alkyl having 1-30 carbon atoms, substituted or unsubstituted alkenyl having 2-30 carbon atoms, substituted or unsubstituted cycloalkyl having 3-30 carbon atoms and at least one carbocyclic ring, substituted or unsubstituted heterocyclic having 3-30 carbon atoms, 1-4 heteroatoms and at least one heterocyclic ring, substituted or unsubstituted aryl having 1 or 2 aromatic rings which are optionally fused rings and having 5-30 carbon atoms, substituted or unsubstituted heteroaryl having 1 or 2 rings of which at least one is aromatic and which are optionally fused and having 3-30 carbon atoms and 1-4 heteroatoms, or substituted or unsubstituted alkoxyalkyl having 2-12 carbon atoms; and
   contacting in the solution one or more reactants with the weakly coordinating anion reagent, and/or the cation, thereby resulting in formation of one or more products.

In certain embodiments, said formation comprises a catalytic reaction. In certain embodiments, said formation comprises cation/anion exchange, halide abstraction, metalation, halide abstraction, chemical oxidation, dehydrofluorination, protonation and/or and any reactions that involve carbocations.

In certain embodiments, the cation is a precatalyst cation, the method comprising: activating the precatalyst cation by contacting the precatalyst cation with the weakly coordinating anion to form an activated catalyst; and contacting the activated catalyst with the one or more reactants. In certain embodiments, the activated catalyst is a catalytically active cation. In certain embodiments, the catalytically active cation comprises a metal coordination complex. In certain embodiments, the one or more reactants comprise monomers and wherein the product comprises a polymer. In certain embodiments, the reactants comprise at least two different monomers and wherein the product comprises a copolymer.

In certain embodiments, R¹ is a substituted or unsubstituted C₁-C₂₀ alkyl, substituted or unsubstituted C₂-C₂₀ alkenyl, substituted or unsubstituted C₂-C₂₀ alkynyl, and substituted or unsubstituted C₄-C₂₀ aryl. In certain embodiments, R¹ is a substituted or unsubstituted alkyl having 1-4 carbon atoms, a substituted or unsubstituted substituted alkenyl having 2-4 carbon atoms, a substituted or unsubstituted phenyl or benzyl group, or an alkoxyalkyl group having 2-12 carbon atoms.

In certain embodiments, R¹ is substituted with one or more halogens, one or more substituted or unsubstituted alkyl groups having 1-20 carbon atoms, one or more substituted or unsubstituted —OR¹ groups having 1 to 20 carbon atoms, one or more substituted or unsubstituted alkenyl groups having 1-6 carbon atoms, and/or one or more substituted or unsubstituted alkynyl groups having 1-6 carbon atoms. In certain embodiments, R¹ is fully fluorinated.

In certain embodiments, R¹ is selected from the group consisting of methyl, pentafluorophenyl, CH₂CH₂(CF₂)₅CF₃, decyl, styrene, vinyl, 4-^{t}Bu-C₆H₄, CH₂CH₂CF₃,

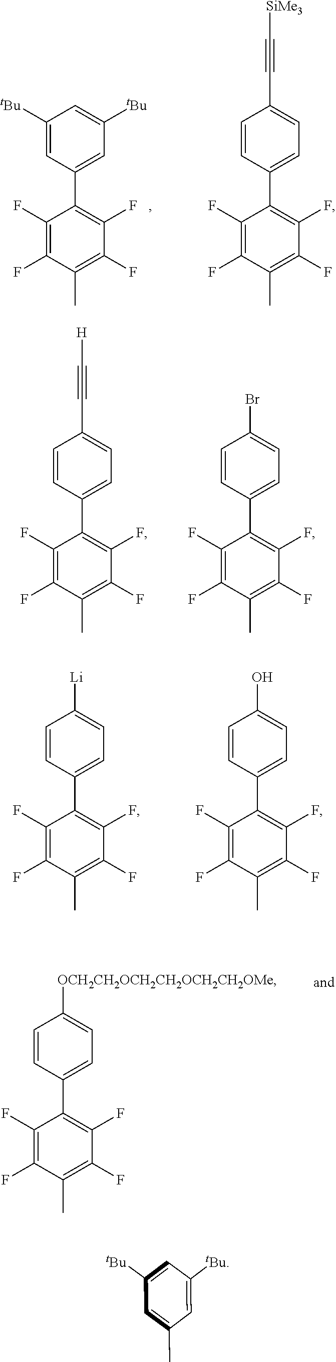

In certain embodiments, R¹ is an electron donating group or an electron withdrawing group. In certain embodiments, the R¹ is a perflourinated group.

In certain embodiments, the total number of carbon atoms in the weakly coordinating anion is selected from the range of 13 to 40.

In certain embodiments, the weakly coordinating anion has the structure:

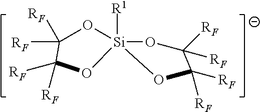

wherein R_{F} is fluoroalkyl having 1-3 carbon atoms and two to seven fluorine atoms or fluorophenyl having 2-5 fluorine atoms on the ring.

In certain embodiments, the weakly coordinating anion has the structure:

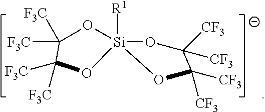

In certain embodiments, the weakly coordinating anion is coordinated to a cation, wherein the cation is a group 1 metal cation, group 2 metal cation, group 13 metal cation, transition metal cation, lanthanide cation, actinide cation, organic acid cation, and/or weakly coordinating cation.

In certain embodiments, the weakly coordinating anion is coordinated to a cation, wherein the cation comprises Mg²⁺, Ca²⁺, Na¹⁺, K¹⁺, Li¹⁺ Rb⁺, Cs⁺, Zn²⁺, Al³⁺, [Et₃NH]⁺, [Me₂NHPh]⁺, [Fe(C₅H₅)₂]⁺, [Ph₃C]⁺, [Bu₄N]⁺, [Ag(NCMe)₂]⁺, [Mg(DME)₃]⁺, [Ni(COD)₂]⁺, and/or [Fe(C₅H₅)₂]⁺, wherein H may in each case be substituted for any alkyl, alkenyl, alkynyl, aryl, heteroatom, and non-H functional groups. In certain embodiments, the cation is a divalent cation. In certain embodiments, the cation is a trivalent cation. In certain embodiments, the cation is selected from the group consisting of Al³⁺, Mg²⁺, Ca²⁺, Zn²⁺, Na⁺, K⁺, Li⁺, Rb⁺, and Cs⁺.

In certain embodiments, the solvent comprises: MeCN, toluene, Et₂O, THF, hydrocarbons, ethers, amines, carbonates, esters, amides, polymers, ionic liquids, and/or a solvent of the general formula CₙHₘXₗ, wherein X is any heteroatom or any combination of heteroatoms, n is any non-zero integer, m is any integer, and l is any integer.

In one embodiment, the weakly coordinating anion is a weakly coordinating anion of the formula:

[(R¹)ₘ—Si(Z)₂]⁻ (FX1)
or salts thereof;
wherein each Z is independently:

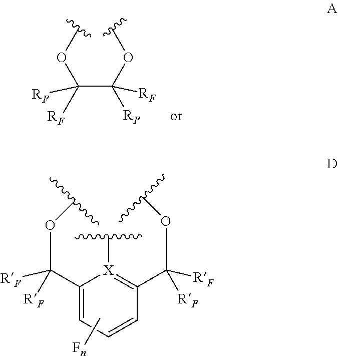

wherein:
   m is 1 when both of Z are A, or m is zero;
   X is C or N;
   Fₙ represents one, two or three F on the indicated ring;
   R_{F} is fluoroalkyl having 1-3 carbon atoms and two to seven fluorine atoms or fluorophenyl having 2-5 fluorine atoms on the ring;
   R′_{F} is fluoroalkyl having 1-3 carbon atoms and two to seven fluorine atoms or fluorophenyl having 2-5 fluorine atoms on the ring; and
   R¹ is substituted or unsubstituted alkyl having 1-30 carbon atoms, substituted or unsubstituted alkenyl having 2-30 carbon atoms, substituted or unsubstituted cycloalkyl having 3-30 carbon atoms and at least one carbocyclic ring, substituted or unsubstituted heterocyclic having 3-30 carbon atoms, 1-4 heteroatoms and at least one heterocyclic ring, substituted or unsubstituted aryl having 1 or 2 aromatic rings which are optionally fused rings and having 5-30 carbon atoms, substituted or unsubstituted heteroaryl having 1 or 2 rings of which at least one is aromatic and which are optionally fused and having 3-30 carbon atoms and 1-4 heteroatoms, or substituted or unsubstituted alkoxyalkyl having 2-12 carbon atoms;
   with the proviso that when m equals 1, each Z is A, and each R_{F} is a fluoroalkyl having 1 carbon atom and three fluorine atoms then R¹ is not unsubstituted phenyl.

In one embodiment, a weakly coordinating dianion or trianion has the formula:

[Y-(E)_{N}]^{N-} (FX2)
or salts thereof;
wherein:
N is 2 or 3;
Y is substituted or unsubstituted alkyl having 1-30 carbon atoms, substituted or unsubstituted alkenyl having 2-30 carbon atoms, substituted or unsubstituted cycloalkyl having 3-30 carbon atoms and at least one carbocyclic ring, substituted or unsubstituted heterocyclic having 3-30 carbon atoms, 1-4 heteroatoms and at least one heterocyclic ring, substituted or unsubstituted aryl having 1-4 aromatic rings which are optionally fused rings and having 5-30 carbon atoms, substituted or unsubstituted heteroaryl having 1-4 rings of which at least one is aromatic and which are optionally fused and having 3-30 carbon atoms and 1-4 heteroatoms, or substituted or unsubstituted alkoxyalkyl having 2-12 carbon atoms; and E is an anionic group having the structure:

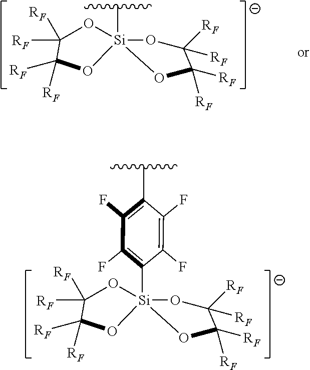

wherein R_{F} is fluoroalkyl having 1-3 carbon atoms and two to seven fluorine atoms or fluorophenyl having 2-5 fluorine atoms on the ring.

TABLE 1
exemplary cations and their application with the disclosed WCA.

| Cations | Applications |
|---|---|
| Li⁺, Na⁺, K⁺, Rb⁺, Cs⁺, Mg²⁺, Ca²⁺ | Coordination chemistry, |
| | electrochemistry, catalysis |
| | (as additives) |
| Cp₂Fe⁺ and its derivatives | Coordination chemistry |
| [Ni(COD)₂]⁺ and other transition | Catalysis |
| metal cations supported by [^{R}Si^{F}₂₄]⁻ | |
| Ph₃C⁺ | Coordination chemistry, catalysis |
| [Bu₄N]⁺ and other weakly- | Electrochemistry |
| coordinating cations | |
| [Et³NH]⁺ and other forms of organic | Coordination chemistry, catalysis |
| acid cations | |

In certain embodiments, optional substitution for alkyl, alkenyl, alkynyl, cycloalkyl and heterocyclic substituent groups is one or more halogen, one or more OH groups, one or more alkoxy groups having 1-3 carbon atoms, one or more alkoxyalkyl groups having 2-12 carbon atoms, one or more phenyl or benzyl groups, one or more halogenated phenyl or benzyl groups, one or more trialkylsilanes wherein the alkyl groups have 1-3 carbon atoms, one or more trialkylsilylethynyl groups wherein the alkyl groups have 1-3 carbon atoms,

In certain embodiments, optional substitution for aryl or heteroaryl substituent groups is one or more halogen, one or more alkyl having 1-3 carbon atoms, one or more haloalkyl having 1-3 carbon atoms, one or more OH, one or more alkoxy having 1-3 carbon atoms, one or more trialkylsilylethynyl where the alkyl groups have 1-3 carbon atoms, or one or more trialkylsilanes wherein the alkyl groups have 1-3 carbon atoms.

In certain embodiments, alkoxyalkyl includes —(CH₂)ₚ—(O—(CH₂)_{q})ᵣ—O(CH₂)ₛH where p is 0 or an integer from 1-6, q and s are integers 1-6 and r is integers 1-4.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1: Common weakly-coordinating anions with application in coordination chemistry (left), divalent battery electrolytes (right) or both (center).

FIG. 2: Design principle of a pentacoordinate silicate anion.

FIG. 3: Preparation of [R₃NH][^{Me}Si^{F}₂₄].

FIG. 4: Crystal structures of 1-[Et₃NH](left) and 3-[Et₃NH](right).

FIG. 5: Preparation of [alkali metal][^{R}Si^{F}₂₄] compounds; Crystal structure of 3-[K].⁵²

FIG. 6: Preparation of 3-[Ph₃C].

FIG. 7: Crystal structure of 3-[Ph₃C](left) and 1-[Ag(NCMe)₂], (right).⁵²

FIG. 8: Preparation of 1-[Ag(NCMe)₂], 1-[Bu₄N], and 1-[Fc].

FIG. 9: Chemical oxidation of Ni(COD)₂ with 1-[Fc].

FIG. 10: Crystal structure of 1-[Ni(COD)₂](left) and crystal structure of 1-[Mg](right). Second anion of 1-[Mg] omitted for clarity.

FIG. 11: Preparation of 3-[Pd(dppe)(NCMe)Me] and conditions for C₂H₄/CO copolymerization.⁶⁴⁻⁶⁵

FIG. 12: Cyclic voltammetry and linear sweep voltammetry experiments of 0.1 M 1-[Bu₄N] and [Bu₄N][PF₆] in MeCN; Current shown were normalized to the highest current in each experiment; FIG. 12A: Cyclic voltammogram of 1-[Bu₄N] in MeCN; WE: Glassy carbon; CE: Pt wire; RE: Ag wire; scan rate=100 mVs⁻¹; FIGS. 12B and 12C: Linear sweep voltammograms of 0.1 M 1-[Bu₄N] and [Bu₄N][PF₆] in MeCN; WE: Glassy carbon; CE: Pt wire; RE: Ag wire; scan rate=50 mVs⁻¹.

FIG. 13: Preparation of 1-[Mg(DME)₃].

FIG. 14A: Cyclic voltammetry experiments of 0.26 M 1-[Mg(DME)₃] with 10 mM of Me₂Mg. WE: Pt wire; CE: Mg strip; RE: Mg strip; Scan rate: 25 mVs⁻¹; Cycling protocol: −0.8 V to 4.0 V, 100 cycles. FIG. 14B: Cycles 1, 25, 50, 75, 100. FIG. 14C: Coulombic efficiency cycles 1-100; Cyclic voltammetry experiments of 0.26 M 1-[Mg(DME)₃] with 10 mM of Me₂Mg. WE: Pt wire; CE: Mg strip; RE: Mg strip; Scan rate: 25 mVs⁻¹; Cycling protocol: −0.8 V to 4.75 V. FIG. 14D: 1 cycle following 100 cycles from −0.8 V to 4.0 V to demonstrate the oxidative stability of 1-[Mg(DME)₃].

FIG. 15A: Cyclic voltammetry experiments of 0.25 M 2-[Mg(DME)₃] with 10 mM of Me₂Mg. WE: Pt wire; CE: Mg strip; RE: Mg strip; Scan rate: 25 mVs⁻¹; Cycling protocol: −0.8 V to 3.8 V, 100 cycles; FIG. 15B: Cycles 1, 25, 50, 75, 100. FIG. 15C: Coulombic efficiency cycles 1-100; Cyclic voltammetry experiments of 0.25 M 2-[Mg(DME)₃] with 10 mM of Me₂Mg. WE: Pt wire; CE: Mg strip; RE: Mg strip; Scan rate: 25 mVs⁻¹; Cycling protocol: −0.8 V to 4.75 V. FIG. 15D: 1 cycle following 100 cycles from −0.8 V to 4.0 V to demonstrate the oxidative stability of 2-[Mg(DME)₃].

FIG. 16: In certain embodiments, the WCA is an ^{R}Si^{F}₂₄ anion featuring bisperfluorpinacolate and an “R” group (alkyl or aryl), enabling tuning of anion sterics and solubility. These anions support a wide array of cations, including those relevant to organometallic and catalysis applications. The anion has a wide electrochemical window and supports reversible Mg electrochemistry.

FIG. 17: Cyclic voltammetry experiments of 0.26 M 1-[Mg(DME)₃] with 10 mM of Me₂Mg in DME. WE: Pt wire; CE: Mg strip; RE: Mg strip; Scan rate: 25 mVs⁻¹; Cycling protocol: −0.8 V to 4.0 V, 100 cycles.

FIG. 18: Cyclic voltammetry experiments of 0.26 M 1-[Mg(DME)₃] with 10 mM of Me₂Mg in DME. WE: Pt wire; CE: Mg strip; RE: Mg strip; Scan rate: 25 mVs⁻¹; Cycling protocol: −0.8 V to 4.0 V, 100 cycles.

FIG. 19: Cyclic voltammetry experiments of 0.26 M 1-[Mg(DME)₃] with 10 mM of Me₂Mg in DME. WE: Pt wire; CE: Mg strip; RE: Mg strip; Scan rate: 25 mVs⁻¹; Cycling protocol: −0.8 V to 4.0 V, 100 cycles.

FIG. 20: Cyclic voltammetry experiments of 0.26 M 1-[Mg(DME)₃] in DME.WE: Pt wire; CE: Mg strip; RE: Mg strip; Scan rate: 25 mVs⁻¹; Cycling protocol: −0.8 V to 4.0 V, 200 cycles.

FIG. 21: Coulombic efficiencies for 0.26 M 1-[Mg(DME)₃] with 10 mM Me₂Mg in DME.

FIG. 22: Coulombic efficiencies for 0.26 M 1-[Mg(DME)₃] in DME.

FIG. 23: ¹H NMR (CD3CN, 400 MHz) of 1-[Et₃NH].

FIG. 24: ¹⁹F NMR (CD3CN, 376 MHz) of 1-[Et₃NH].

FIG. 25: ¹³C{¹H}NMR (CD3CN, 101 MHz) of 1-[Et₃NH]. The insets depict the enlargement of the following signals 1) the quartet of multiplets and 2) the singlet that overlaps with solvent signals.

FIG. 26: ²⁹Si NMR (CD3CN, 80 MHz) of 1-[Et₃NH].

FIG. 27: ¹H NMR (CD3CN, 400 MHz) of 2-[Et₃NH].

FIG. 28: ¹⁹F NMR (CD3CN, 376 MHz) of 2-[Et₃NH].

FIG. 29: ¹³C{¹H}NMR (CD3CN, 101 MHz) of 2-[Et₃NH]. The insets depict the enlargement of the quartet of multiplets.

FIG. 30: ²⁹Si NMR (CD3CN, 80 MHz) of 2-[Et₃NH].

FIG. 31: ¹H NMR (CD3CN, 400 MHz) of 1-[Me₂NPh].

FIG. 32: ¹⁹F NMR (CD3CN, 376 MHz) of 1-[Me₂NPh]. The sharp singlet at −70.3 is minor and corresponds to an unidentified impurity that could not be removed despite extensive washing with PhMe.

FIG. 33: ¹³C{¹H}NMR (CD3CN, 101 MHz) of 1-[Me₂NPh]. The insets depict the enlargement of the following signals 1) the quartet of multiplets and 2) the singlet that overlaps with solvent signals.

FIG. 34: ²⁹Si NMR (CD3CN, 80 MHz) of 1-[Me₂NPh].

FIG. 35: ¹H NMR (CD3CN, 400 MHz) of 2-[Me₂NPh].

FIG. 36: ¹⁹F NMR (CD3CN, 376 MHz) of 2-[Me₂NPh]. The sharp singlet at −70.3 is minor and corresponds to an unidentified impurity that could not be removed despite extensive washing with PhMe.

FIG. 37: ¹³C{¹H}NMR (CD3CN, 101 MHz) of 2-[Me₂NPh].

FIG. 38: ²⁹Si NMR (CD3CN, 80 MHz) of 2-[Me₂NPh].

FIG. 39: ¹H NMR (CD3CN, 400 MHz) of 3-[Et₃NH].

FIG. 40: ¹⁹F NMR (CD3CN, 376 MHz) of 3-[Et₃NH].

FIG. 41: ¹³C{¹H}NMR (CD3CN, 101 MHz) of 3-[Et₃NH]. The inset depicts the enlargement of the quartet of multiplets.

FIG. 42: ¹H-²⁹Si HMBC of 3-[Et₃NH] in CD3CN. ²⁹Si NMR spectrum not shown due to low signal intensity.

FIG. 43: ¹H NMR (CD3CN, 400 MHz) of 4-[Et₃NH].

FIG. 44: ¹⁹F NMR (CD3CN, 376 MHz) of 4-[Et₃NH].

FIG. 45: ¹³C{¹H}NMR (CD3CN, 101 MHz) of 4-[Et₃NH].

FIG. 46: ²⁹Si NMR (CD3CN, 80 MHz) of 4-[Et₃NH].

FIG. 47: ¹H NMR (CD3CN, 400 MHz) of 5-[Et₃NH].

FIG. 48: ¹⁹F NMR (CD3CN, 376 MHz) of 5-[Et₃NH].

FIG. 49: ¹³C{¹H}NMR (CD3CN, 101 MHz) of 5-[Et₃NH]. The inset depicts the enlargement of the quartet of multiplets.

FIG. 50: ²⁹Si NMR (CD3CN, 80 MHz) of 5-[Et₃NH].

FIG. 51: ¹H NMR (CD3CN, 400 MHz) of 6-[Et₃NH].

FIG. 52: ¹⁹F NMR (CD3CN, 376 MHz) of 6-[Et₃NH].

FIG. 53: ¹³C{¹H}NMR (CD3CN, 101 MHz) of 6-[Et₃NH]. The inset depicts the enlargement of the quartet of multiplets.

FIG. 54: ²⁹Si NMR (CD3CN, 80 MHz) of 6-[Et₃NH].

FIG. 55: ¹H NMR (CD3CN, 400 MHz) of 7-[Et₃NH].

FIG. 56: ¹⁹F NMR (CD3CN, 376 MHz) of 7-[Et₃NH].

FIG. 57: ¹³C{¹H}NMR (CD3CN, 101 MHz) of 7-[Et₃NH]. The inset depicts the enlargement of the quartet of multiplets.

FIG. 58: ²⁹Si NMR (CD3CN, 80 MHz) of 7-[Et₃NH].

FIG. 59: ¹H NMR (CD3CN, 400 MHz) of 8-[Et₃NH].

FIG. 60: ¹⁹F NMR (CD3CN, 376 MHz) of 8-[Et₃NH].

FIG. 61: ¹³C{¹H}NMR (CD3CN, 101 MHz) of 8-[Et₃NH]. The inset depicts the enlargement of the quartet of multiplets.

FIG. 62: ²⁹Si NMR (CD3CN, 80 MHz) of 8-[Et₃NH].

FIG. 63: ¹H NMR (CD3CN, 400 MHz) of 9-[Et₃NH].

FIG. 64: ¹⁹F NMR (CD3CN, 376 MHz) of 9-[Et₃NH].

FIG. 65: ¹³C{¹H}NMR (CD3CN, 101 MHz) of 9-[Et₃NH]. The inset depicts the enlargement of the quartet of multiplets.

FIG. 66: ²⁹Si NMR (CD3CN, 80 MHz) of 9-[Et₃NH].

FIG. 67: ¹H NMR (CD3CN, 400 MHz) of 10-[Et₃NH].

FIG. 68: ¹⁹F NMR (CD3CN, 376 MHz) of 10-[Et₃NH].

FIG. 69: ¹³C{¹H}NMR (CD3CN, 101 MHz) of 10-[Et₃NH]. The inset depicts the enlargement of the quartet of multiplets.

FIG. 70: ²⁹Si NMR (CD3CN, 80 MHz) of 10-[Et₃NH].

FIG. 71: ¹H NMR (CD3CN, 400 MHz) of 1-[Mg(DME)₃].

FIG. 72: ¹⁹F NMR (CD3CN, 376 MHz) of 1-[Mg(DME)₃].

FIG. 73: ¹³C{¹H}NMR (CD3CN, 101 MHz) of 1-[Mg(DME)₃]. The insets depict the enlargement of the following signals 1) the quartet of multiplets and 2) the singlet that overlaps with solvent signals.

FIG. 74: ²⁹Si NMR (CD3CN, 80 MHz) 1-[Mg(DME)₃].

FIG. 75: ¹H NMR (CD3CN, 400 MHz) of 2-[Mg(DME)₃].

FIG. 76: ¹⁹F NMR (CD3CN, 376 MHz) of 2-[Mg(DME)₃].

FIG. 77: ¹³C{¹H}NMR (CD3CN, 101 MHz) of 2-[Mg(DME)₃].

FIG. 78: ²⁹Si NMR (CD3CN, 80 MHz) 2-[Mg(DME)₃].

FIG. 79: ¹H NMR (CD3CN, 400 MHz) of 1-[K].

FIG. 80: ¹⁹F NMR (CD3CN, 376 MHz) of 1-[K].

FIG. 81: ¹³C{¹H}NMR (CD3CN, 101 MHz) of 1-[K]. The insets depict the enlargement of the following signals 1) the quartet of multiplets and 2) the singlet that overlaps with solvent signals.

FIG. 82: ²⁹Si NMR (CD3CN, 80 MHz) of 1-[K].

FIG. 83: ¹H NMR (CD3CN, 400 MHz) of 3-[Na]. The inset depicts the enlargement of the aromatic signals.

FIG. 84: ¹⁹F NMR (CD3CN, 376 MHz) of 3-[Na].

FIG. 85: ¹³C{¹H}NMR (CD3CN, 101 MHz) of 3-[Na].

FIG. 86: ¹H-²⁹Si HMBC of 3-[Na] in CD3CN. ²⁹Si NMR spectrum not shown due to low signal intensity.

FIG. 87: ¹H NMR (CD3CN, 400 MHz) of 3-[K]. The inset depicts the enlargement of the aromatic signals.

FIG. 88: ¹⁹F NMR (CD3CN, 376 MHz) of 3-[K].

FIG. 89: ¹³C{¹H}NMR (CD3CN, 101 MHz) of 3-[K].

FIG. 90: ¹H-²⁹Si HMBC of 3-[K] in CD3CN. ²⁹Si NMR spectrum showed no signal.

FIG. 91: ¹H NMR (CD3CN, 400 MHz) of 1-[Bu₄N].

FIG. 92: ¹⁹F NMR (CD3CN, 376 MHz) of 1-[Bu₄N].

FIG. 93: ¹³C{¹H}NMR (CD3CN, 101 MHz) of 1-[Bu₄N]. The insets depict the enlargement of the following signals 1) the quartet of multiplets and 2) the singlet that overlaps with solvent signals.

FIG. 94: ²⁹Si NMR (CD3CN, 80 MHz) of 1-[Bu₄N].

FIG. 95: ¹H NMR (CD2Cl₂, 400 MHz) of 1-[Ag(MeCN)₂].

FIG. 96: ¹⁹F NMR (CD₂Cl₂, 376 MHz) of 1-[Ag(MeCN)₂].

FIG. 97: ¹³C{¹H}NMR (CD₂Cl₂, 101 MHz) of 1-[Ag(MeCN)₂].

FIG. 98: ²⁹Si NMR (CD₂Cl₂, 80 MHz) of 1-[Ag(MeCN)₂].

FIG. 99: ¹H NMR (CD₂Cl₂, 400 MHz) of 3-[Ph₃C].

FIG. 100: ¹⁹F NMR (CD₂Cl₂, 376 MHz) of 3-[Ph₃C].

FIG. 101: ¹³C{¹H}NMR (CD₂Cl₂, 101 MHz) of 3-[Ph₃C].

FIG. 102: ²⁹Si NMR (CD₂Cl₂, 80 MHz) of 3-[Ph₃C].

FIG. 103: ¹H NMR (CD₃CN, 400 MHz) of 1-[Fc].

FIG. 104: ¹⁹F NMR (CD₃CN, 376 MHz) of 1-[Fc].

FIG. 105: X-Band CW EPR of [Ni(COD₂)[^{Me}Si^{F}₂₄] at 77 K in 10:1 o-DFB: PhMe. Acquisition parameters: MW frequency=9.44 GHz; Modulation amplitude=0.01 mT; MW power=2.2 mW Conversion time=5 ms; Time constant=5.12 ms; Asterix denotes a secondary species that is either a side product or a geometric isomer.⁴

FIG. 106: X-ray crystal structure of 1-[Et₃NH]. Ellipsoids are shown at 50% probability level.

FIG. 107: X-ray crystal structure of 3-[Et₃NH]. Ellipsoids are shown at 50% probability level.

FIG. 108: X-ray crystal structure of 1-[Fc]. Ellipsoids are shown at 50% probability level.

FIG. 109: X-ray crystal structure of 3-[Ph₃C]. Ellipsoids are shown at 50% probability level.

FIG. 110: X-ray crystal structure of 1-[Ag(NCMe)₂]. Ellipsoids are shown at 50% probability level.

FIG. 111: X-ray crystal structure of 3-[K]. Ellipsoids are shown at 50% probability level.

FIG. 112: X-ray crystal structure of 1-[Mg(DME)₃]. Ellipsoids are shown at 50% probability level. Second anion omitted for clarity.

FIG. 113: X-ray crystal structure of 1-[Ni(COD)₂]. Ellipsoids are shown at 50% probability level.

FIG. 114: X-ray crystal structure of 7-[Et₃NH]. Ellipsoids are shown at 50% probability level.

FIG. 115: X-ray crystal structure of [Et₃NH][^{C6F5}Si^{F}₂₄]. Ellipsoids are shown at 50% probability level.

FIG. 116: Scheme 4. a) Preparation of a trianionic silicate through alkyne trimerization; b) Preparation of a dianionic silicate via S_{N}Ar. Outer-sphere Li⁺ counterions omitted for clarity.

FIG. 117: Scheme 5. Preparation of dianionic silicates. [Et₃NH]⁺ counterions omitted for clarity.

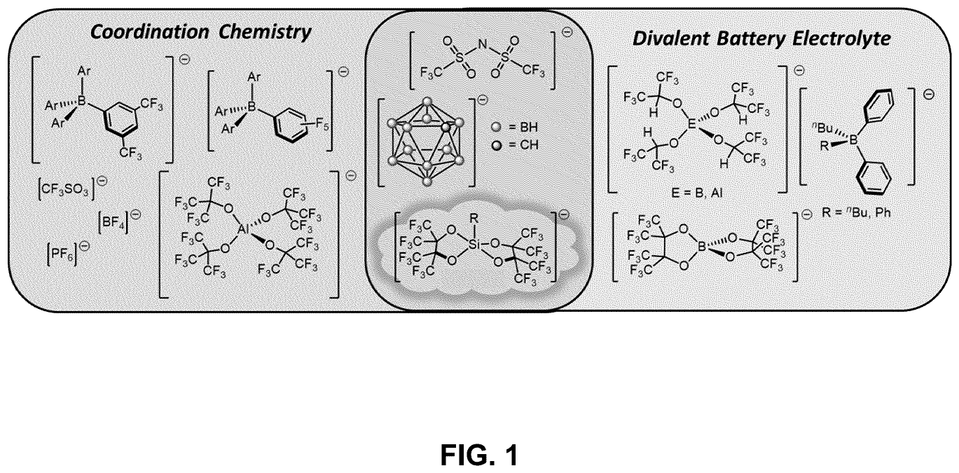

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

The terms alkyl or alkyl group refer to a monoradical of a straight-chain or branched saturated hydrocarbon. Alkyl groups include straight-chain and branched alkyl groups. Unless otherwise indicated, alkyl groups have 1-20 carbon atoms (C1-C20 alkyl groups) and preferred are those that contain 1-10 carbon atoms (C1-C10 alkyl groups) and more preferred are those that contain 1-6 carbon atoms (C1-C6 alkyl groups) and those that contain 1-3 carbon atoms (C1-C3 alkyl groups). Alkyl groups are optionally substituted with one or more non-hydrogen substituents as described herein. Exemplary alkyl groups include methyl, ethyl, n-propyl, iso-propyl, n-butyl, s-butyl, t-butyl, n-pentyl, branched-pentyl, n-hexyl, branched hexyl, all of which are optionally substituted. Substituted alkyl groups include fully halogenated or semihalogenated alkyl groups, such as alkyl groups having one or more hydrogens replaced with one or more fluorine atoms, chlorine atoms, bromine atoms and/or iodine atoms. Substituted alkyl groups include fully fluorinated or semifluorinated alkyl.

A carbocyclyl group is a group having one or more saturated or unsaturated carbon rings. Carbocyclyl groups, for example, contain one or two double bonds. One or more carbons in a carbocyclic ring can be —CO— groups. Carbocyclyl groups include those having 3-12 carbon atoms, and optionally replacing 1 or 2 carbon atoms with a —CO— group and optionally having 1, 2 or 3 double bonds. Carbocyclyl groups include those having 5-6 ring carbons. Carbocyclyl groups can contain one or more rings each of which is saturated or unsaturated. Carbocyclyl groups include bicyclic and tricyclic groups. Preferred carbocyclic groups have a single 5- or 6-member ring. Carbocyclyl groups are optionally substituted as described herein. Specifically, carbocyclic groups can be substituted with one or more alkyl groups. Carbocyclyl groups include among others cycloalkyl and cycloalkenyl groups.

Cycloalkyl groups include those which have 1 ring or which are bicyclic or tricyclic. In specific embodiments, cycloalkyl groups have 1 ring having 5-8 carbon atoms and preferably have 5 or 6 carbon atoms.

Cycloalkenyl groups include those which have 1 ring or which are bicyclic or tricyclic and which contain 1-3 double bond. In specific embodiments, cycloalkenyl groups have 1 ring having 5-8 carbon atoms and preferably have 5 or 6 carbon atoms and have one double bond.

Alkenyl groups include monovalent straight-chain, branched and cyclic alkenyl groups which contain one or more carbon-carbon double bonds. Unless otherwise indicated alkenyl groups include those having from 2 to 20 carbon atoms.

Alkenyl groups include those having 2 to 4 carbon atoms and those having from 5-8 carbon atoms. Cyclic alkenyl groups include those having one or more rings wherein at least one ring contains a double bond. Cyclic alkenyl groups include those which have 1, 2 or 3 rings wherein at least one ring contains a double bond. Cyclic alkenyl groups also include those having 3-10 carbon atoms. Cyclic alkenyl groups include those having a 5-, 6-, 7-, 8-, 9- or 10-member carbon ring and particularly those having a 5- or 6-member ring. The carbon rings in cyclic alkenyl groups can also carry straight-chain or branched alkyl or alkenyl group substituents. Cyclic alkenyl groups can include bicyclic and tricyclic alkyl groups wherein at least one ring contains a double bond.

Alkenyl groups are optionally substituted with one or more non-hydrogen substituents as described herein. Specific alkenyl groups include ethylene, propenyl, cyclopropenyl, butenyl, cyclobutenyl, pentenyl, pentadienyl, cyclopentenyl, cyclopentadienyl, hexylenyl, hexadienyl, cyclohexenyl, cyclohexadienyl, including all isomers thereof and all of which are optionally substituted. Substituted alkenyl groups include fully halogenated or semihalogenated alkenyl groups.

Alkynyl groups include mono-valent straight-chain, branched and cyclic alkynyl group which contain one or more carbon-carbon triple bonds. Unless otherwise indicated alkynyl groups include those having from 2 to 20 carbon atoms. Alkynyl groups include those having 2 to 4 carbon atoms and those having from 5-8 carbon atoms. Cyclic alkynyl groups include those having one or more rings wherein at least one ring contains a triple bond. Cyclic alkynyl groups include those which have 1, 2 or 3 rings wherein at least one ring contains a triple bond. Cyclic alkynyl groups also include those having 3-10 carbon atoms. Cyclic alkynyl groups include those having a 5-, 6-, 7-, 8-, 9- or 10-member carbon ring and particularly those having a 5- or 6-member ring.

The carbon rings in cyclic alkynyl groups can also carry straight-chain or branched alkyl, alkenyl or alkynyl group substituents. Cyclic alkynyl groups can include bicyclic and tricyclic alkyl groups wherein at least one ring contains a triple bond.

Alkynyl groups are optionally substituted with one or more non-hydrogen substituents as described herein.

An alkoxy group is an alkyl group (including cycloalkyl), as broadly discussed above, linked to oxygen, a monovalent —O-alkyl group. An aryloxy group is an aryl group, as discussed above, linked to an oxygen, a monovalent —O-aryl. A heteroaryloxy group is a heteroaryl group as discussed above linked to an oxygen, a monovalent —O— heteroaryl. Alkenoxy, alkynoxy, alicycloxy, heterocycloxy groups are analogously defined. All of such groups are optionally substituted.

The number of carbon atoms in a given group, such as an alkyl group, can be indicated herein using the expression “Cₘ” where m is the number of carbon atoms.

Thus, the expression “Cₘ₁-Cₘ₂” modifying a given chemical group indicates that the group can contain from m1 to m2 carbon atoms. For example, a C₁-C₆ alkyl group contains 1 to 6 carbon atoms, exclusive of carbons in any substituent on the alkyl group. Similar expressions can be used to indicate the number of atoms of N (nitrogen), O (oxygen) or other elements in a given group.

A heterocyclyl (or heterocyclic) group is a group having one or more saturated or unsaturated carbon rings and which contains one to three heteroatoms (e.g., N, O or S) per ring. These groups optionally contain one, two or three double bonds. To satisfy valence requirement, a ring atom may be substituted as described herein. One or more carbons in the heterocyclic ring can be —CO— groups. Heterocyclyl groups include those having 3-12 carbon atoms, and 1-6, heteroatoms, wherein 1 or 2 carbon atoms are replaced with a —CO— group. Heterocyclyl groups include those having 3-12 or 3-10 ring atoms of which up to three can be heteroatoms other than carbon. Heterocyclyl groups can contain one or more rings each of which is saturated or unsaturated. Heterocyclyl groups include bicyclic and tricyclic groups. Preferred heterocyclyl groups have 5- or 6-member rings. Heterocyclyl groups are optionally substituted as described herein. Specifically, heterocyclic groups can be substituted with one or more alkyl groups. Heterocyclyl groups include those having 5- and 6-member rings with one or two nitrogens and one or two double bonds. Heterocyclyl groups include those having 5- and 6-member rings with an oxygen or a sulfur and one or two double bonds. Heterocyclyl group include those having 5- or 6-member rings and two different heteroatom, e.g., N and O, O and S or N and S. Specific heterocyclyl groups include among others among others, pyrrolidinyl, piperidyl, piperazinyl, pyrrolyl, pyrrolinyl, furyl, thienyl, morpholinyl, oxazolyl, oxazolinyl, oxazolidinyl, indolyl, triazoly, and triazinyl groups.

Aryl groups include groups having one or more 5- or 6-member aromatic rings. Aryl groups can contain one, two or three, 6-member aromatic rings. Aryl groups can contain two or more fused aromatic rings. Aryl groups can contain two or three fused aromatic rings. Aryl groups are optionally substituted with one or more non-hydrogen substituents. Substituted aryl groups include among others those which are substituted with alkyl or alkenyl groups, which groups in turn can be optionally substituted. Specific aryl groups include phenyl groups, biphenyl groups, and naphthyl groups, all of which are optionally substituted as described herein. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogen replaced with one or more fluorine atoms.

Heteroaryl groups include groups having one or more aromatic rings in which at least one ring contains a heteroatom (a non-carbon ring atom). Heteroaryl groups include those having one or two heteroaromatic rings carrying 1, 2 or 3 heteroatoms and optionally have one 6-member aromatic ring. Heteroaryl groups can contain 5-20, 5-12 or 5-10 ring atoms. Heteroaryl groups include those having one aromatic ring contains a heteroatom and one aromatic ring containing carbon ring atoms. Heteroaryl groups include those having one or more 5- or 6-member aromatic heteroaromatic rings and one or more 6-member carbon aromatic rings. Heteroaromatic rings can include one or more N, O, or S atoms in the ring. Heteroaromatic rings can include those with one, two or three N, those with one or two 0, and those with one or two S, or combinations of one or two or three N, O or S. Specific heteroaryl groups include furyl, pyridinyl, pyrazinyl, pyrimidinyl, quinolinyl, and purinyl groups. In specific embodiments herein aryl groups contain no heteroatoms in the aryl rings. Aryl including heteroaryl groups are optionally substituted.

Heteroatoms include O, N, S, P or B. More specifically heteroatoms are N, O or S. In specific embodiments, one or more heteroatoms are substituted for carbons in aromatic or carbocyclic rings. To satisfy valence any heteroatoms in such aromatic or carbocyclic rings may be bonded to H or a substituent group, e.g., an alkyl group or other substituent.

Heteroarylalkyl groups are alkyl groups substituted with one or more heteroaryl groups wherein the alkyl groups optionally carry additional substituents, and the aryl groups are optionally substituted.

Alkylaryl groups are aryl groups substituted with one or more alkyl groups wherein the alkyl groups optionally carry additional substituents, and the aryl groups are optionally substituted. Specific alkylaryl groups are alkyl-substituted phenyl groups such as methylphenyl.

Arylalkyl groups are alkyl groups substituted with one or more aryl groups, typically one aryl group. The aryl group is optionally substituted. Specific arylalkyl groups include benzyl, optionally substituted benzyl, phenethyl, and optionally substituted phenethyl.

Alkylheteroaryl groups are heteroaryl groups substituted with one or more alkyl groups wherein the alkyl groups optionally carry additional substituents, and the aryl groups are optionally substituted.

An alkoxy group is an alkyl group, as broadly discussed above, linked to oxygen (Ralkyl-O—). An aryloxy group is an aryl group, as discussed above, linked to an oxygen (Raryl-O—). A heteroaryloxy group is a heteroaryl group as discussed above linked to an oxygen (Rheteroaryl-O—). A carbocyclyloxy group is a carbocyclyl group, as broadly discussed above, linked to oxygen (Rcarbocyclyl-O—). A heterocyclyloxy group is an carbocyclyl group, as broadly discussed above, linked to oxygen (Rheterocyclyl-O—).

An acyl group is an R′—CO group where R′ in general is a hydrogen, an alkyl, alkenyl or alkynyl, aryl or heteroaryl group as described above. In specific embodiments, acyl groups have 1-20, 1-12 or 1-6 carbon atoms and optionally 1-3 heteroatom, optionally one double bond or one triple bond. In specific embodiments, R is a C₁-C₆ alkyl, alkenyl or alkynyl group. cyclic configuration or a combination thereof, attached to the parent structure through a carbonyl functionality. Examples include acetyl, benzoyl, propionyl, isobutyryl, or oxalyl. The R′ group of acyl groups are optionally substituted as described herein. When R′ is hydrogen, the group is a formyl group. An acetyl group is a CH₃—CO— group. Another exemplary acyl group is a benzyloxy group.

Groups herein are optionally substituted most generally with one or more alky, alkenyl, alkynyl, and aryl, heteroaryl, carbocyclyl, and heterocyclyl groups can be substituted, for example, with one or more oxo group, thioxo group, halogen, nitro, cyano, cyanate, azido, thiocyano, isocyano, isothiocyano, sulfhydryl, hydroxyl, alkyl, alkoxy, alkenyl, alkenyloxy, alkynyl, alkynyloxy, aryl, aryloxy, heteroaryl, heteroaryloxy, carbocyclyl, carbocyclyloxy, heterocyclyl, heterocyclyloxy, alkylthio, alkenylthio, alkynylthio, arylthio, thioheteroaryl, thioheteroaryl, thiocarbocyclyl, thioheterocyclyl, —CORs, —COH, —OCORs, —OOH, —CO—ORs, —CO—OH, —CO—O—CO-Rs, —CON(Rs)2, —CONHRs, —CONH2, —NRs-CORs, —NHCORs, —NHRs, —N(Rs)2, —O-SO2-Rs, —SO2-Rs, —SO2-NHRs, —SO2-N(Rs)2, —NRs-SO2-Rs, —NH—SO2-Rs, —NRsCO-N(Rs)2, —NH—CO—NHRs, —O—PO(ORs)2, —O—PO(ORs)(N(Rs)2), —O—PO(N(Rs)2)2, —N—PO(ORs)2, —N—PO(ORs)(N(Rs)2), —P(Rs)2, —B(OH)2, —B(OH)(ORs), —B(ORs)2, where each Rs independently is an organic group and more specifically is an alkyl, alkenyl, alkynyl, aryl, heteroaryl, carbocyclyl, or heterocyclyl group or two Rs within the same substituent can together form a carbocyclic or heterocyclic ring having 3 to 10 ring atoms. Organic groups of non-hydrogen substituents are in turn optionally substituted with one or more halogens, nitro, cyano, isocyano, isothiocyano, hydroxyl, sulfhydryl, haloalkyl, hydroxyalkyl, amino, alkylamino, dialkylamino, arylalkyl, unsubstituted alkyl, unsubstituted alkenyl, unsubstituted alkynyl alkylalkenyl, alkylalkynyl, haloaryl, hydroxylaryl, alkylaryl, unsubstituted aryl, unsubstituted carbocylic, halo-substituted carbocyclic, hydroxyl-substituted carbocyclic, alkyl-substituted carbocyclic, unsubstituted heterocyclic, unsubstituted heteroaryl, alkyl-substituted heteroaryl, or alkyl-substituted heterocyclic. In specific embodiments, Rs groups of substituents are independently selected from alkyl groups, haloalkyl groups, phenyl groups, benzyl groups and halo-substituted phenyl and benzyl groups. In specific embodiments, non-hydrogen substituents have 1-20 carbon atoms, 1-10 carbon atoms, 1-7 carbon atoms, 1-5 carbon atoms or 1-3 carbon atoms. In specific embodiments, non-hydrogen substituents have 1-10 heteroatoms, 1-6 heteroatoms, 1-4 heteroatoms, or 1, 2, or 3 heteroatoms. Heteroatoms include O, N, S, P, B and Se and preferably are 0, N or S.

In specific embodiments, optional substitution is substitution with 1-12 (or 1-3 or 1 to 3 or 1 to 6) non-hydrogen substituents. In specific embodiments, optional substitution is substitution with 1-6 non-hydrogen substituents. In specific embodiments, optional substitution is substitution with 1-3 non-hydrogen substituents.

In specific embodiments, optional substituents contain 6 or fewer carbon atoms. In specific embodiments, optional substitution is substitution by one or more halogen, hydroxyl group, cyano group, oxo group, thioxo group, unsubstituted C1-C6 alkyl group or unsubstituted aryl group. The term oxo group and thioxo group refer to substitution of a carbon atom with a ═O or a ═S to form respectively CO (carbonyl) or CS (thiocarbonyl) groups.

In specific embodiments, non-hydrogen substituents for optional substitution include alkyl, alkoxy, halogen (F, Cl, Br or I and preferably Cl or F), haloalkyl, or haloalkoxy. In specific embodiments, non-hydrogen substituents for optional substitution include methyl, ethyl, methoxy, ethoxy, F, Cl, and trifluormethyl.

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RsCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups, and methoxyphenyl groups, particularly 4-methoxyphenyl groups.

As to any of the above groups which contain one or more substituents, it is understood, that such groups do not contain any substitution or substitution patterns which are sterically impractical and/or synthetically non-feasible. In addition, the compounds of this invention include all stereochemical isomers arising from the substitution of these compounds.

Compounds of the invention may contain chemical groups (acidic or basic groups) that can be in the form of salts. Exemplary acid addition salts include acetates (such as those formed with acetic acid or trihaloacetic acid, for example, trifluoroacetic acid), adipates, alginates, ascorbates, aspartates, benzoates, benzenesulfonates, bisulfates, borates, butyrates, citrates, camphorates, camphorsulfonates, cyclopentanepropionates, digluconates, dodecylsulfates, ethanesulfonates, fumarates, glucoheptanoates, glycerophosphates, hemisulfates, heptanoates, hexanoates, hydrochlorides (formed with hydrochloric acid), hydrobromides (formed with hydrogen bromide), hydroiodides, 2-hydroxyethanesulfonates, lactates, maleates (formed with maleic acid), methanesulfonates (formed with methanesulfonic acid), 2-naphthalenesulfonates, nicotinates, nitrates, oxalates, pectinates, persulfates, 3-phenylpropionates, phosphates, picrates, pivalates, propionates, salicylates, succinates, sulfates (such as those formed with sulfuric acid), sulfonates (such as those mentioned herein), tartrates, thiocyanates, toluenesulfonates such as tosylates, undecanoates, and the like.

Exemplary basic salts include ammonium salts, alkali metal salts such as sodium, lithium, and potassium salts, alkaline earth metal salts such as calcium and magnesium salts, salts with organic bases (for example, organic amines) such as benzathines, dicyclohexylamines, hydrabamines [formed with N,N-bis(dehydro-abietyl)ethylenediamine], N-methyl-D-glucamines, N-methyl-D-glucamides, t-butyl amines, and salts with amino acids such as arginine, lysine and the like. Basic nitrogen-containing groups may be quaternized with agents such as lower alkyl halides (e.g., methyl, ethyl, propyl, and butyl chlorides, bromides and iodides), dialkyl sulfates (e.g., dimethyl, diethyl, dibutyl, and diamyl sulfates), long chain halides (e.g., decyl, lauryl, myristyl and stearyl chlorides, bromides and iodides), aralkyl halides (e.g., benzyl and phenethyl bromides), and others.

Compounds of the present invention, and salts thereof, may exist in their tautomeric form, in which hydrogen atoms are transposed to other parts of the molecules and the chemical bonds between the atoms of the molecules are consequently rearranged. It should be understood that all tautomeric forms, insofar as they may exist, are included within the invention.

Additionally, inventive compounds may have trans and cis isomers and may contain one or more chiral centers, therefore exist in enantiomeric and diastereomeric forms. The invention includes all such isomers, as well as mixtures of cis and trans isomers, mixtures of diastereomers and racemic mixtures of enantiomers (optical isomers). When no specific mention is made of the configuration (cis, trans or R or S) of a compound (or of an asymmetric carbon), then any one of the isomers or a mixture of more than one isomer is intended. The processes for preparation can use racemates, enantiomers, or diastereomers as starting materials. When enantiomeric or diastereomeric products are prepared, they can be separated by conventional methods, for example, by chromatographic or fractional crystallization. The inventive compounds may be in the free or hydrate form. With respect to the various compounds of the invention, the atoms therein may have various isotopic forms, e.g., isotopes of hydrogen include deuterium and tritium. All isotopic variants of compounds of the invention are included within the invention and particularly included at deuterium and 13C isotopic variants. It will be appreciated that such isotopic variants may be useful for carrying out various chemical and biological analyses, investigations of reaction mechanisms and the like. Methods for making isotopic variants are known in the art.

The term “electrochemical cell” refers to devices and/or device components that convert chemical energy into electrical energy or electrical energy into chemical energy. Electrochemical cells have two or more electrodes (e.g., positive and negative electrodes) and one or more electrolytes. For example, an electrolyte may be a fluid electrolyte or a solid electrolyte. Reactions occurring at the electrode, such as sorption and desorption of a chemical species or such as an oxidation or reduction reaction, contribute to charge transfer processes in the electrochemical cell. Electrochemical cells include, but are not limited to, primary (non-rechargeable) batteries and secondary (rechargeable) batteries. In certain embodiments, the term electrochemical cell includes metal hydride batteries, metal-air batteries, fuel cells, supercapacitors, capacitors, flow batteries, solid-state batteries, and catalysis or electrocatalytic cells (e.g., those utilizing an alkaline aqueous electrolyte).

The term “electrode” refers to an electrical conductor where ions and electrons are exchanged with the aid of an electrolyte and an outer circuit. The term “negative electrode” refers to the electrode that is conventionally referred to as the anode during discharging of the electrochemical cell. During charging of the electrochemical cell, the negative electrode is one that is conventionally referred to as the cathode. The negative electrode may comprise a porous structure. An exemplary negative electrode includes, but is not limited to, a carbon allotrope such as graphite, graphitic carbon, or glassy carbon. The term “positive electrode” refers to the electrode that is conventionally referred to as the cathode during discharging of the electrochemical cell. During charging of the electrochemical cell, the positive electrode is one that is conventionally referred to as the anode. An exemplary positive electrode includes, but is not limited to, lithium cobalt oxide.

In an embodiment, a composition or compound of the invention, such as an alloy or precursor to an alloy, is isolated or substantially purified. In an embodiment, an isolated or purified compound is at least partially isolated or substantially purified as would be understood in the art. In an embodiment, a substantially purified composition, compound or formulation of the invention has a chemical purity of 95%, optionally for some applications 99%, optionally for some applications 99.9%, optionally for some applications 99.99%, and optionally for some applications 99.999% pure.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

The invention can be further understood by the following non-limiting examples.

### Example 1: [^{R}Si^{F}₂₄] Silicate Platform as Weakly-Coordinating Anions for Diverse Organometallic and Electrochemical Applications

A new class of WCA based on silicon (e.g., “^{R}Si^{F}₂₄ anions”) was developed, having applications in coordination chemistry, organometallic catalysis, and electrochemistry, including for Mg batteries.

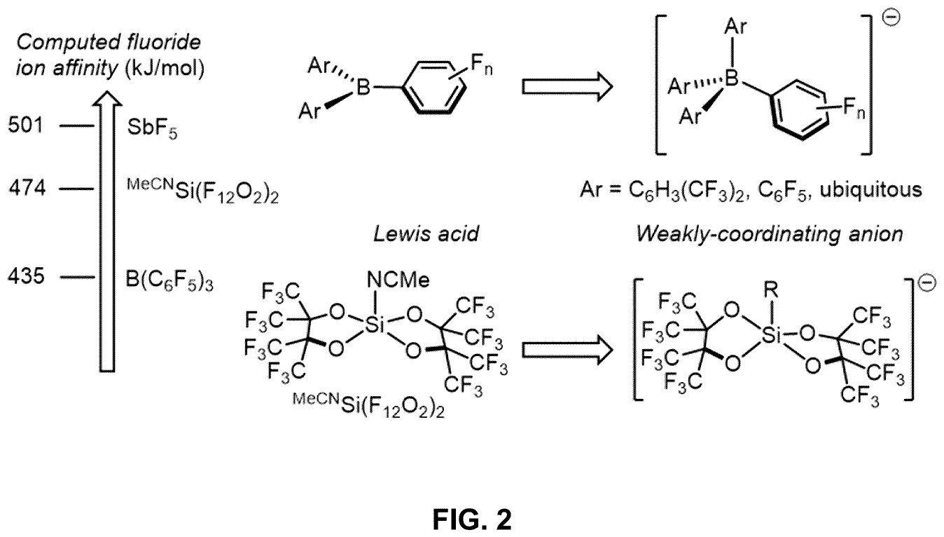

Charge delocalization over several electron deficient substituents imparts low nucleophilicity, basicity, and propensity to oxidize.⁸ Conceptually, a highly Lewis acidic fragment (e.g. neutral borane, such as B(C₆F₅)₃) results in a WCA (e.g. [B(C₆F₅)₄]⁻) upon incorporation of an aryl, (C₆F₅)—, or other anionic groups.⁸ Lewis acids based on Si were identified as potential candidates given their synthetic accessibility and high Lewis acidity.⁴³⁻⁴⁷ Si supported by two perfluoropinacolate ligands, (MeCN)Si(O₂C₆F₁₂)₂ (FIG. 2), was calculated to have a fluoride affinity of 474 kJ/mol, similar to that of SbF₅ (501 kJ/mol) and higher than that of B(C₆F₅)_{3.}⁴⁷ (MeCN)Si(O₂C₆F₁₂)₂ is highly reactive and activates the Si—F bond of Et₃SiF.⁴⁷

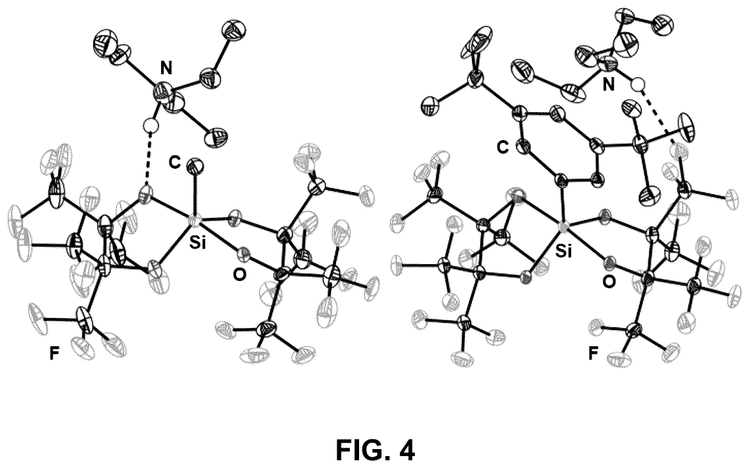

In specific embodiments, pentacoordinate silicates of the form [^{R}Si(O₂C₆F₁₂)₂]⁻ (^{R}Si^{F}₂₄—) were targeted, with the perfluoropinacolate ligands imparting steric protection and oxidative stability, and the alkyl/aryl substituent R1 imparting structural and electronic tunability. Pentacoordinate silicate anions may be accessed from RSi(OEt)₃ precursors, stoichiometric treatment of MeSi(OEt)₃, Et₃N, and perfluoropinacol (F₁₂-pin) in toluene to afford the desired triethylammonium silicate [Et₃NH][^{Me}Si^{F}₂₄](1-[Et₃NH]). The ¹H NMR spectrum of 1-[Et₃NH] displays a downfield singlet characteristic of CH₃—Si motifs and peaks corresponding to the [Et₃NH]⁺ motif. The ¹⁹F NMR of 1-[Et₃NH] displays two multiplets between δ −69 ppm and δ −72 ppm, consistent with previously reported silicates bearing two perfluoropinacolate motifs.⁴⁷ As indicated by a single crystal X-ray diffraction study (FIG. 4, left), in the solid state, the anionic silicate motif was found to be pseudo-trigonal bipyramidal (refer to the SI for the τ₅ parameters), with the methyl group in the equatorial plane.⁵² Despite the presence of eight CF₃ groups, the steric constraints are not sufficient to prevent a hydrogen bonding interaction between the proton of the [Et₃NH]⁺ cation and one of the oxygen atoms of the anion (d_{N-O}=3.06 Å).⁵³ The analogous 1-[Me₂NHPh] is prepared by using Me₂NPh instead of Et₃N as a base.

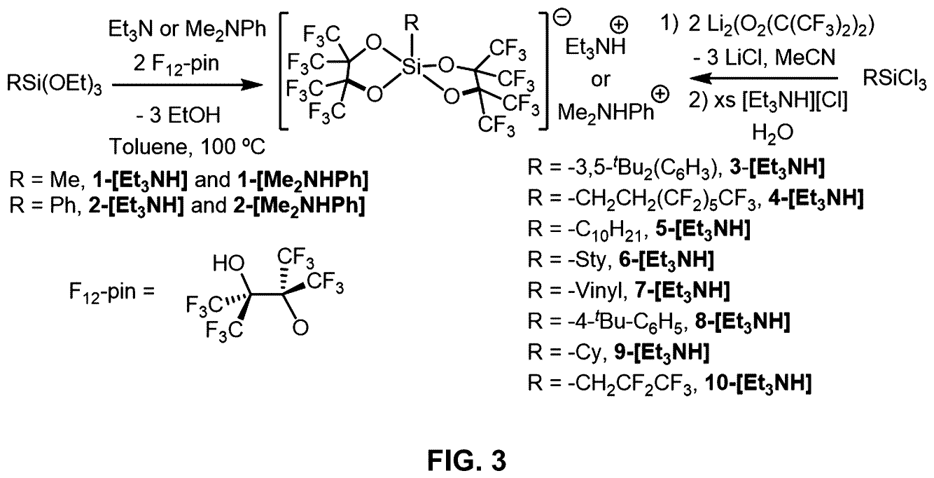

The structural tunability of [^{R}Si^{F}₂₄] anions was explored with a variety of alkyl and aryl substituents. While [Et₃NH][^{Ph}Si^{F}₂₄](2-[Et₃NH] is readily prepared using PhSi(OEt)₃, the breadth of accessible variants has been limited by commercial availability of RSi(OEt)₃ precursors, involved synthesis of RSi(OEt)₃ precursors, and incomplete formation of the desired compounds. Accordingly, an alternative 2-step synthetic route was developed to access analogous [Et₃NH][^{R}Si^{F}₂₄] compounds starting from RSiCl₃ precursors (FIG. 3, right). The wide variety of commercially available RSiCl₃ reagents and the facile preparations of RSiCl₃ (R=aryl) from Grignard reagents readily enables diversification of the R-group. Treating RSiCl₃ with two equivalents of Li₂(O₂C(CF₃)₂C(CF₃)₂) in MeCN results in LiCl precipitation and formation of [Li(NCMe)n][^{R}Si^{F}₂₄]. Cation exchange with excess [Et₃NH][CI] in water affords [Et₃NH][^{R}Si^{F}₂₄]. With this route, [^{R}Si^{F}₂₄]⁻ anions were accessed with a variety of solubilizing and bulky substituents. The solid-state structure of 3-[Et₃NH](FIG. 4, right) displays the same pseudo-trigonal bipyramidal geometry of the anion as 1-[Et₃NH].⁵² In this case, however, the hydrogen bonding interaction is observed with a fluoride, reminiscent of hydrogen bonding interactions observed in borates.⁵⁵⁻⁵⁷ The different preference, for F vs 0, highlights how changing group R impacts the properties of the anion, either by increasing the steric profile or by making the O less basic with the aryl substituent in 3-[Et₃NH] vs methyl in 1-[Et₃NH].

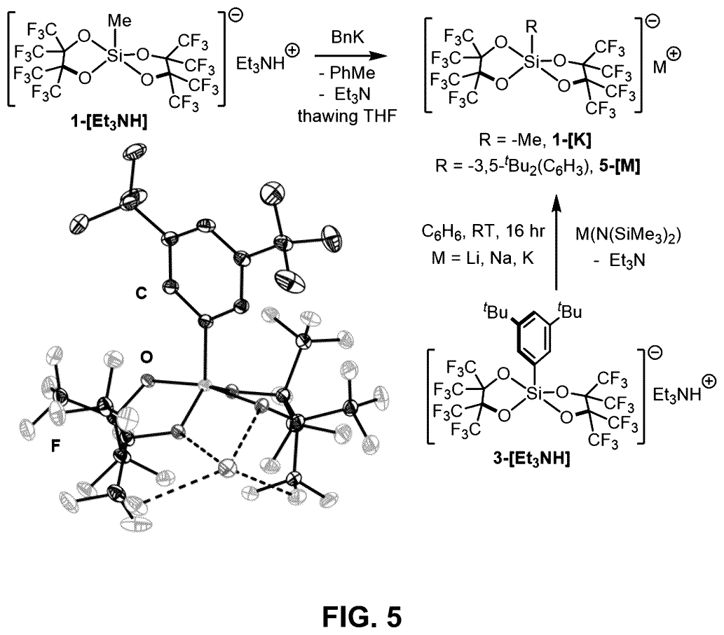

While all [Et₃NH][^{R}Si^{F}₂₄] variants were prepared on multi-gram batches, [Et₃NH][^{Me}Si^{F}₂₄] is noteworthy as an example of facile and high-yielding preparations that can produce over 60 g of the desired product (94% isolated yield) in one step from only commercially-available materials, enabling extensive further study of cations supported by this new class of WCA. Inspired by synthetic approaches in borate chemistry, where NaBArF₂₄ is a versatile intermediate,^{3-5,7,8} variants displaying alkaline metal cations were targeted. 1-[K] was prepared from 1-[Et₃NH] upon treatment with BnK (Bn=—CH₂Ph). While extensive diversification of [^{Me}Si^{F}₂₄]⁻ compounds from 1-[K] was demonstrated (vide infra), its low solubility in low polarity solvents (such as CH₂Cl₂ and aromatics), coupled with the challenge in preparation of ether-free 1-[K] limits its scope of applications. With the bulkier [^{Ar}Si^{F}₂₄](3-, Ar=3,5-t-butylphenyl) anion, ether-free 3-[M](M=Na⁺, K⁺) were readily accessed by treatment of 3-[Et₃NH] with the corresponding hexamethyldisilazide regents (M(N(SiMe₃)) in aromatic solvents (FIG. 5). For comparison, 3-[K] displays better solubility in dichloromethane (0.1 mmol/L in benzene, 0.4 mmol/L in dichloromethane) compared to 1-[K](0.1 mmol/L in benzene, 0.07 mmol/L in dichloromethane), while readily accessible Na variant, Na[^{Ar}Si^{F}₂₄], shows further improved solubility (2 mmol/L in benzene, 1.3 mmol/L in dichloromethane).

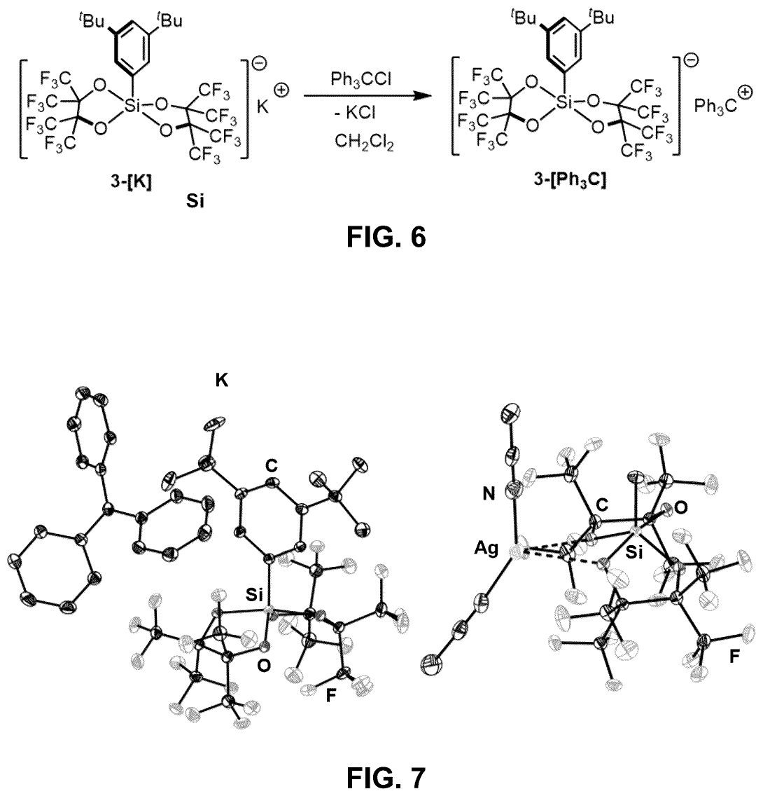

The [Ph₃C]⁺ cation is a versatile reagent for both hydride abstraction and chemical oxidation.^{2,9,58,59} While the [Ph₃C]⁺ cation could not be accessed via 1-[K] because of its exceedingly low solubility in CH₂Cl₂, the high solubility of 3-[K] in CH₂Cl₂ and lack of coordinated ether ligands allowed facile preparation of 3-[Ph₃C], demonstrating how the tunability of the R-group allows for accessing more reactive cations. (FIG. 6).

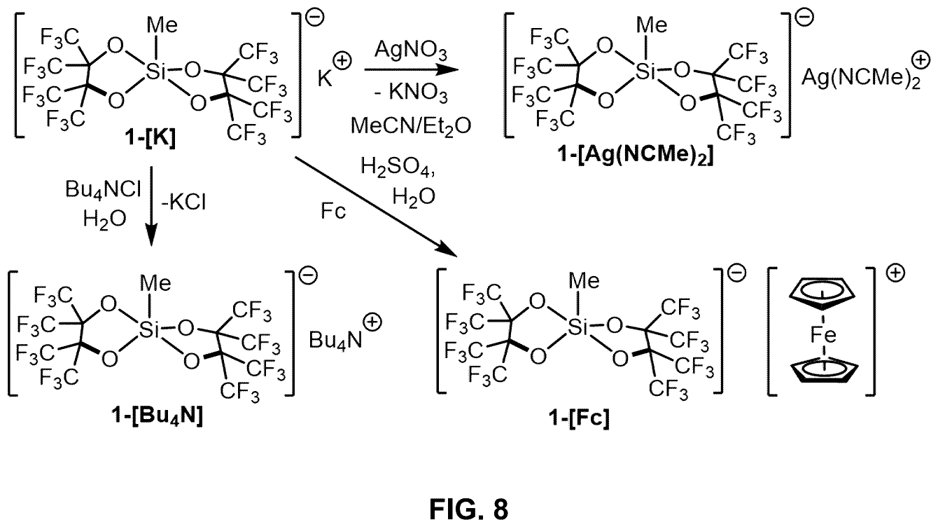

Other common oxidants in organometallic chemistry were prepared. Salt exchange of 1-[K] with AgNO₃ in MeCN/Et₂O mixture cleanly afforded 1-[Ag(NCMe)₂](FIG. 8). Silver salts can serve as both potent halide abstracting agents and strong oxidants.⁷ Targeting a milder oxidant, salt metathesis with [Fc]2[SO₄] in water afforded 1-[Fc] as a fine r powder. Upon removing volatile materials in vacuo at 60° C. followed by recrystallization, anhydrous 1-[Fc] was obtained as large, blue, translucent blocks.

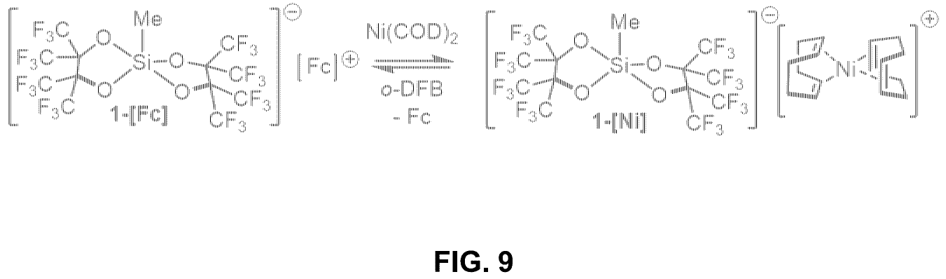

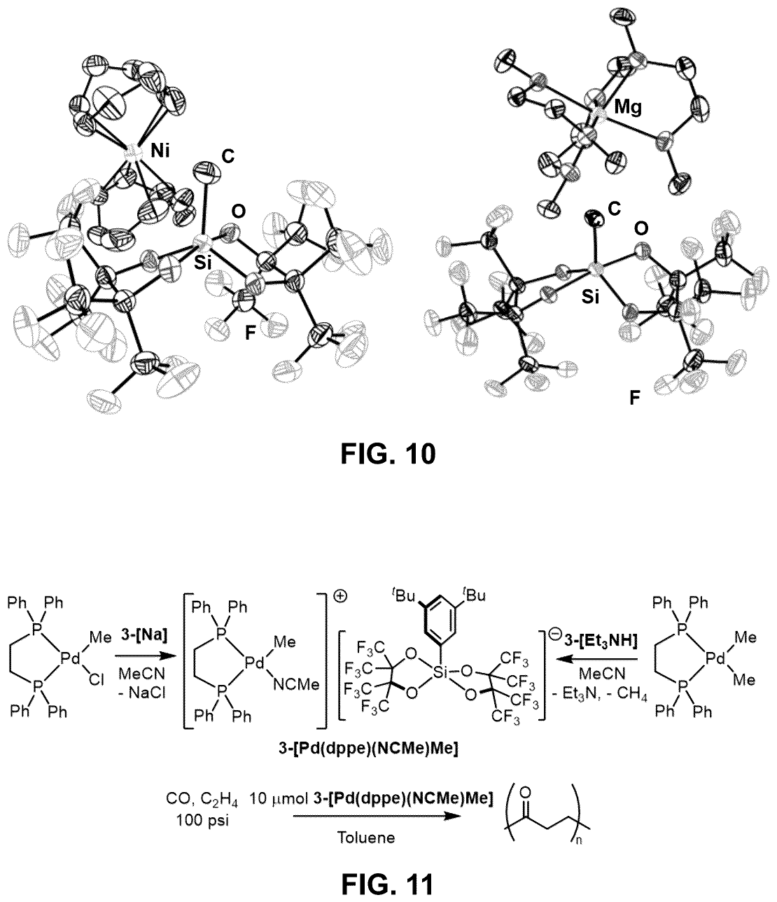

Ni(COD)₂ (COD=1,5-cyclooctadiene) was identified as a candidate for chemical oxidation with 1-[Fc]. Chemical oxidation of Ni(COD)₂ with more oxidizing 1-[Ag(NCMe)₂] was precluded because of coordinated MeCN molecules, potentially reactive with the Ni center. While Ni^{I} species underly catalytic transformations such as cross coupling, photoredox, and electrocatalysis, there are very few examples of Ni^{I} precursors.⁶⁰ Even fewer are examples of Ni^{I} precursors that are only bound to readily-displaceable olefinic ligands, and only one example of the [Ni(COD)₂]⁺ cation was reported—supported by an especially weakly coordinating anion, [Al(OC(CF₃)₃)₄]⁻.⁶¹⁻⁶³ Oxidation of Ni(COD)₂ in o-DFB (ortho-difluorobenzene) with stoichiometric 1-[Fc] affords a mixture of 1-[Ni(COD)₂], unreacted 1-[Fc] and Ni(COD)₂, suggesting an equillibrium process (FIG. 9). Mechanical separation of crystals allowed for structural determination of 1-[Ni(COD)₂](FIG. 10, left).⁵² Gratifyingly, the [^{Me}Si^{F}₂₄] anion was found to be weakly-coordinating towards the [Ni(COD)₂]⁺ cation.

To explore application in a catalytic organometallic system, [Pd(dppe)(solvent)Me]+[Si^{F}₂₄] was generated from precatalysts Pd(dppe)MeCl and Pd(dppe)Me₂ by halide abstraction and protonation of a metal-alkyl bond, respectively.

The cationic Pd-Me species has been reported to be competent for the alternating copolymerization of ethylene and carbon monoxide to generate polyketones.⁶⁴⁻⁶⁵ Under typical activation conditions, [Pd(dppe)(solvent)Me]+[BAr^{F}₂₄]⁻, is prepared from reaction with NaBAr^{F}₂₄. Generation of the cationic active species was probed with 3-[Na](FIG. 11). The salt metathesis proceeds cleanly, forming the cationic Pd compound by precipitation of NaCl. Analysis of the product by ¹H and ³¹P NMR in CDCl₃ revealed full conversion to the desired product, with a diagnostic pair of inequivalent, coupled ³¹P resonances at δ 60.7 ppm and δ 38.6 ppm, shifted from those of the starting material (δ 59.1 ppm and δ 30.7 ppm). The same cationic species has also been accessed by protonation of Pd(dppe)Me₂ with [(Et₂O)₂H][BAr^{F}₂₄].^{66,67} Conveniently, analogous reactivity was observed with 3-[Et₃NH](FIG. 11). Under 100 psi of C₂H₄/CO, 3-[Pd(dppe)(NCMe)Me] is catalytically active (activity=1.7 g mmol⁻¹ hr¹) and exhibits activity similar to the system with the [BAr^{F}₂₄] anion ([Pd(dppe)(NCMe)Me][BAr^{F}₂₄], activity=2.3 g mmol⁻¹ hr⁻¹).

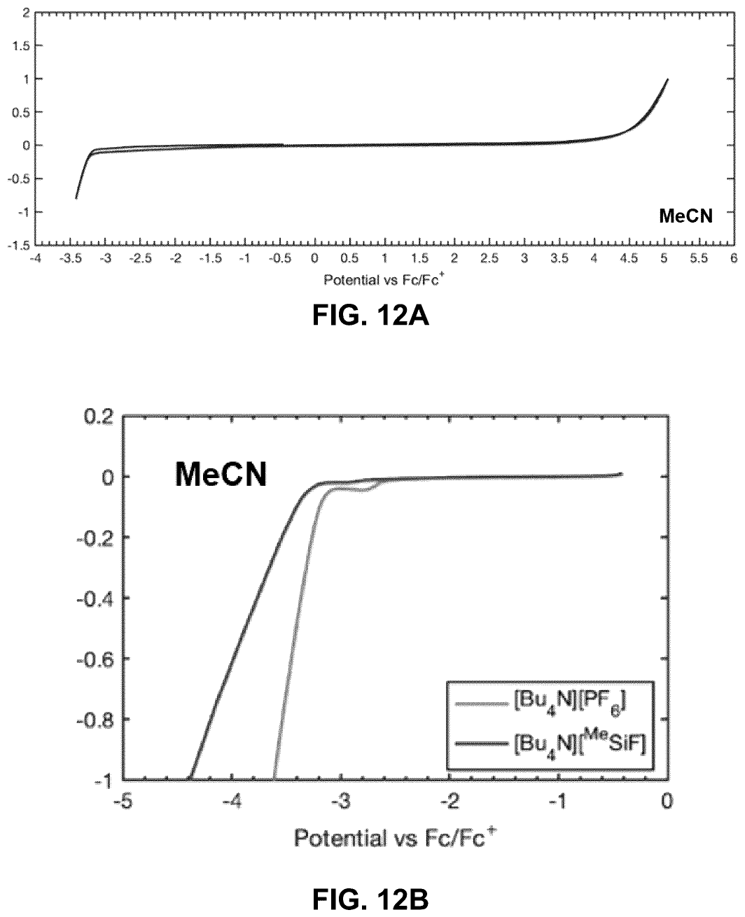

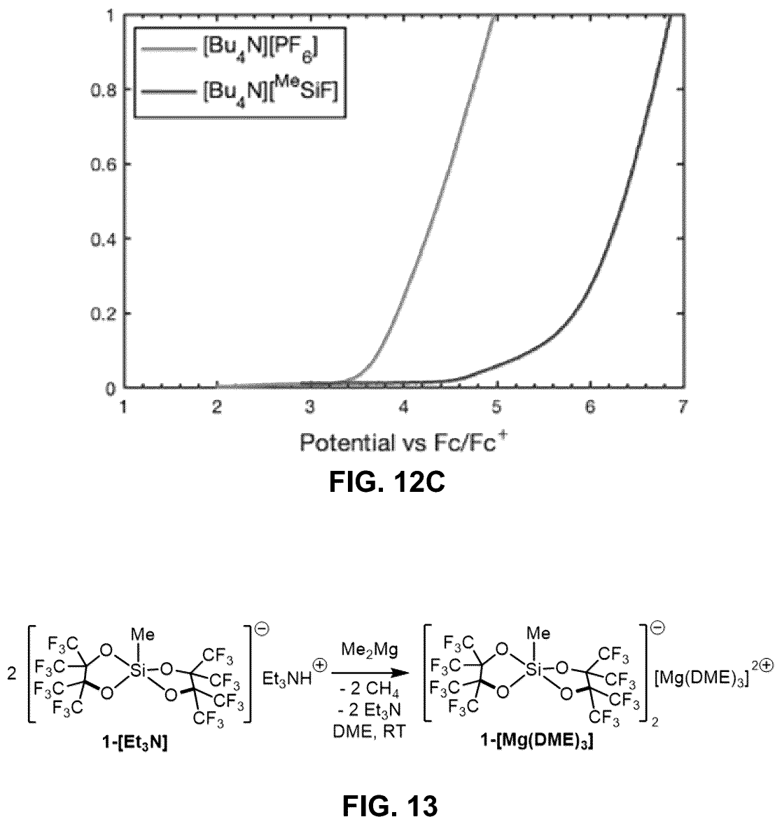

The electrochemical stability window of this novel class of WCAs is of interest. Therefore, the electrochemistry of 1-[Bu₄N] was evaluated with cyclic voltammetry (CV) and linear sweep voltammetry (LSV) (FIGS. 12A-12C) and compared to that of [Bu₄N][PF₆], a common electrolyte employed in electrochemical characterization of coordination compounds. While ^{Me}Si^{F}₂₄ and PF₆⁻ anions have effectively the same reductive stability in MeCN of ca. −3.1 V vs. Fc/Fc⁺, the [^{Me}Si^{F}₂₄] anion is stable up to 4.5 V vs. Fc/Fc⁺, surpassing the oxidative stability of PF₆—by ca. 1 V. Together, 1-[Bu₄N] has an exceptionally wide stability window of ca. 7.5 V in MeCN, highlighting its potential for supporting highly oxidizing, electrophilic cations in both chemical and electrochemical oxidation reactions.

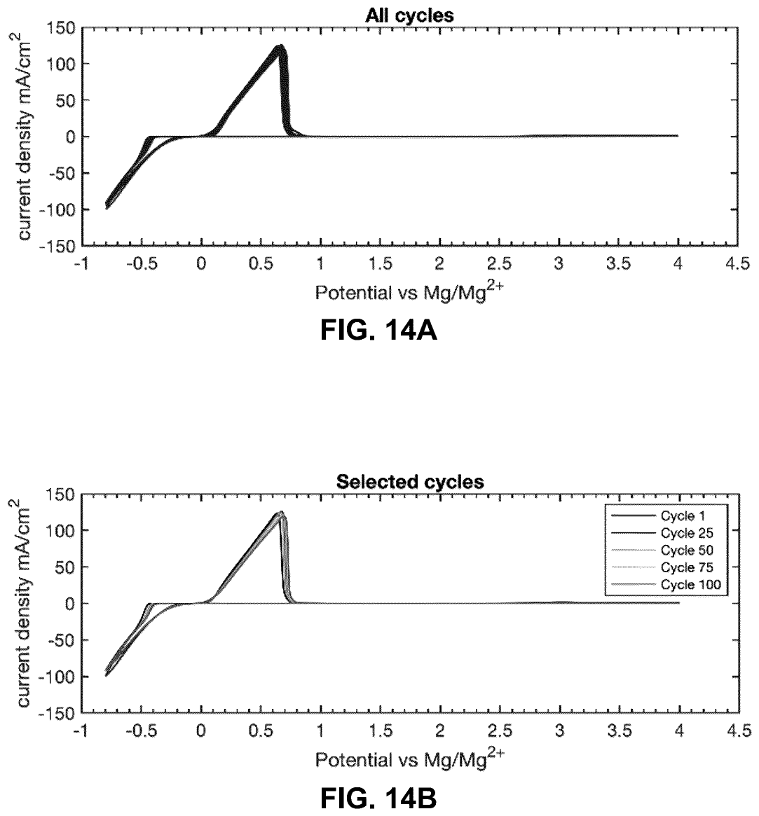

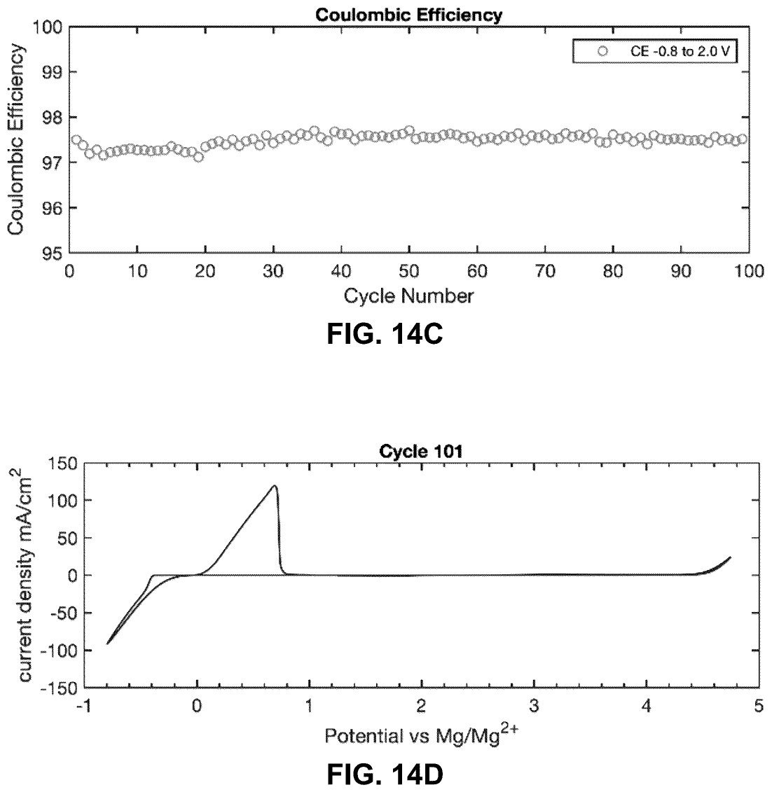

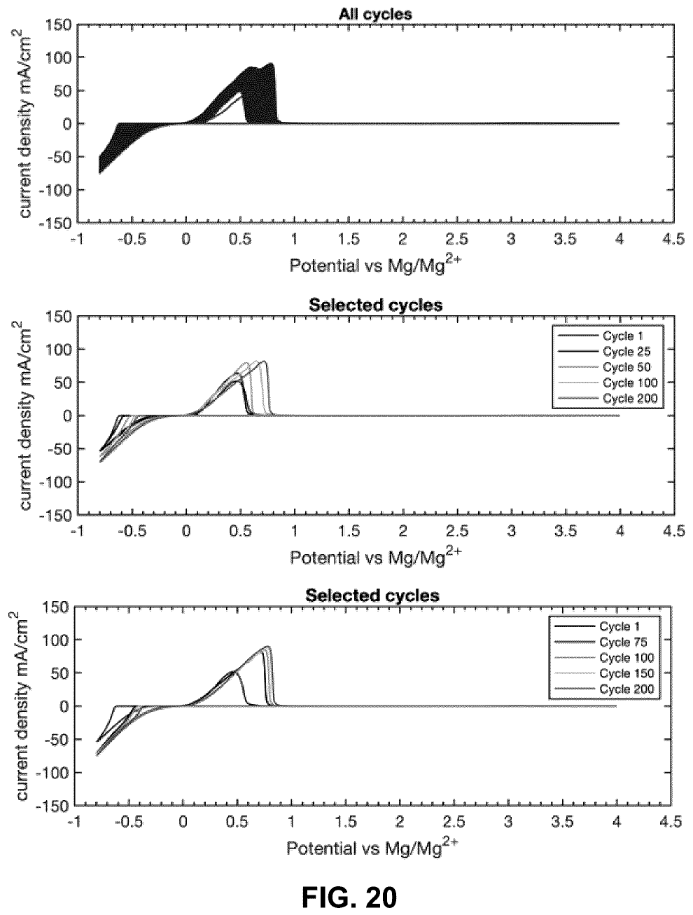

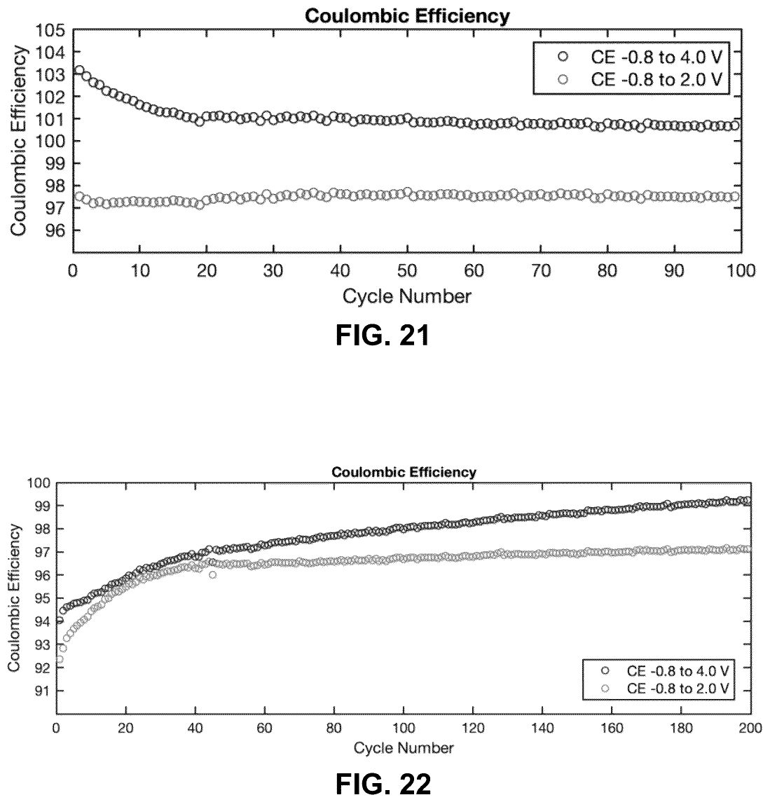

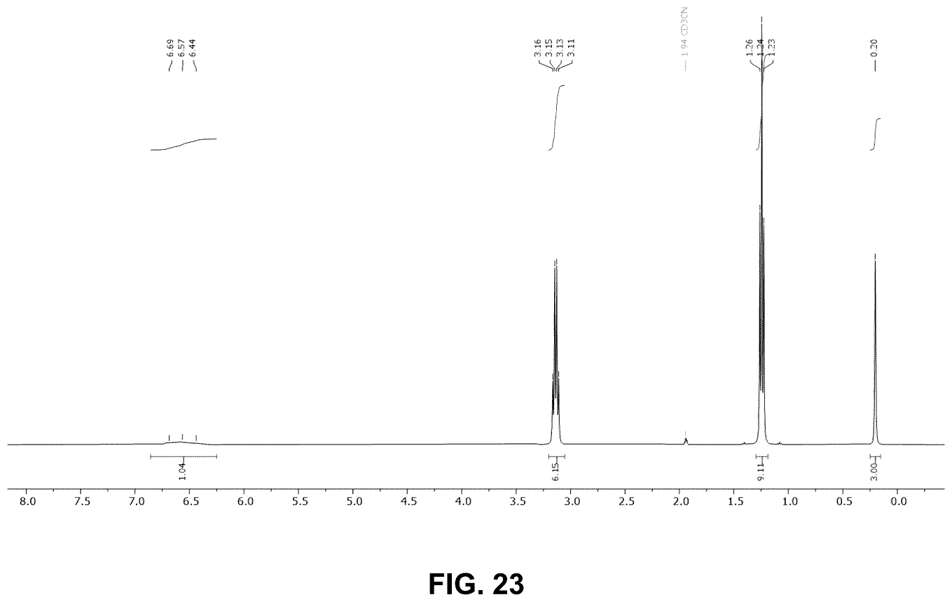

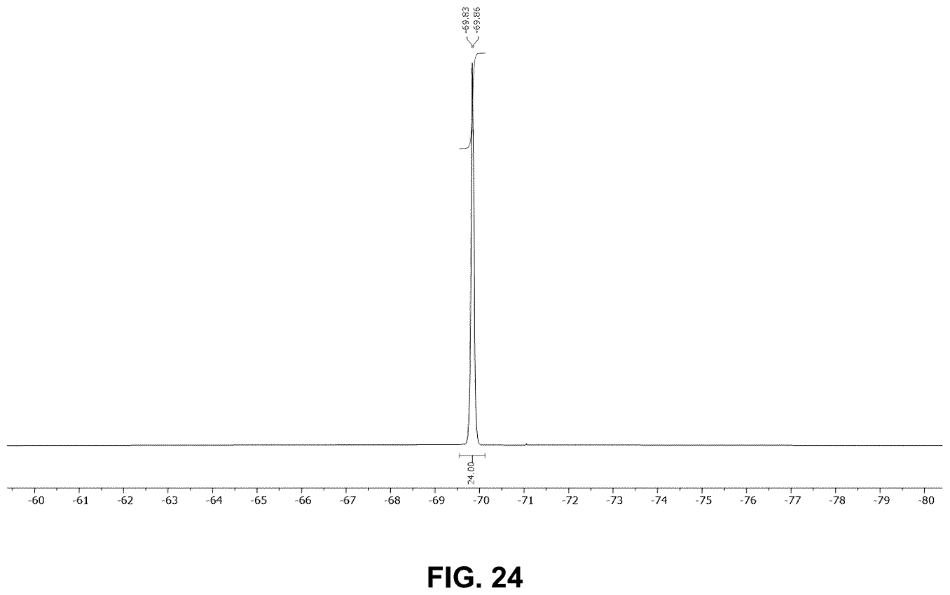

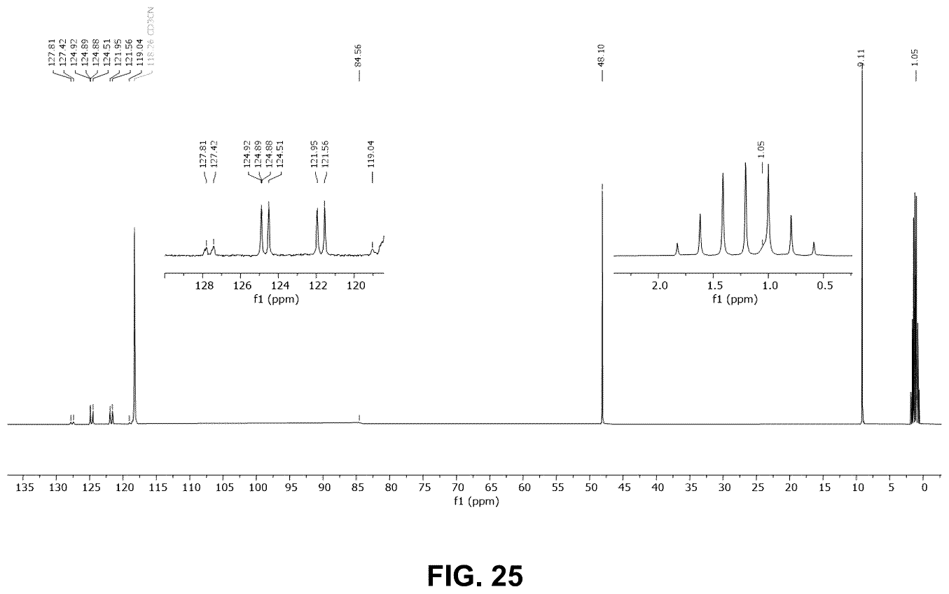

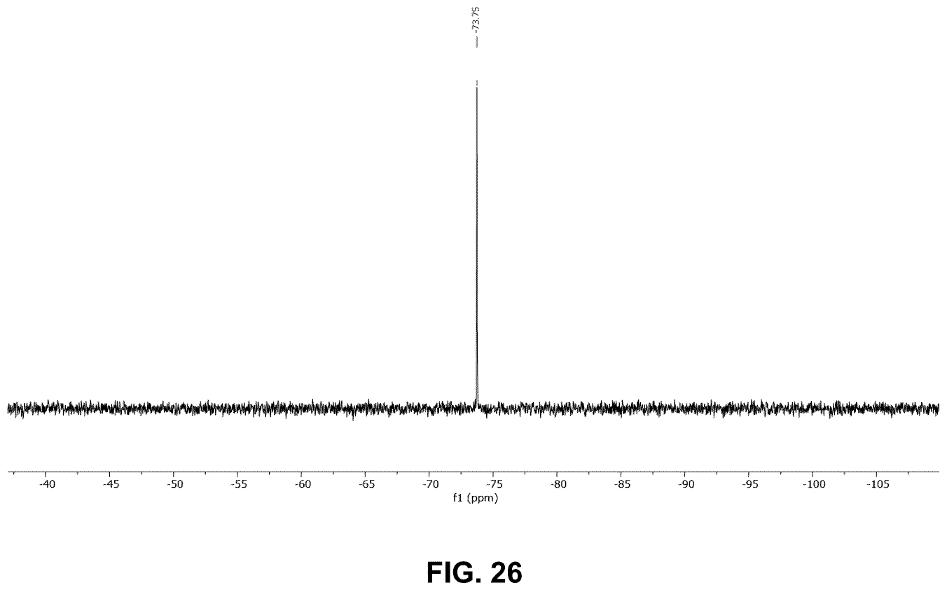

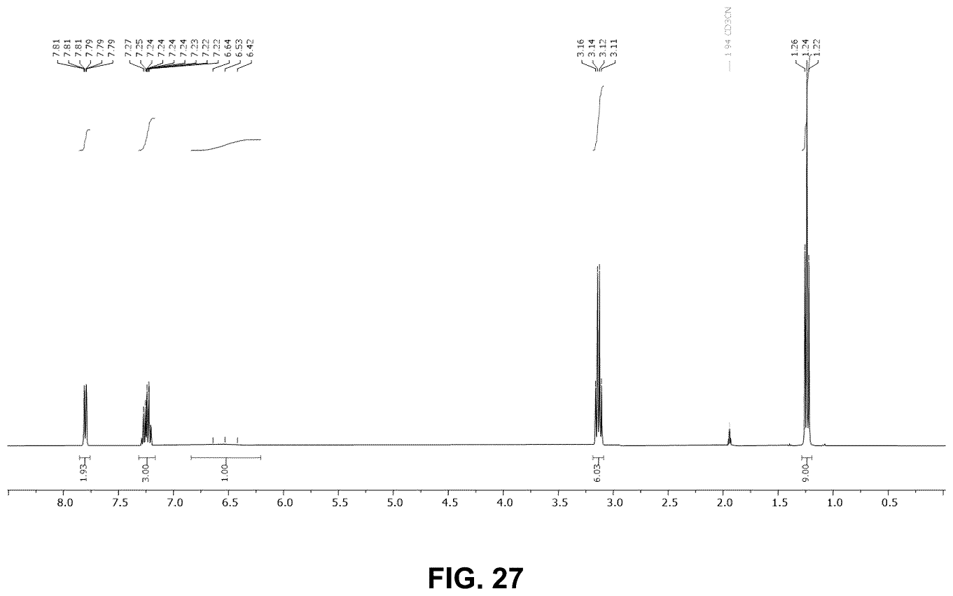

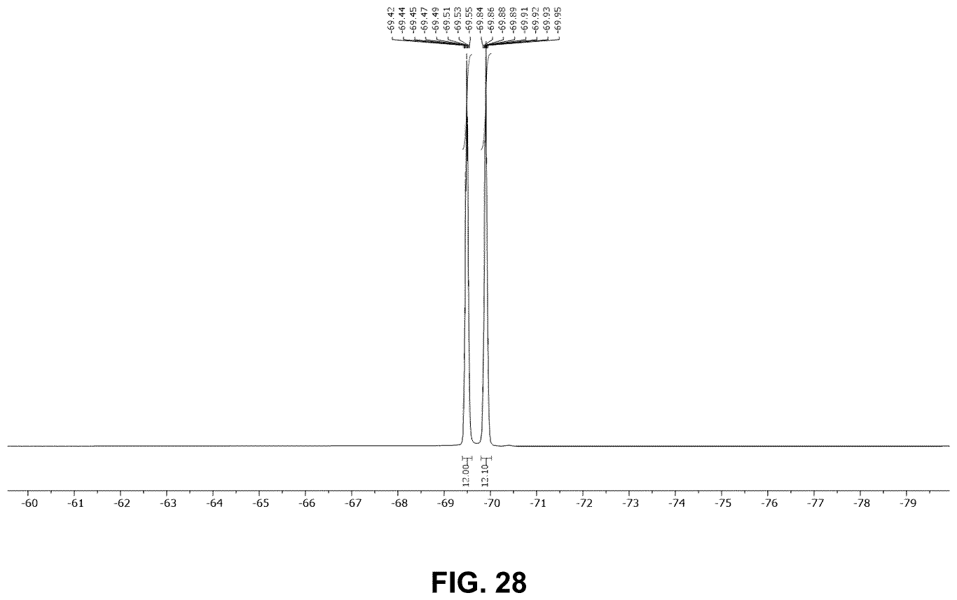

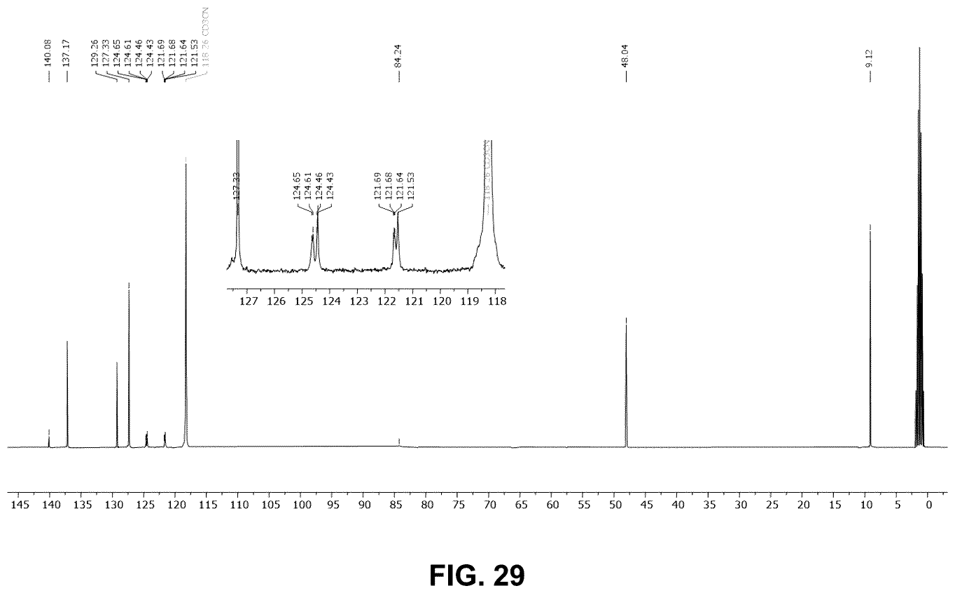

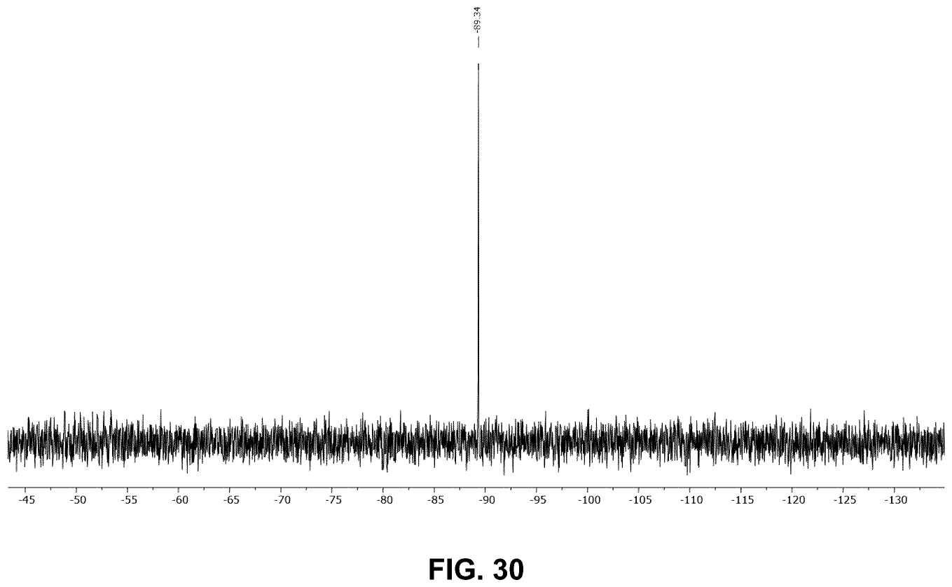

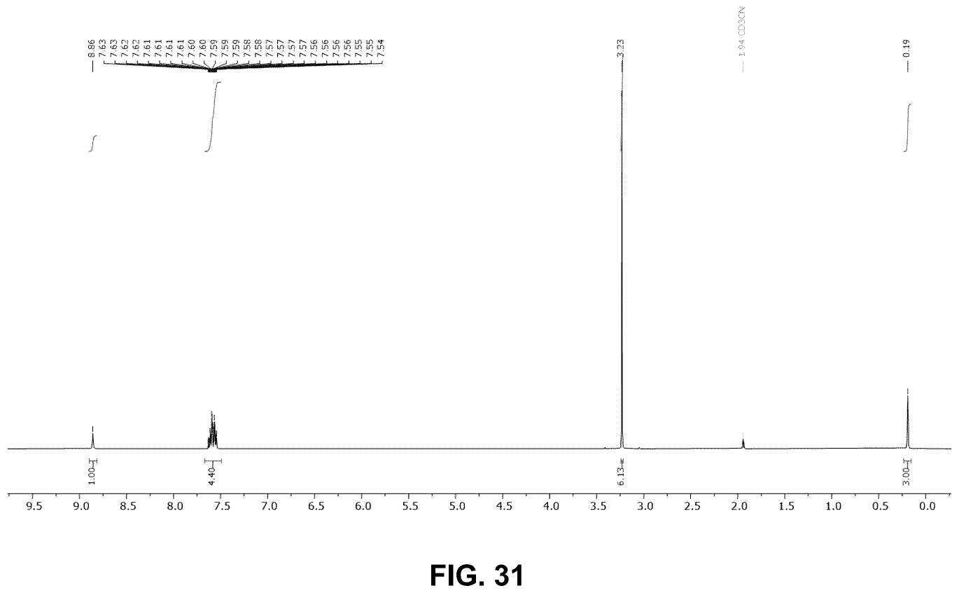

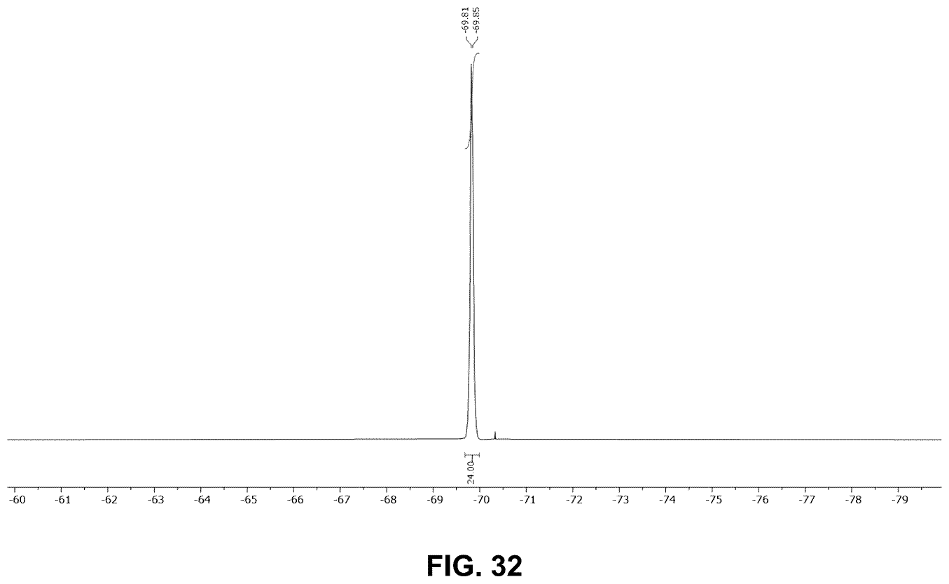

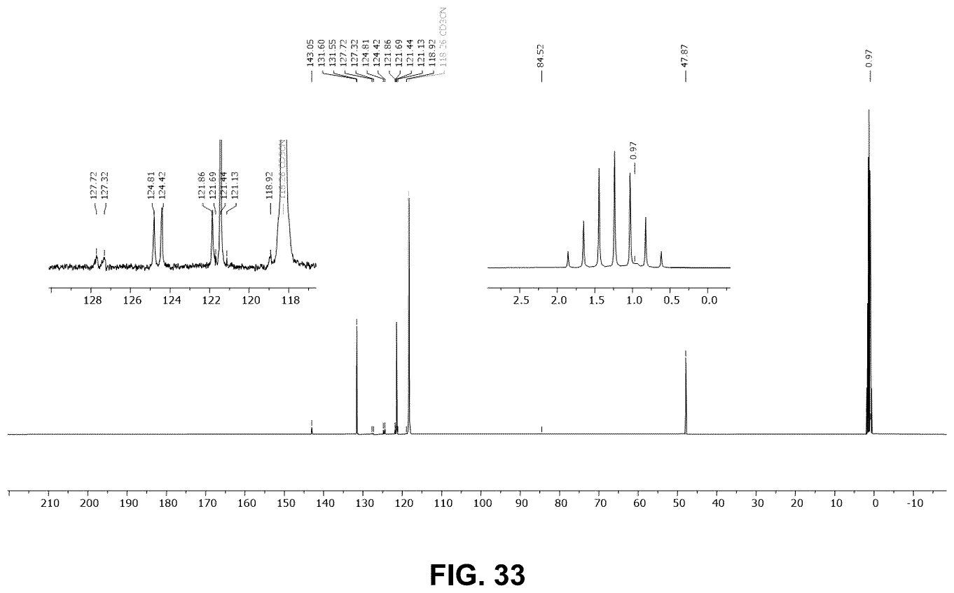

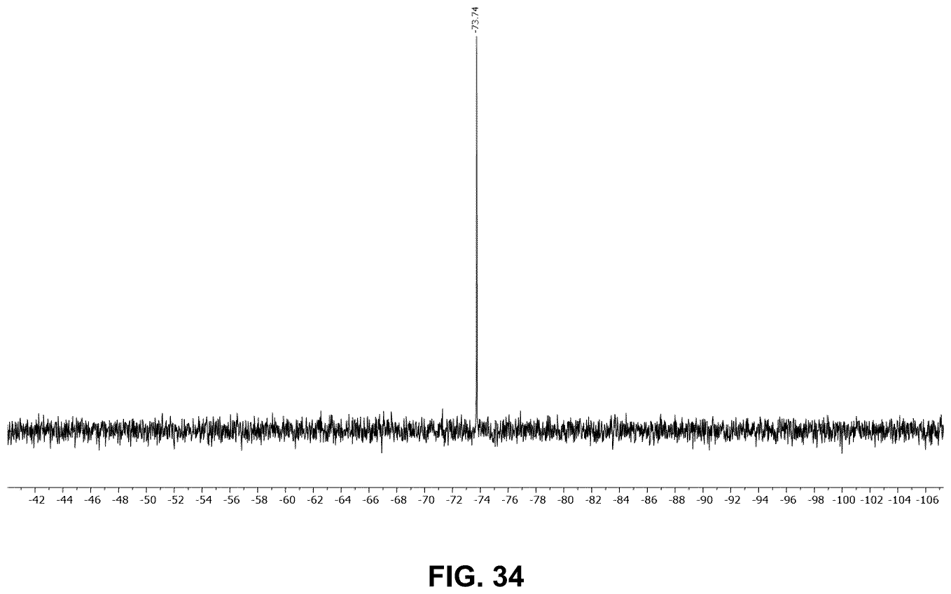

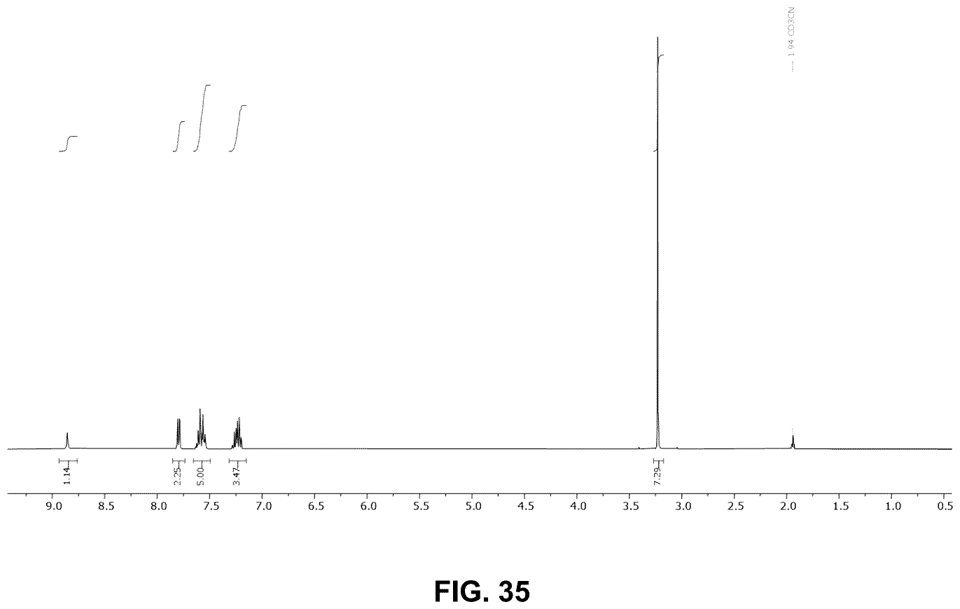

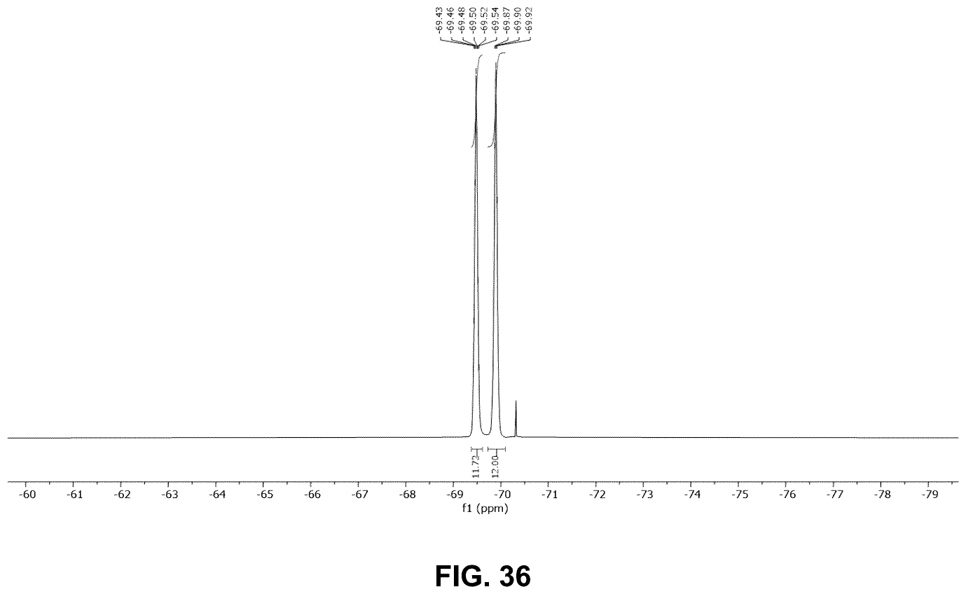

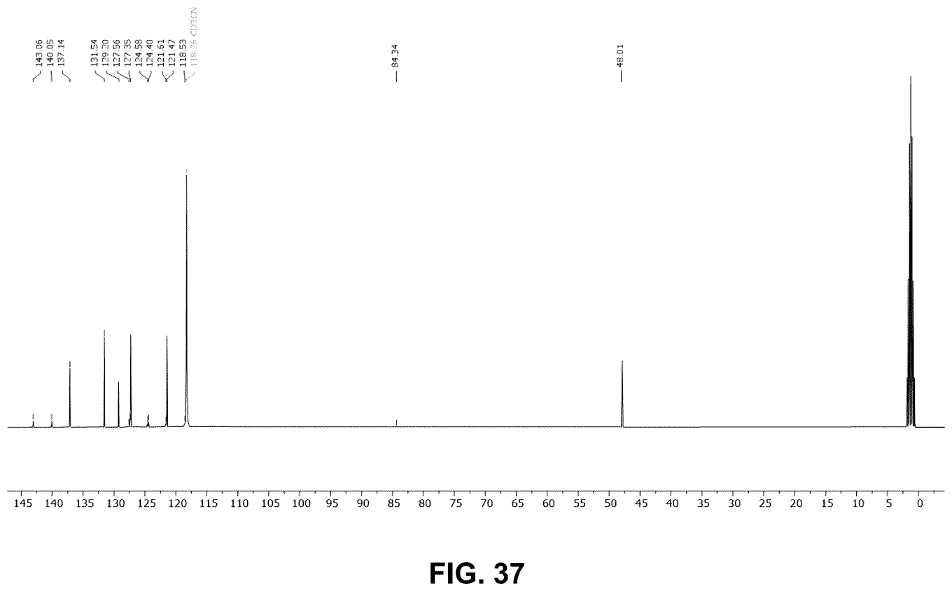

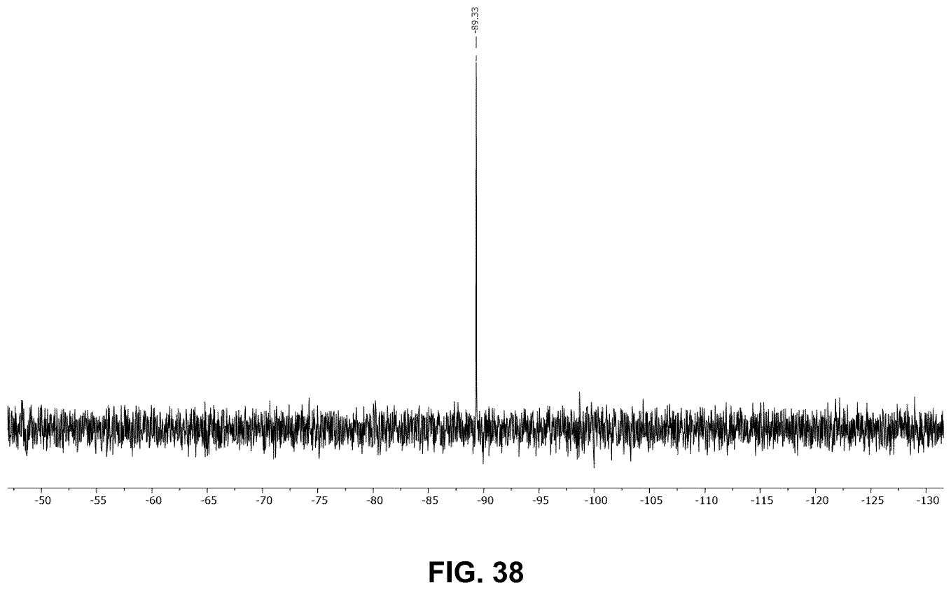

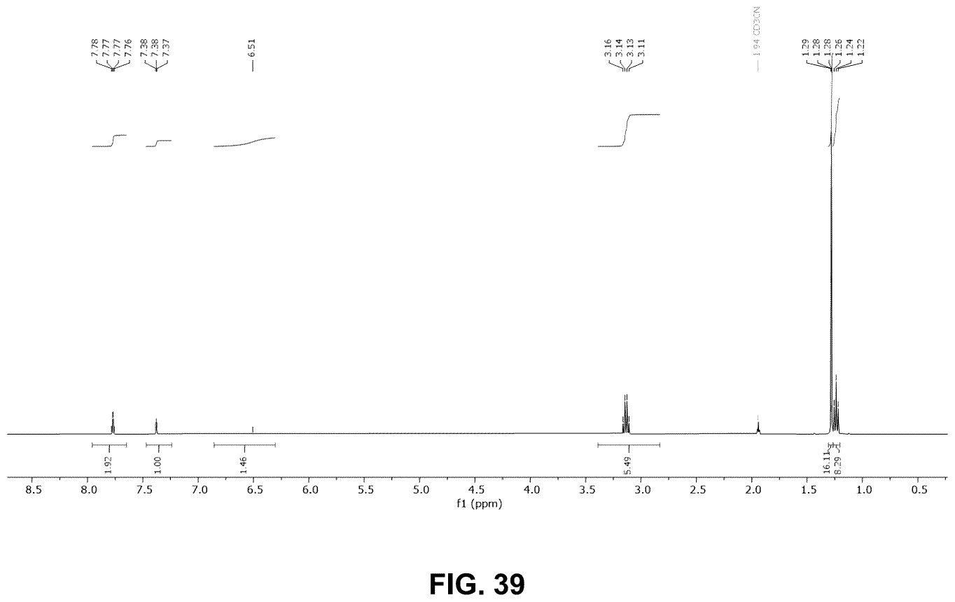

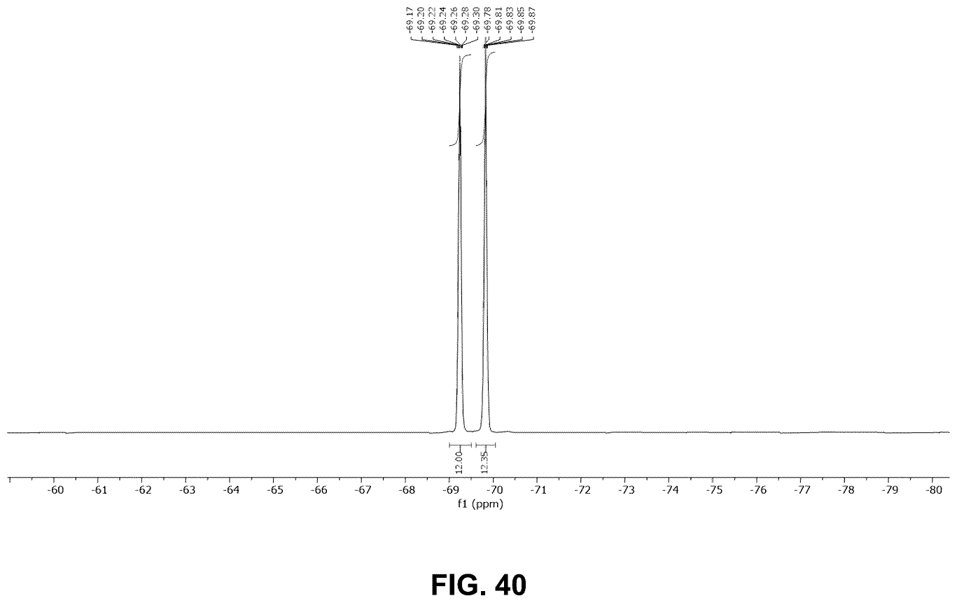

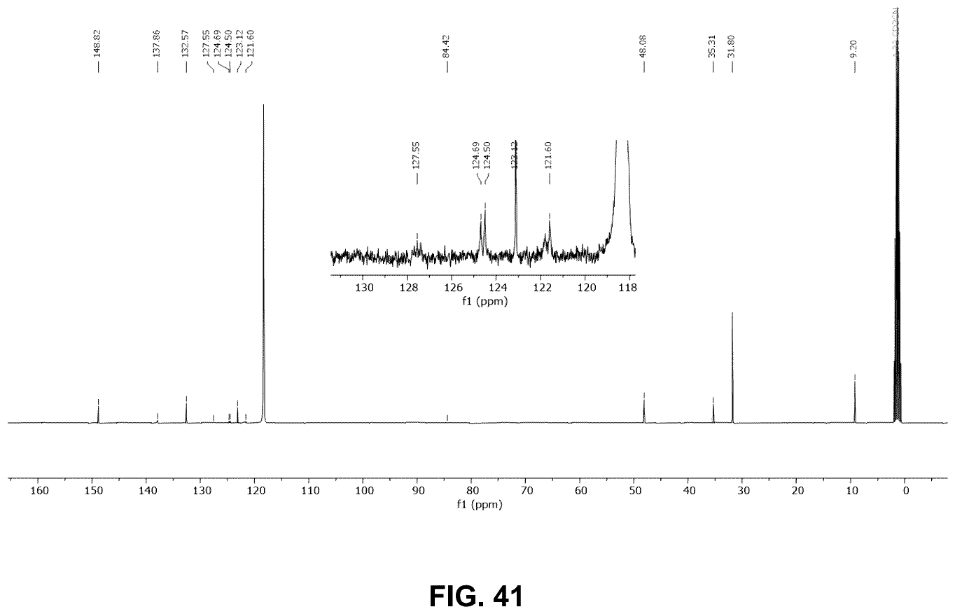

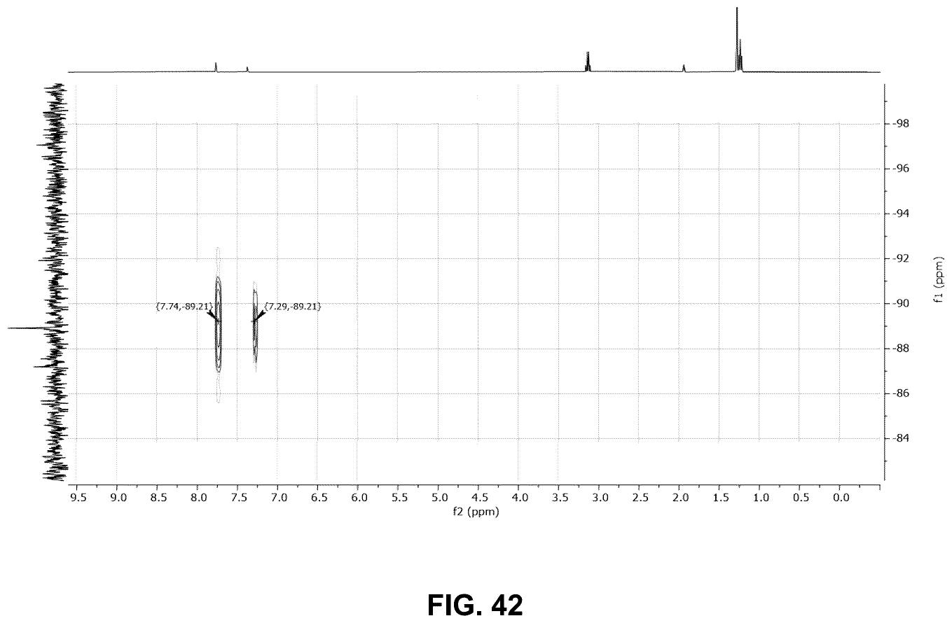

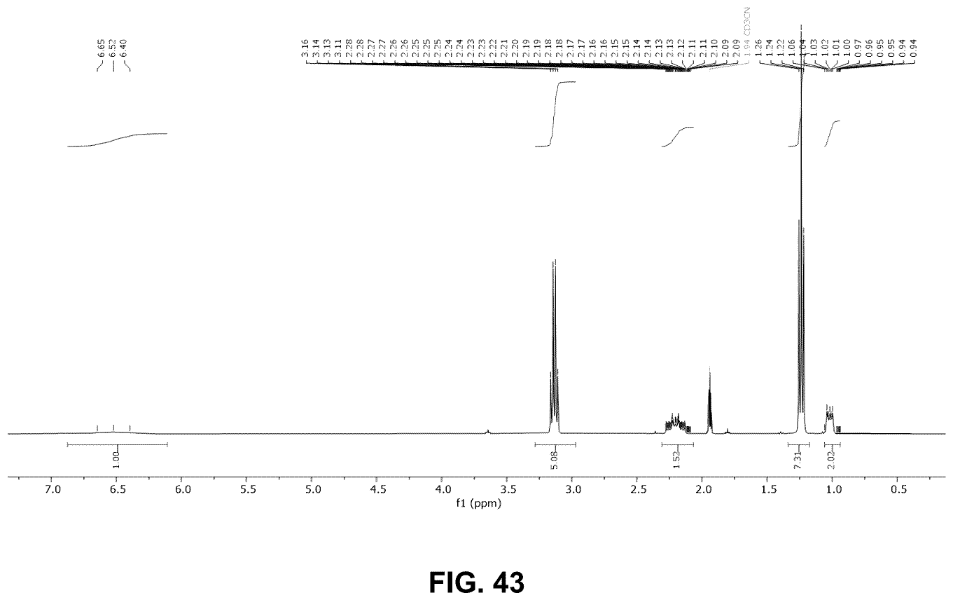

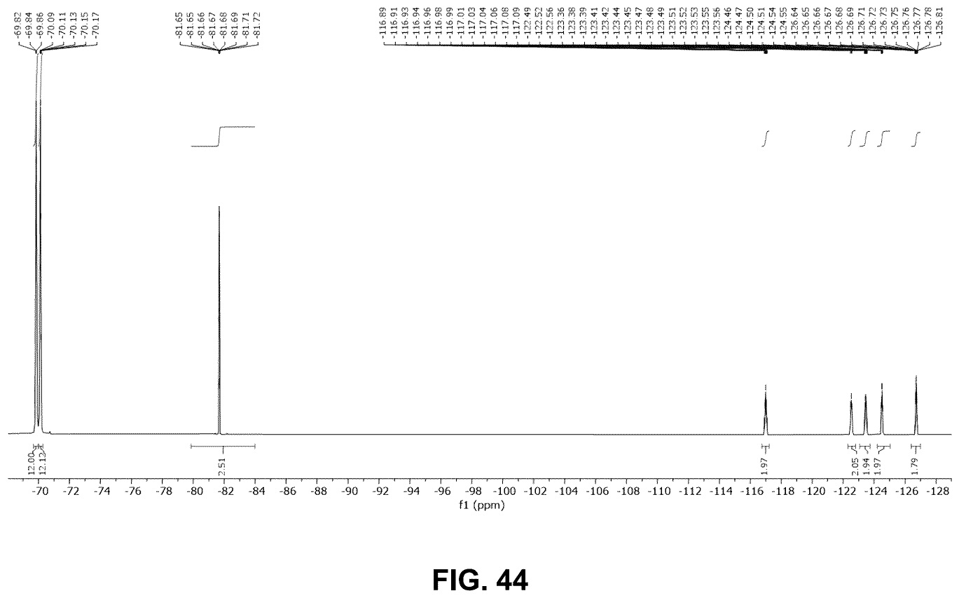

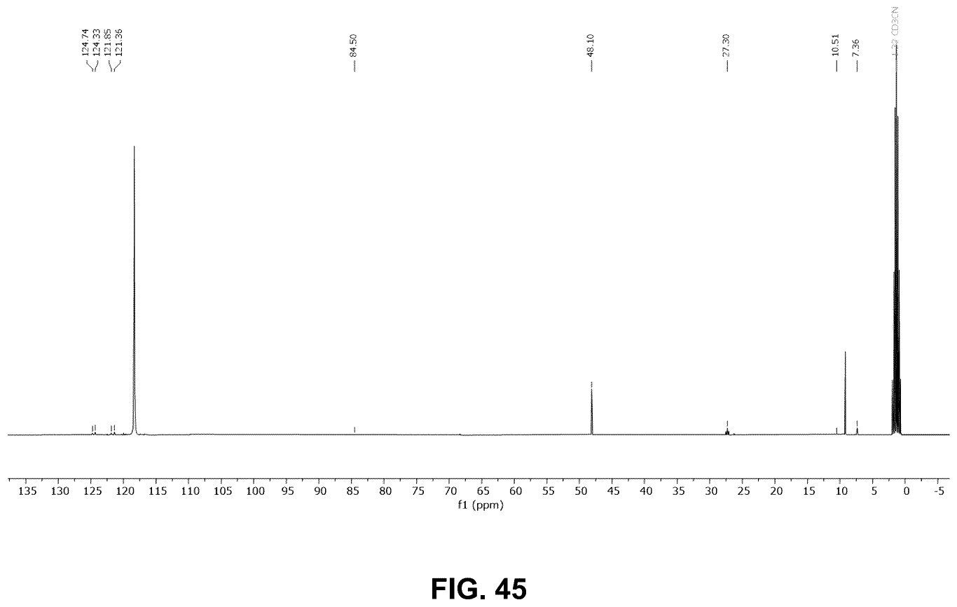

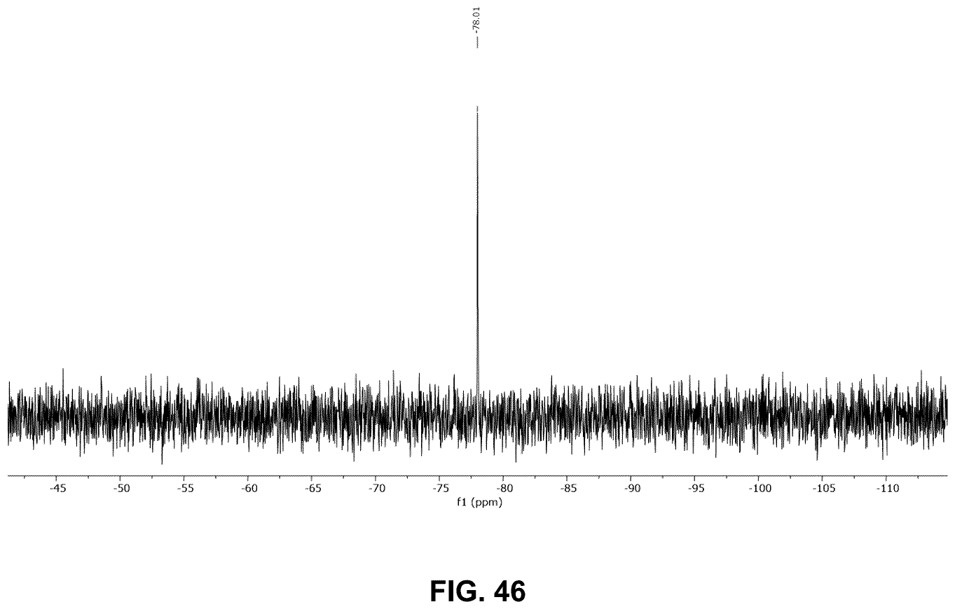

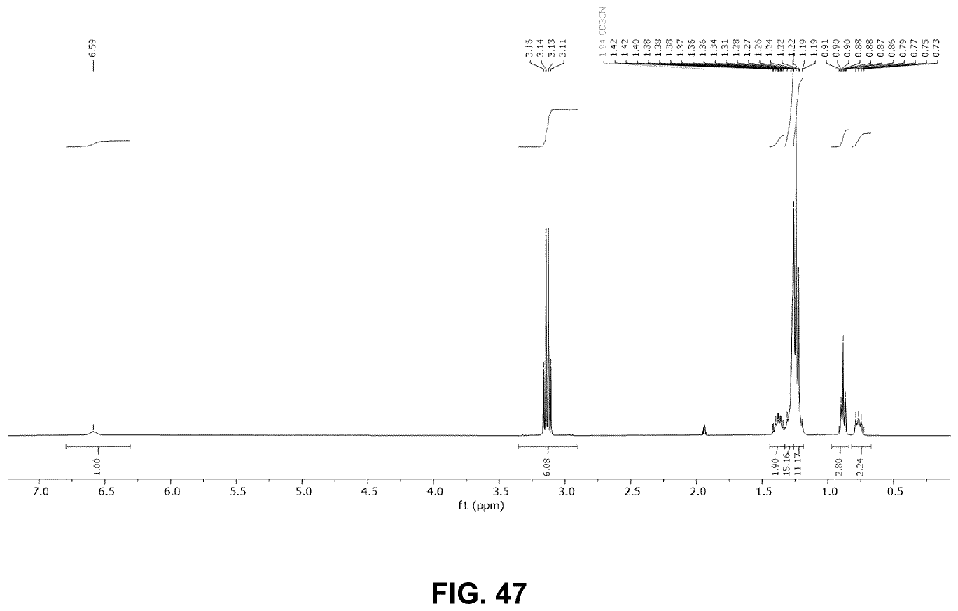

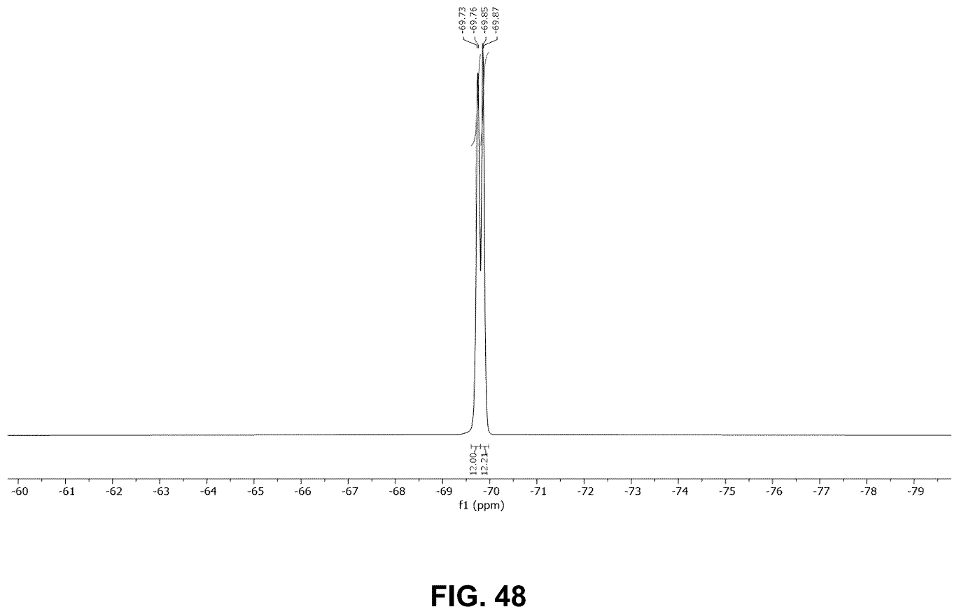

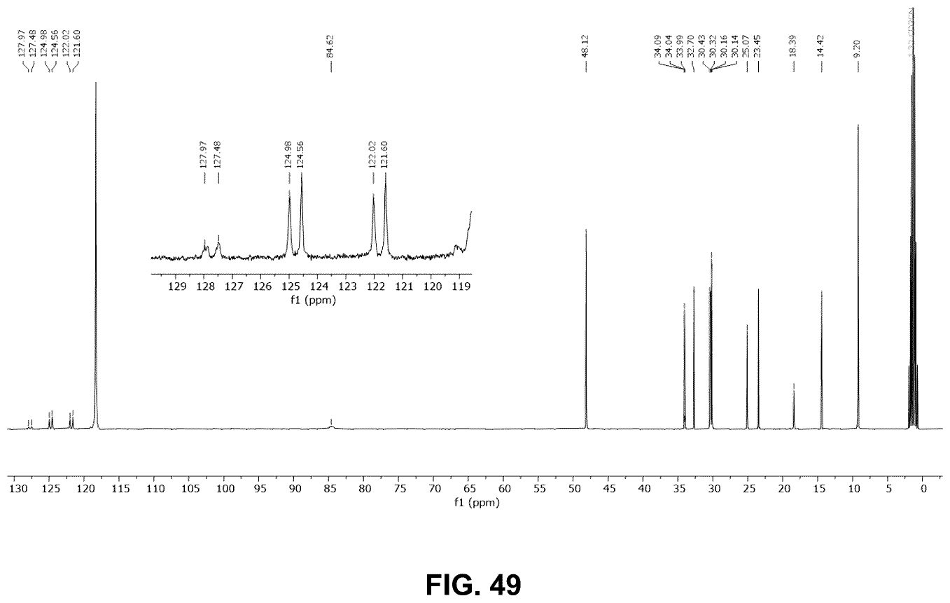

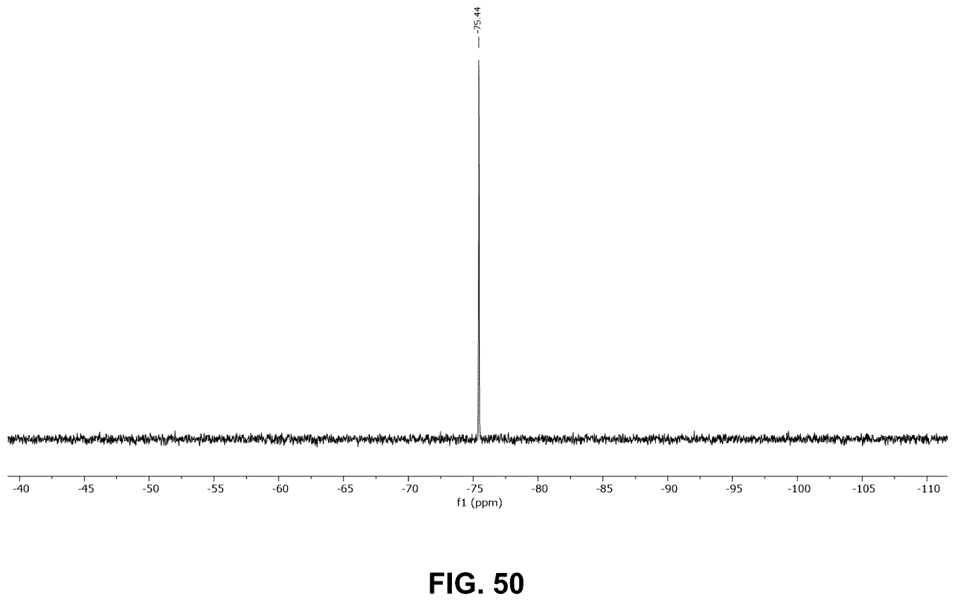

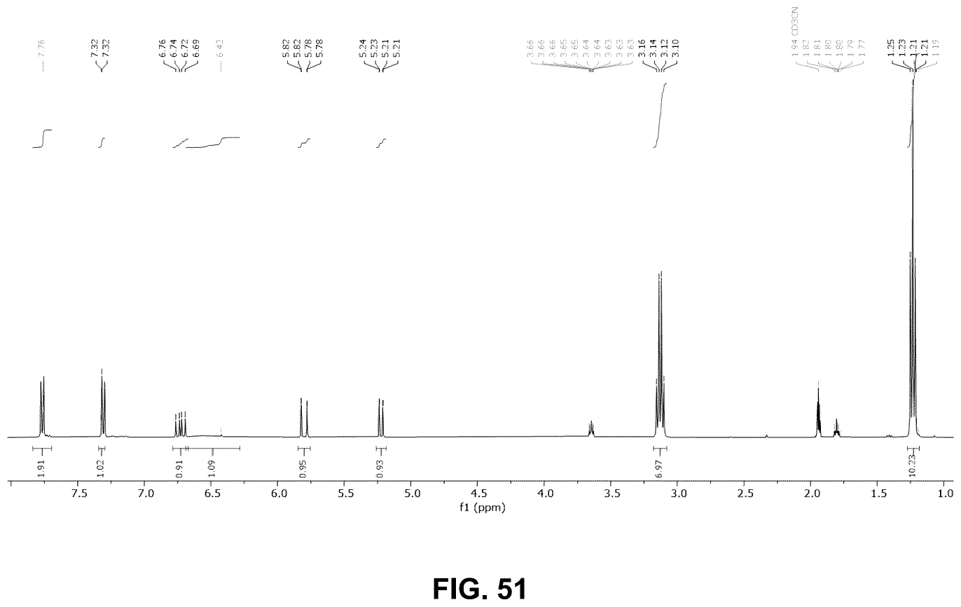

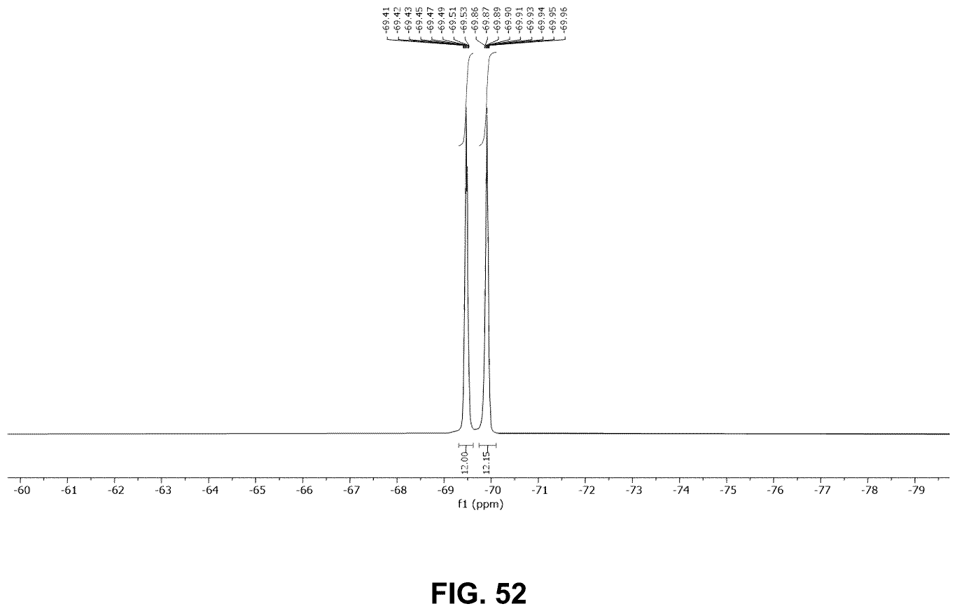

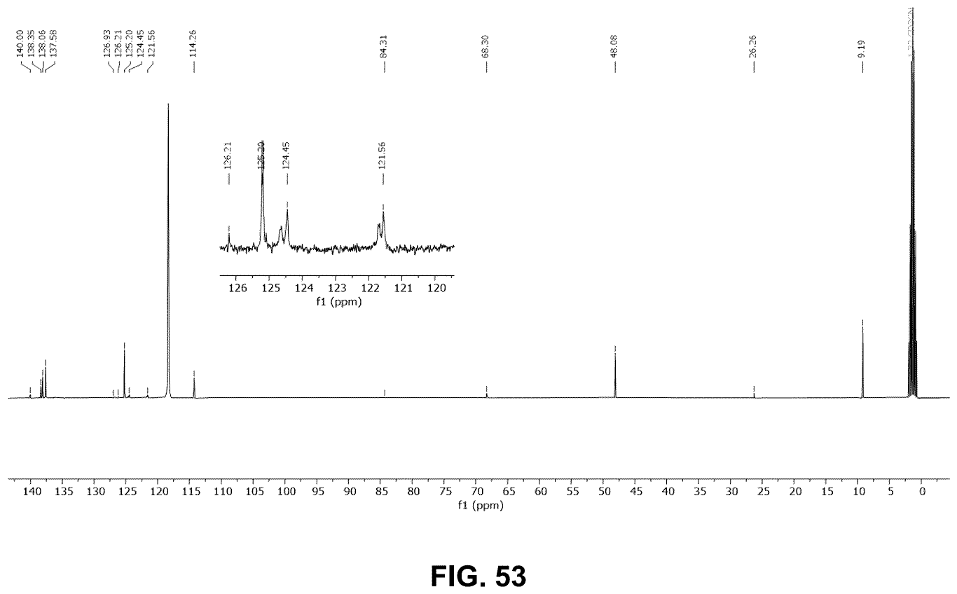

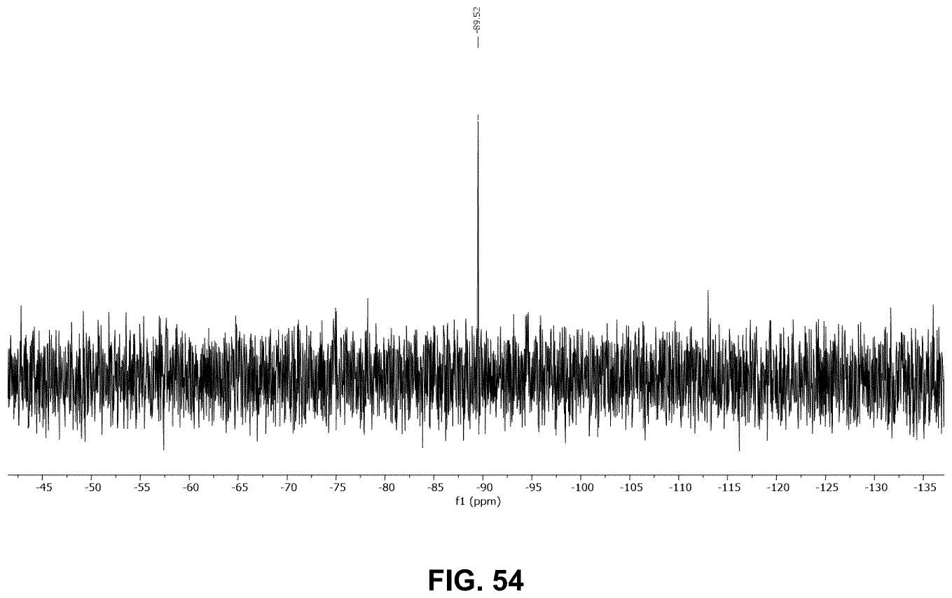

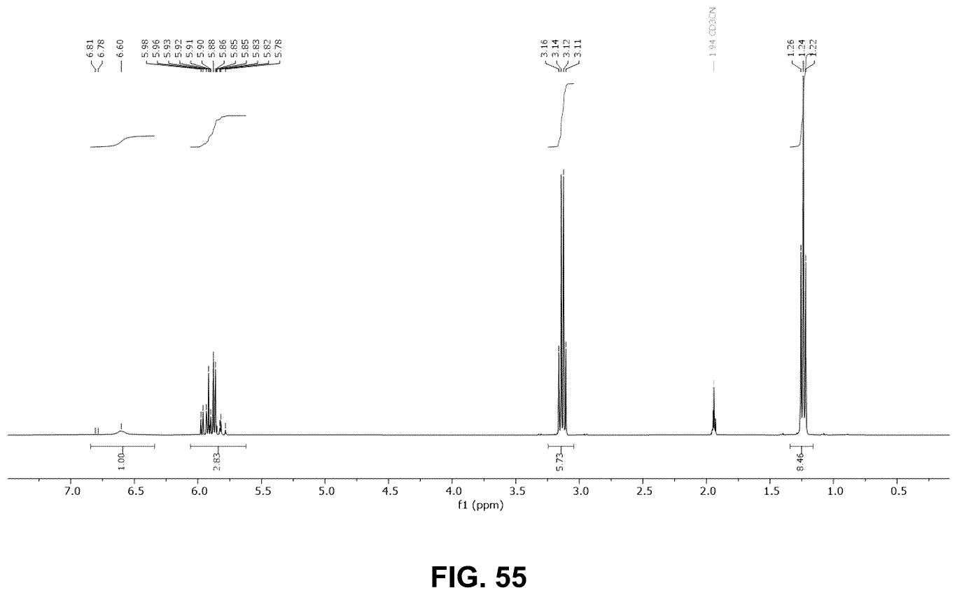

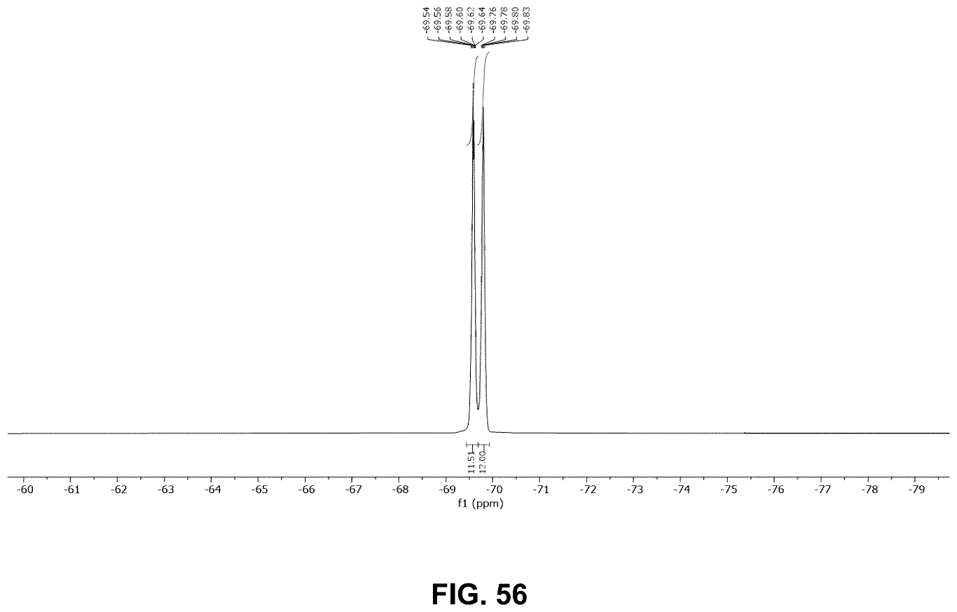

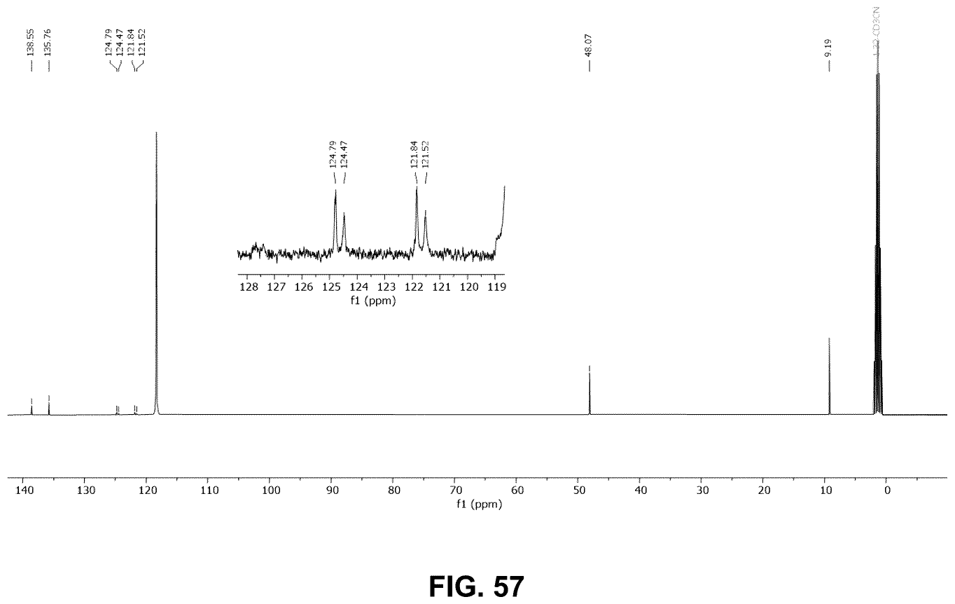

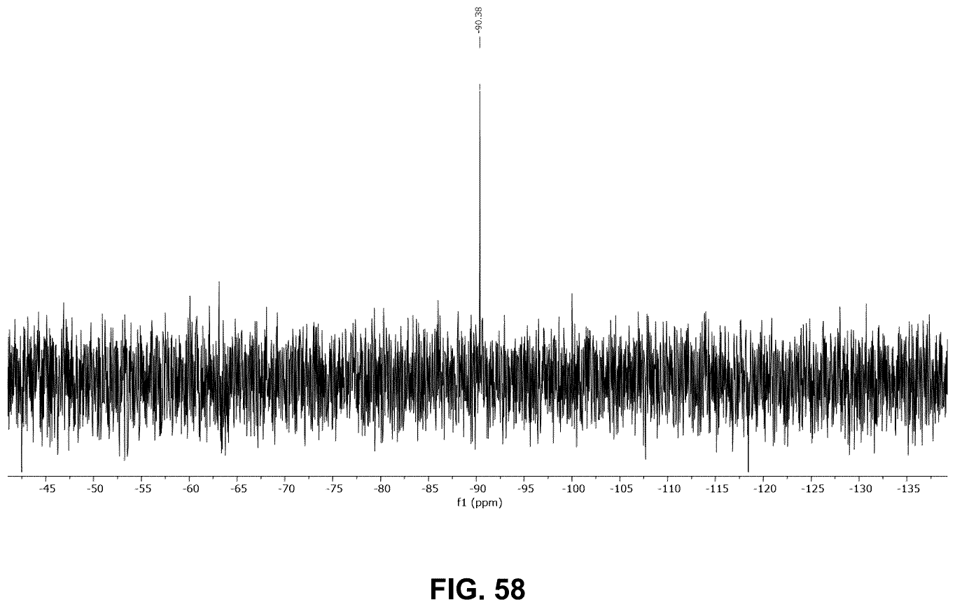

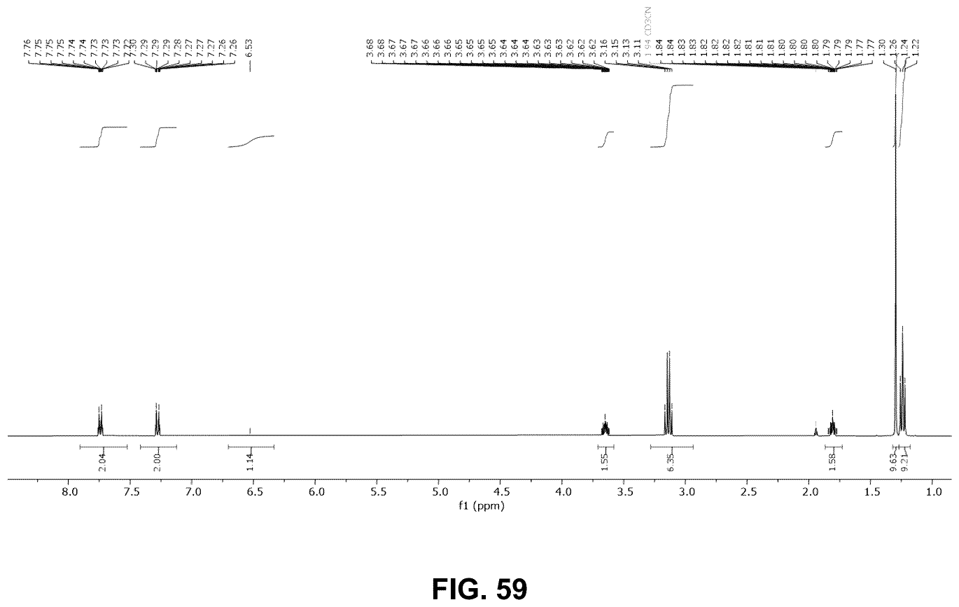

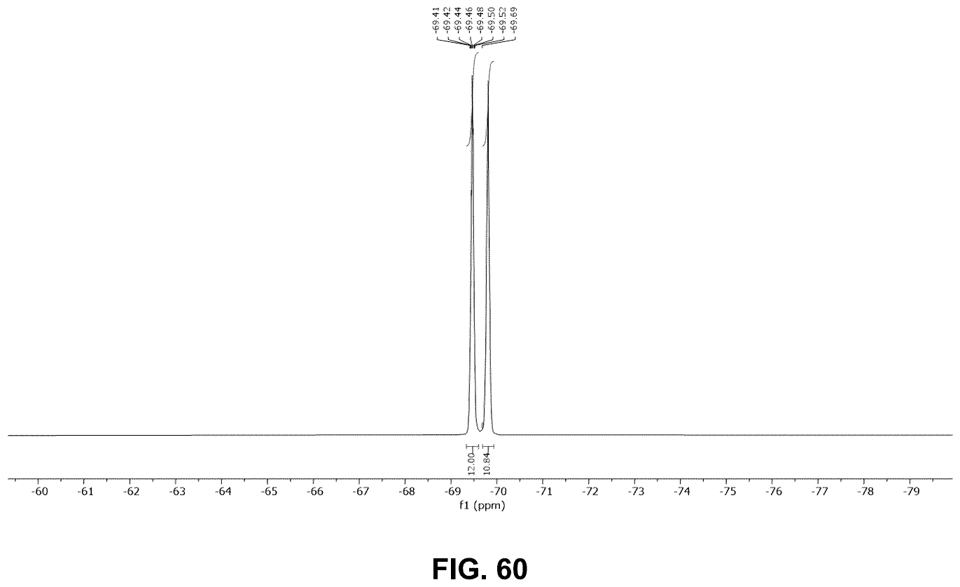

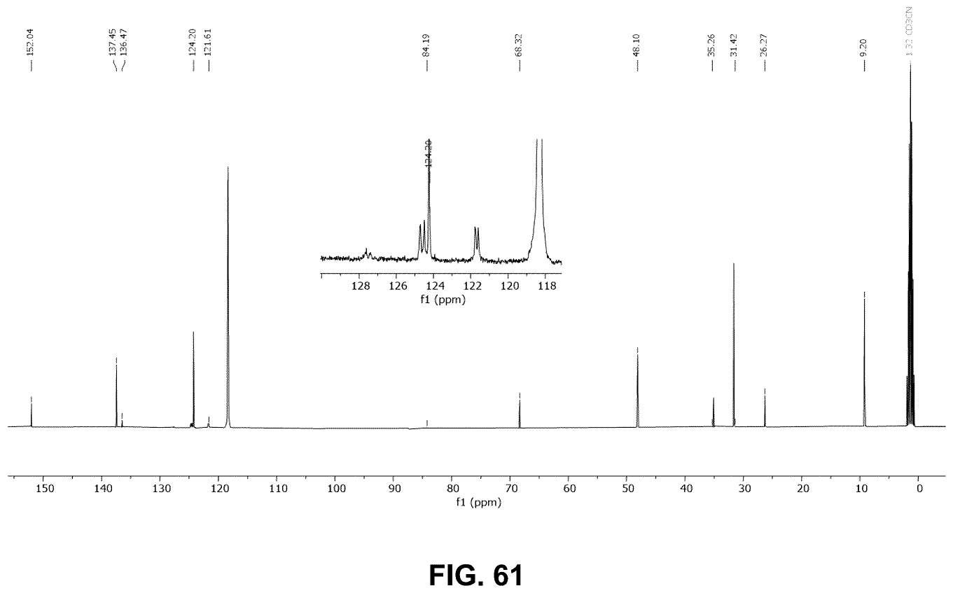

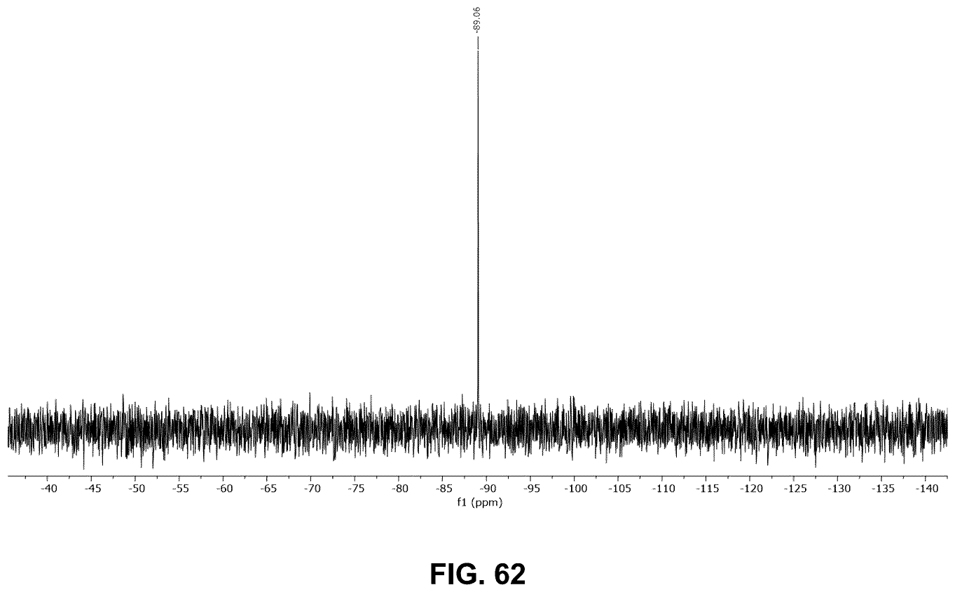

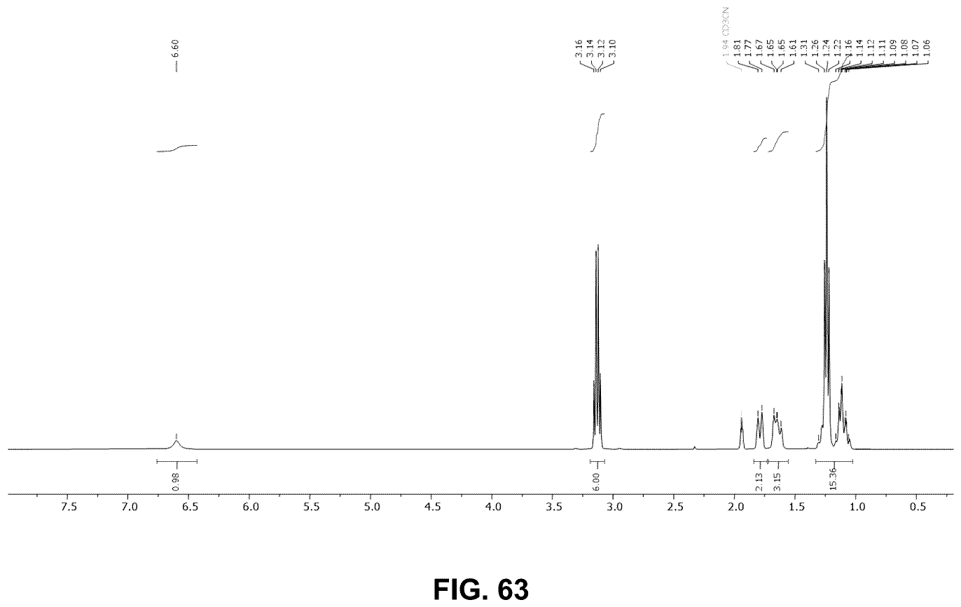

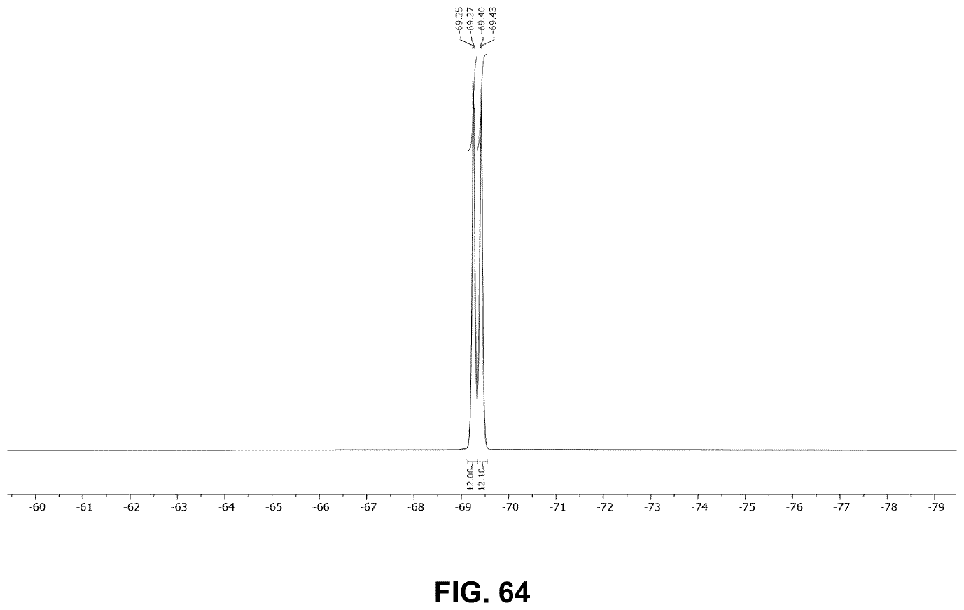

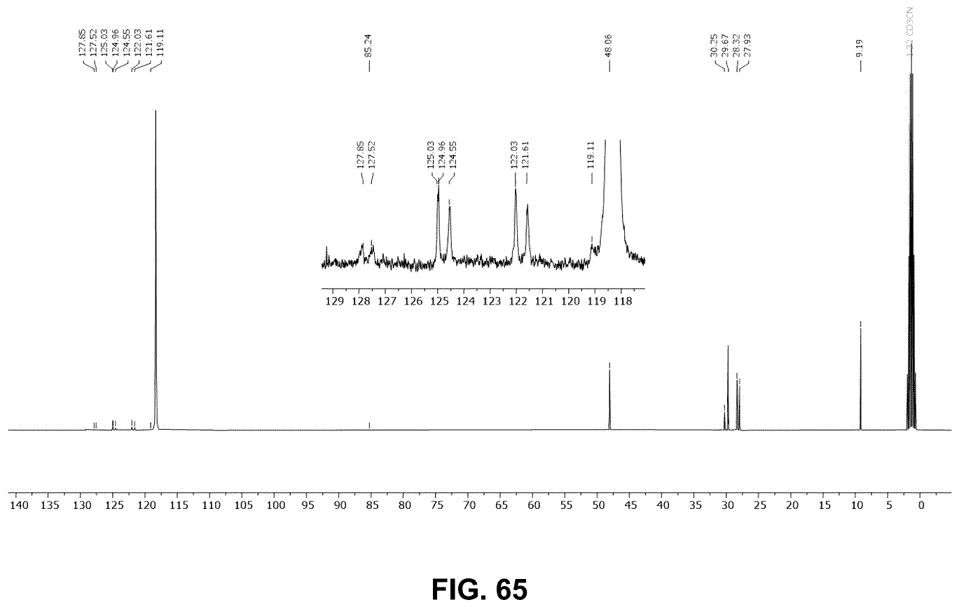

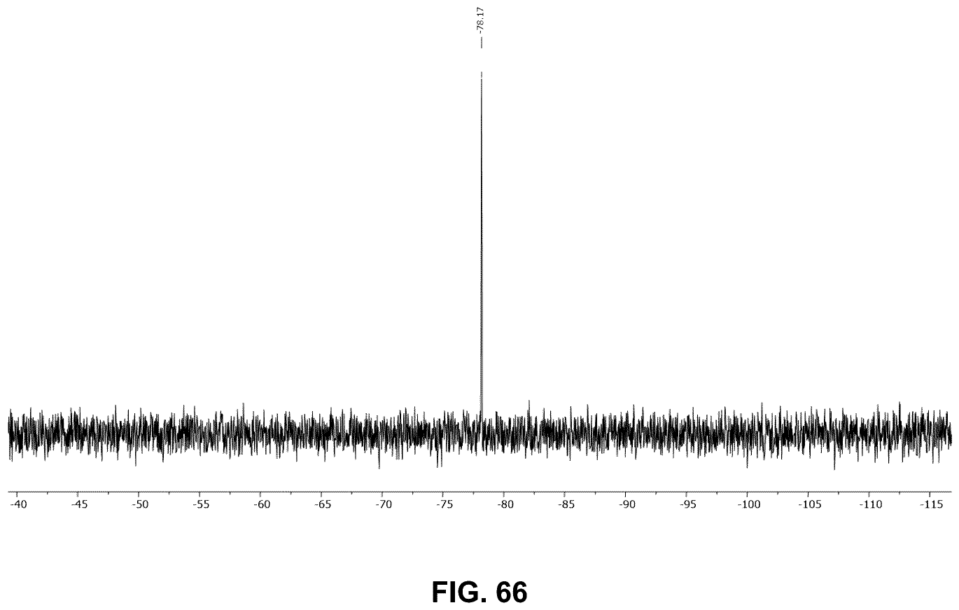

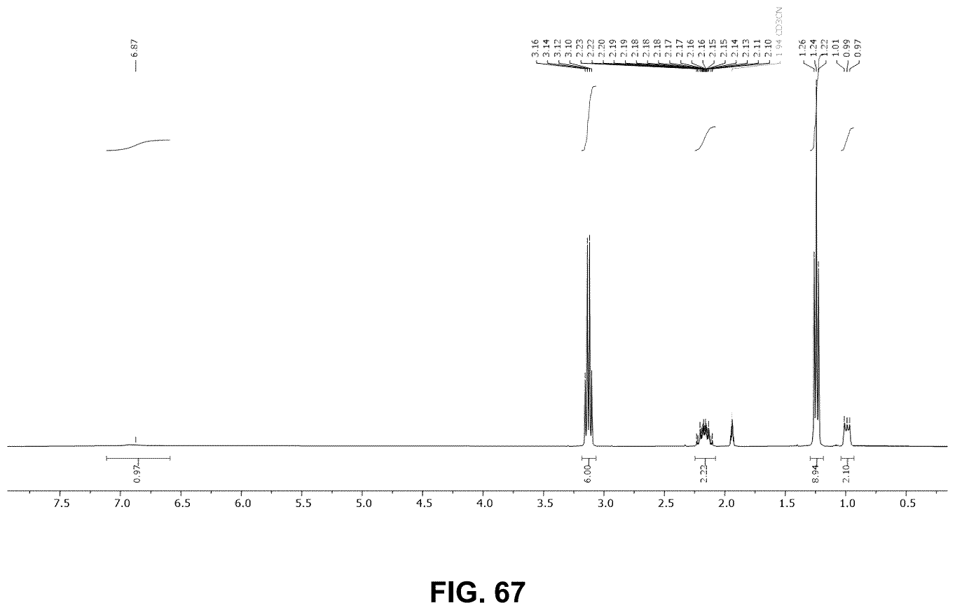

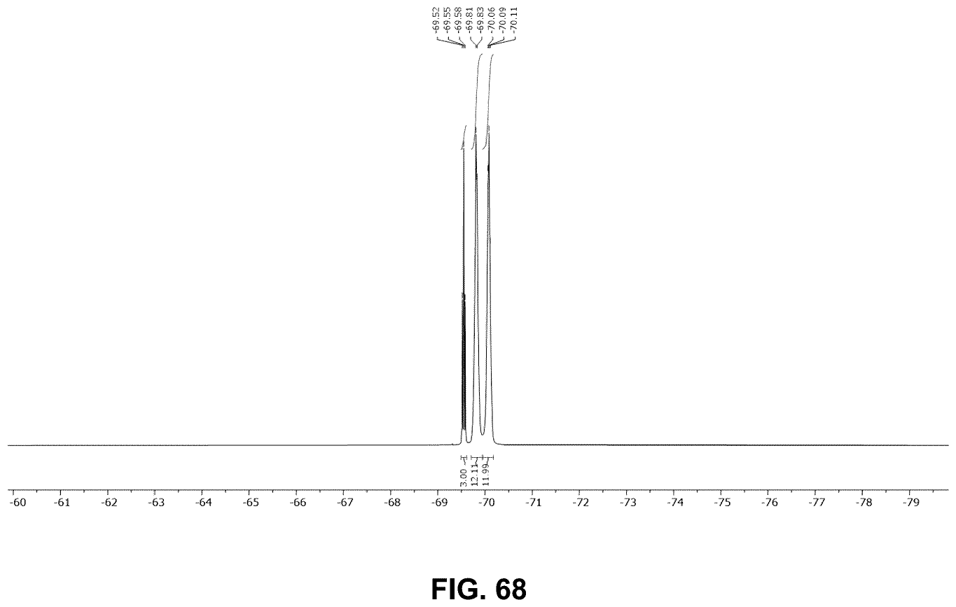

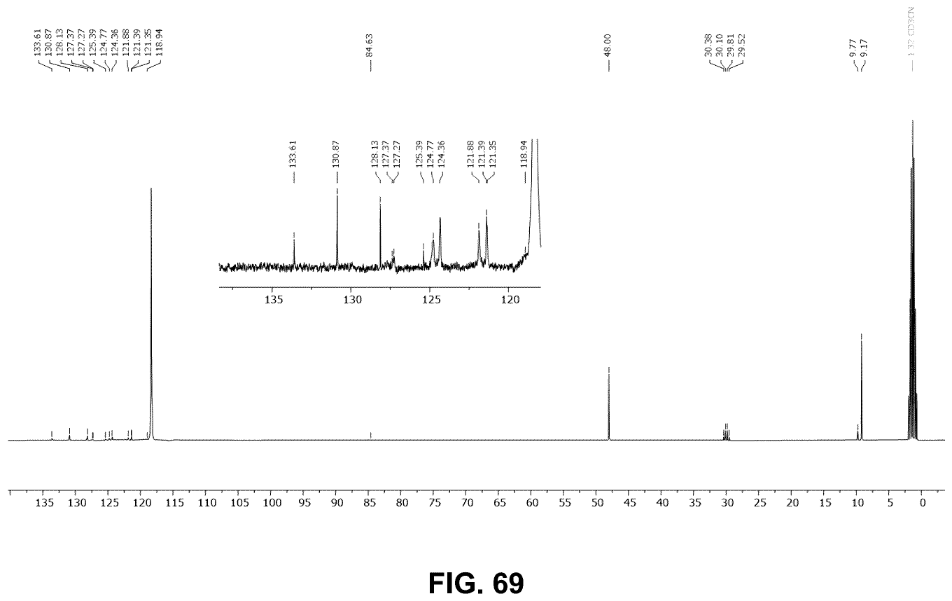

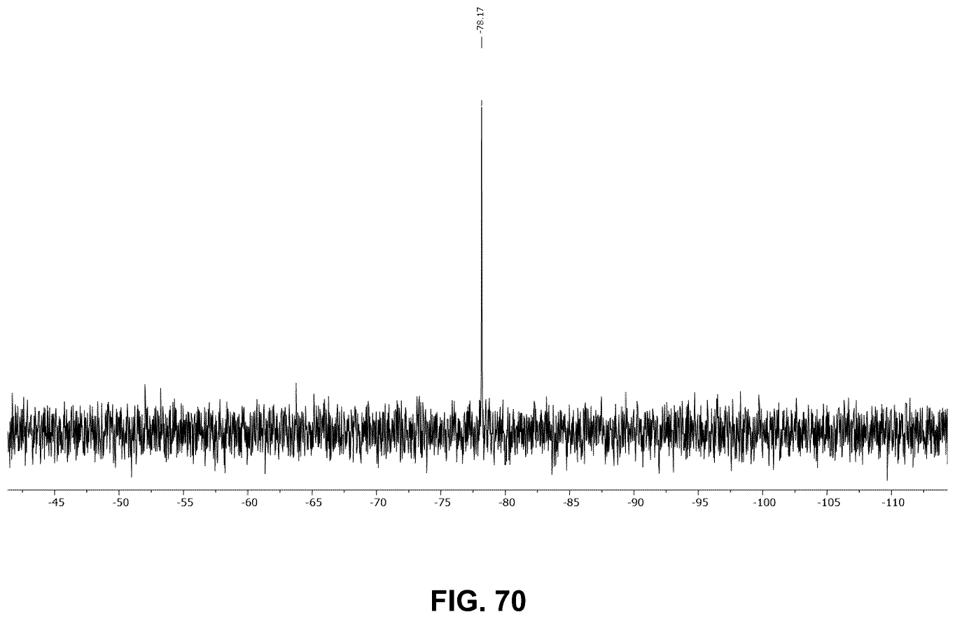

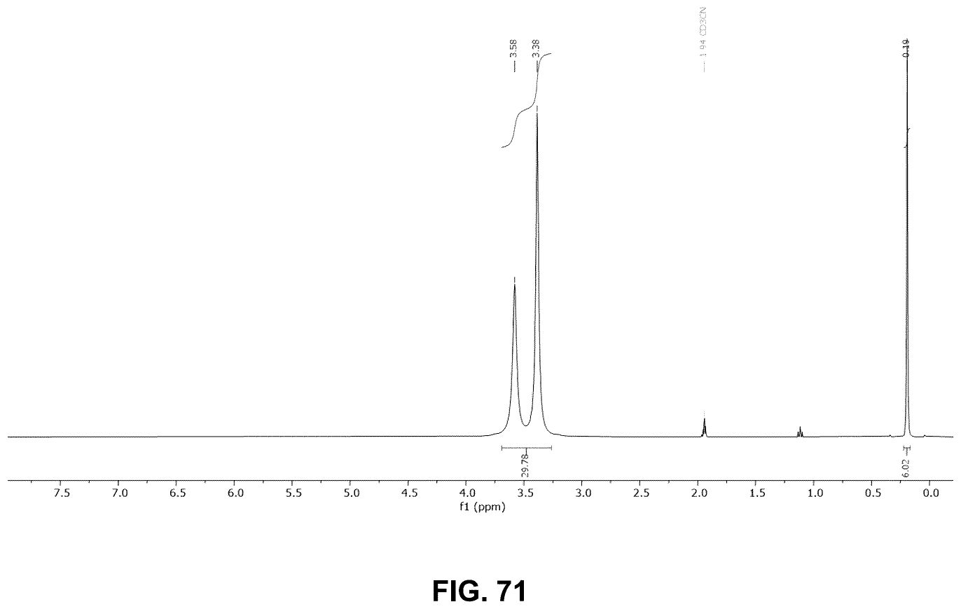

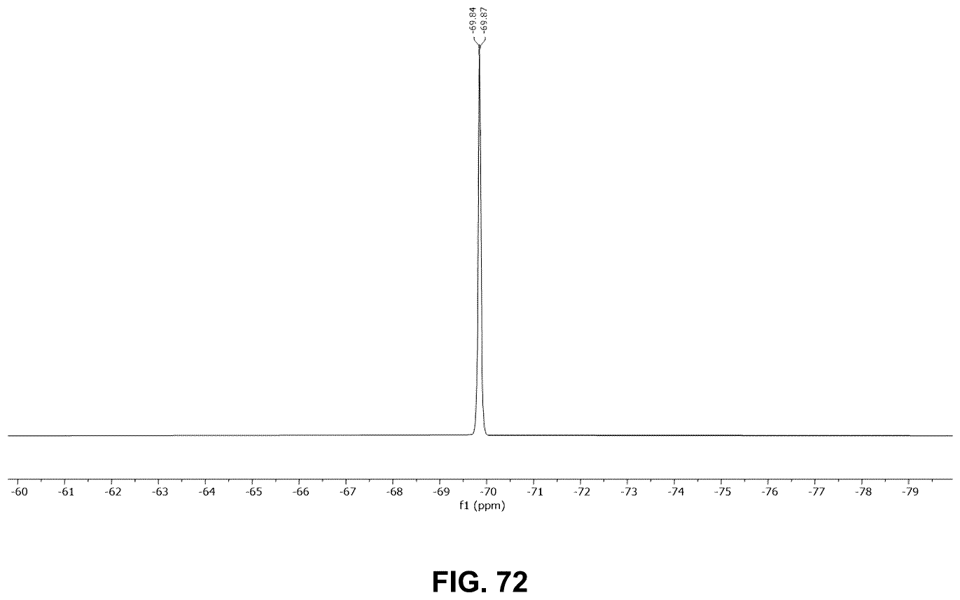

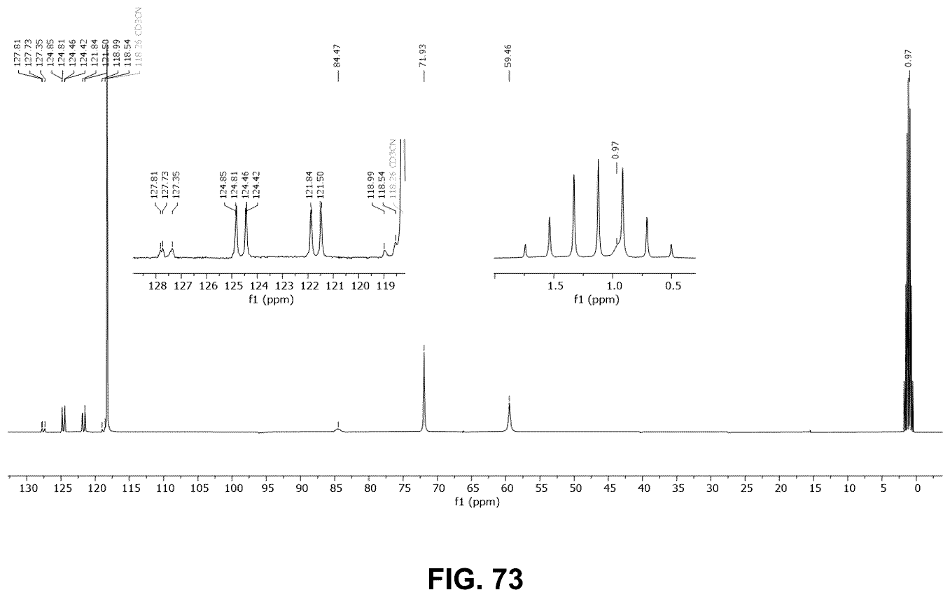

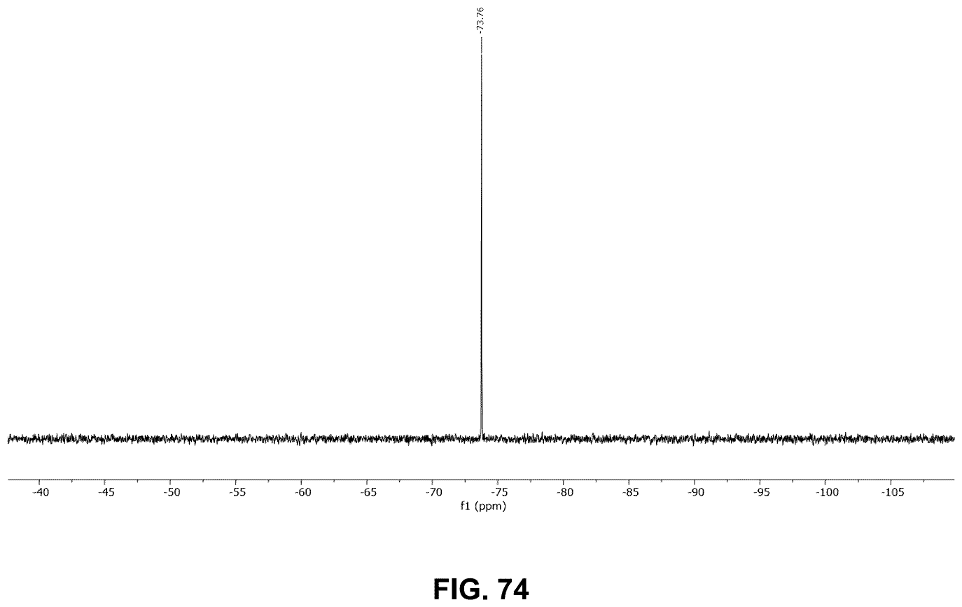

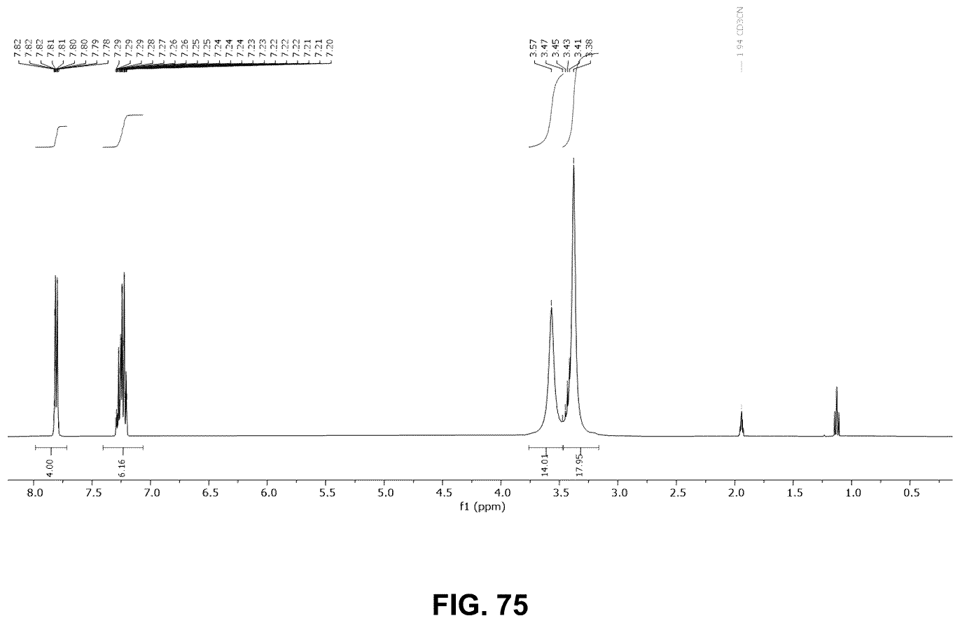

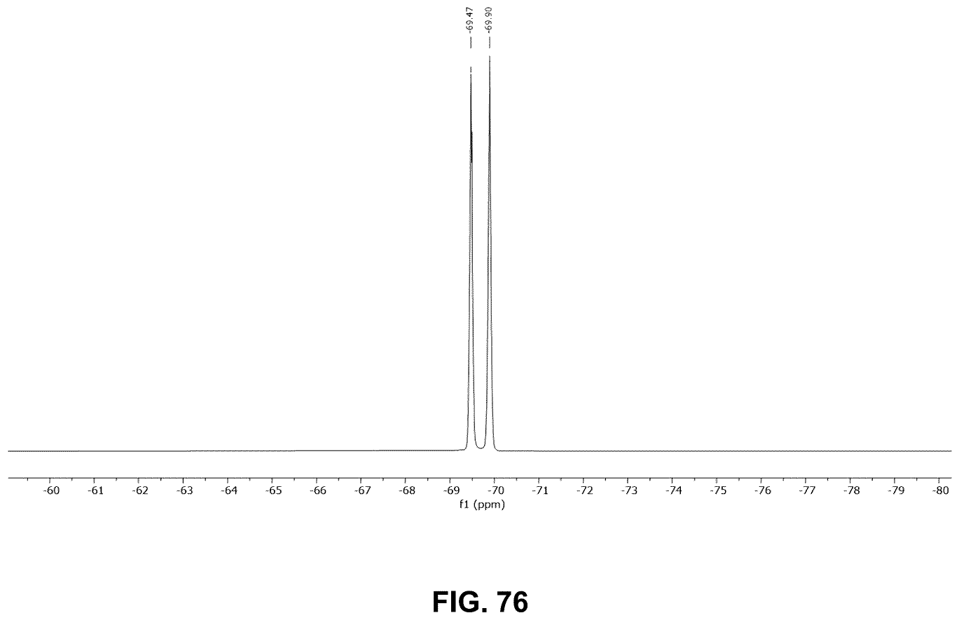

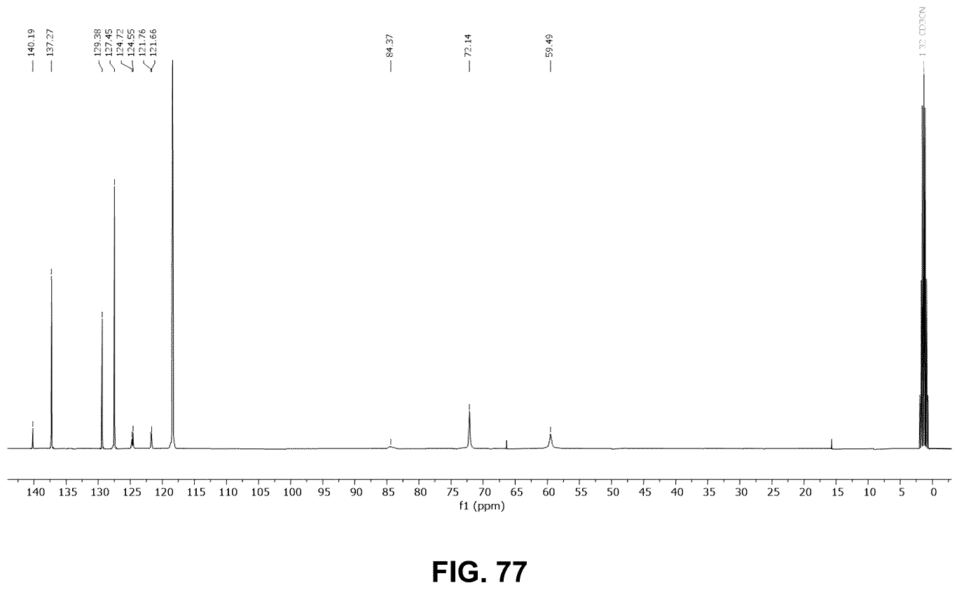

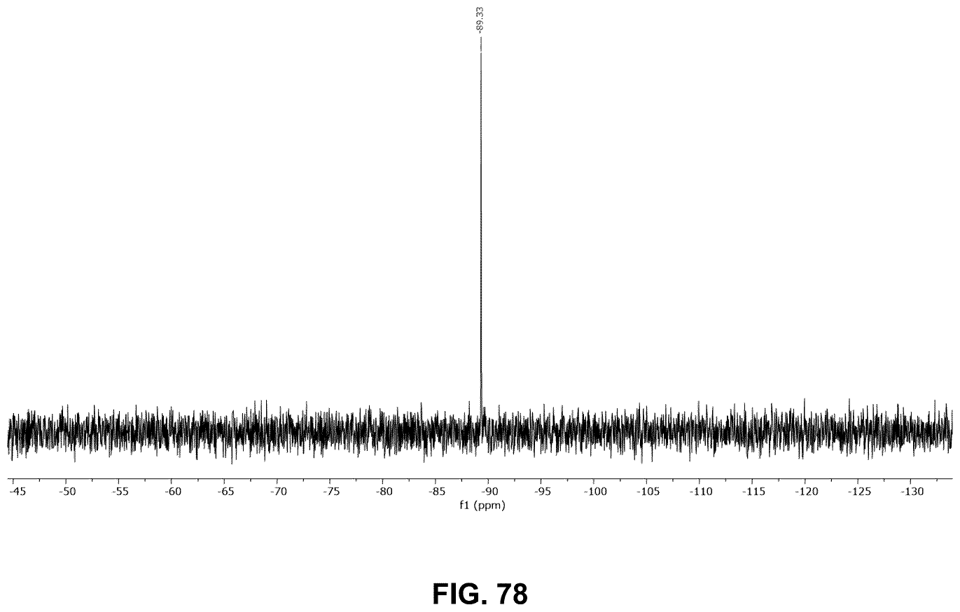

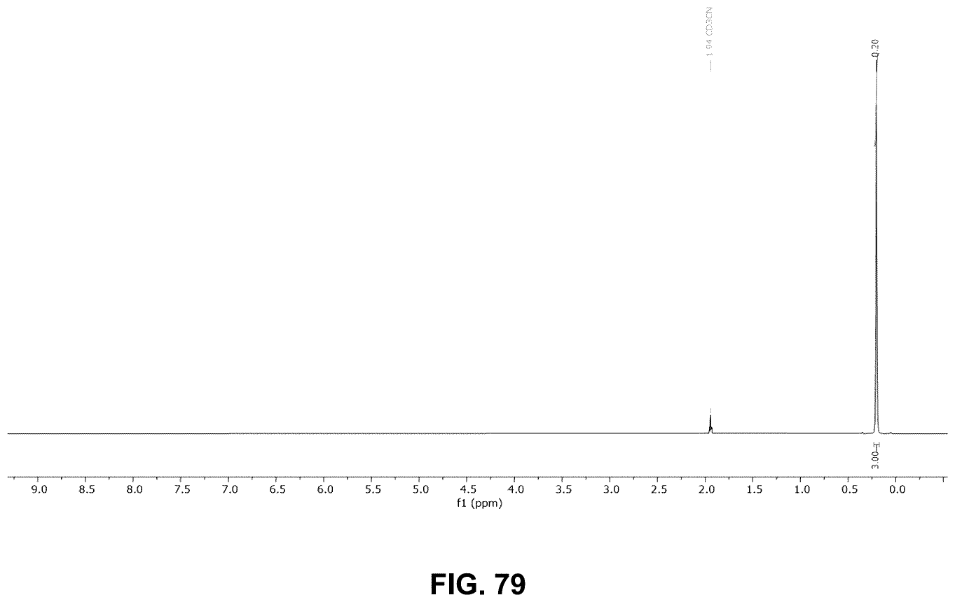

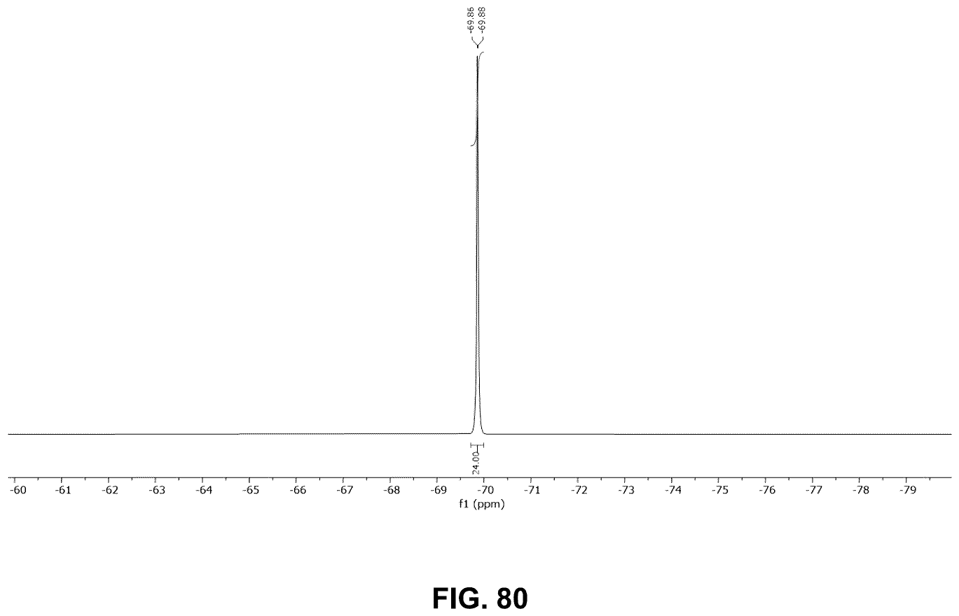

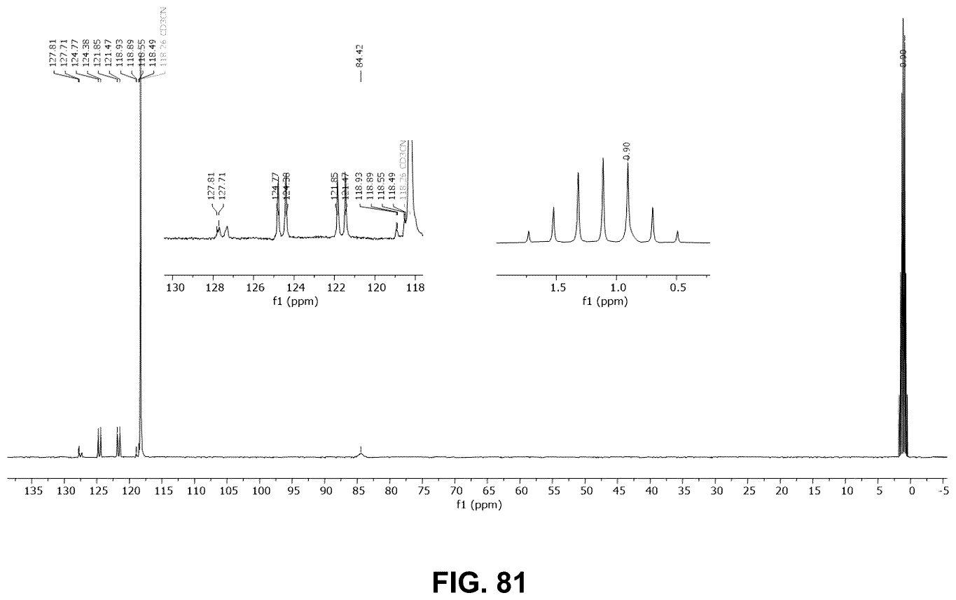

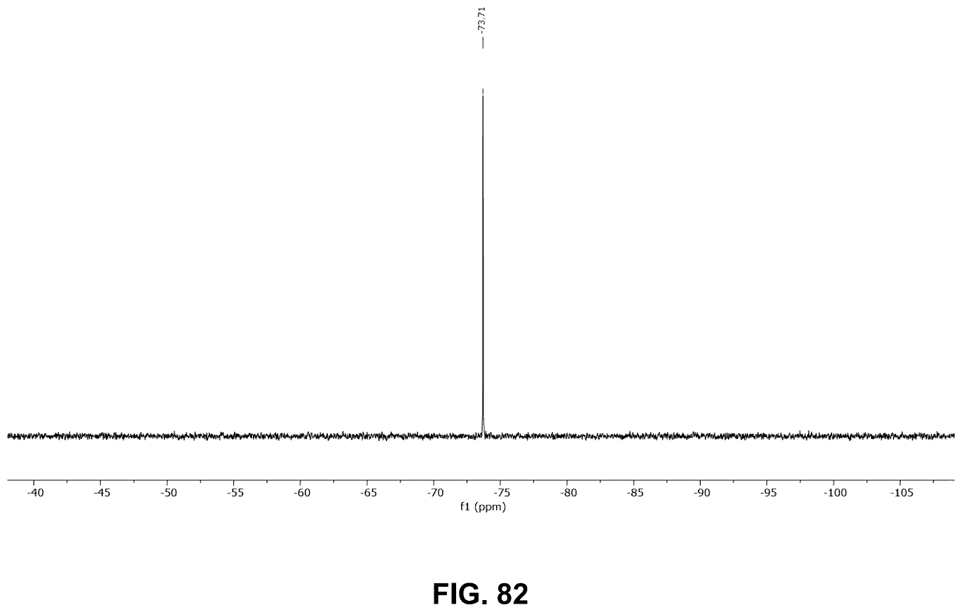

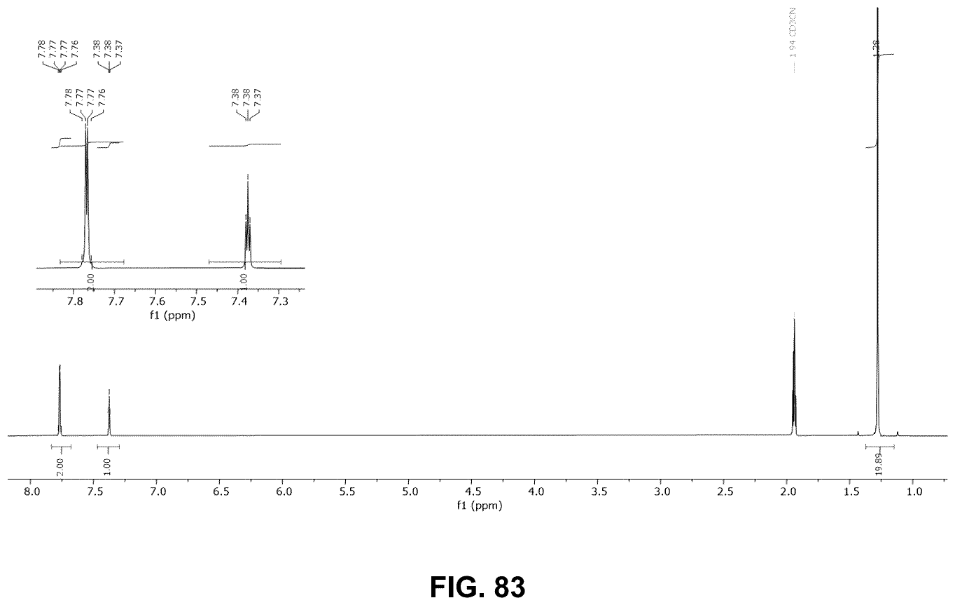

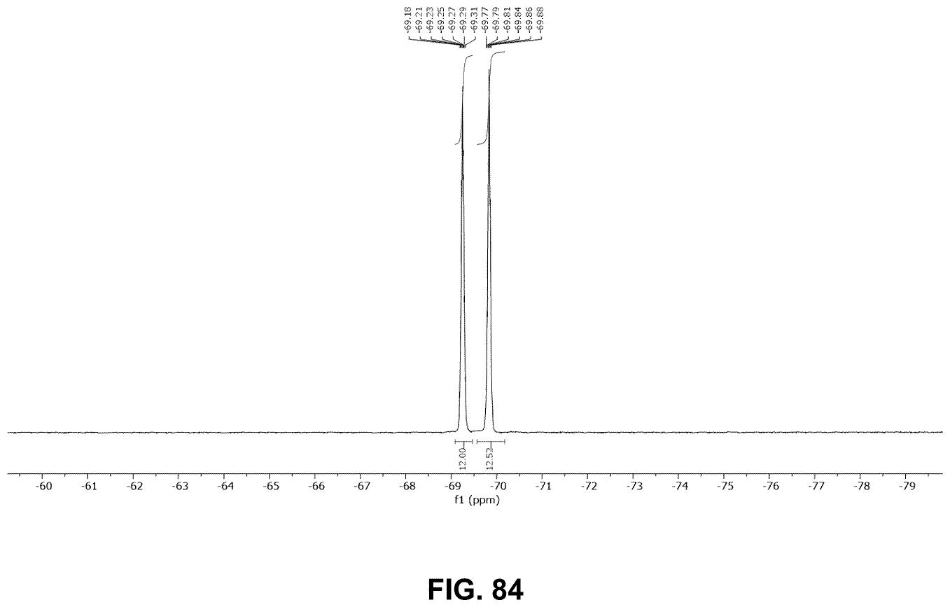

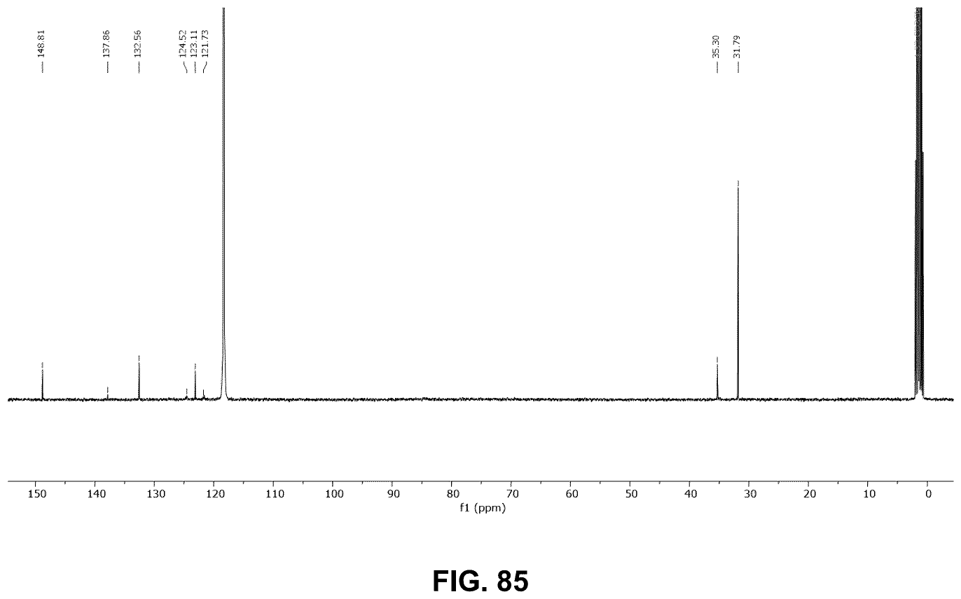

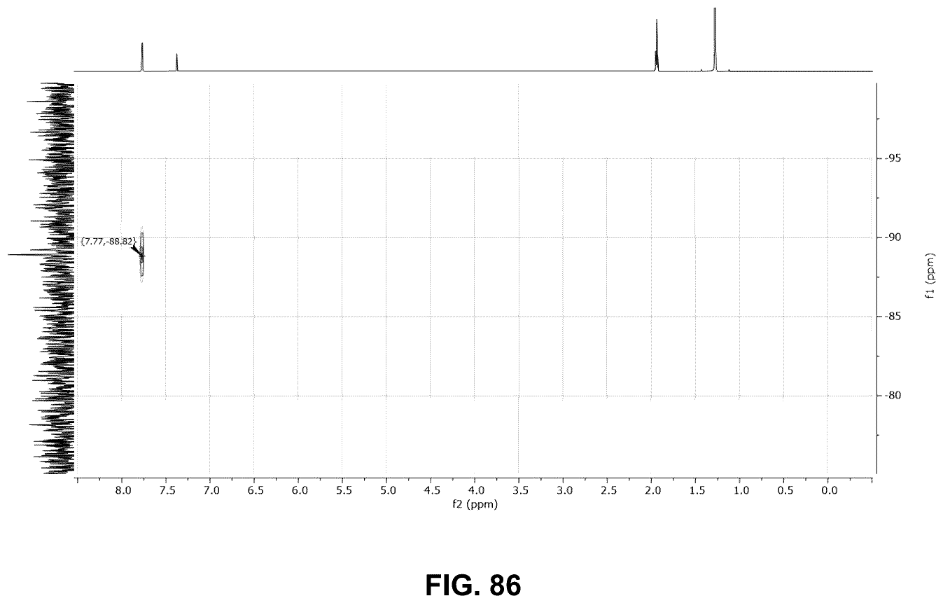

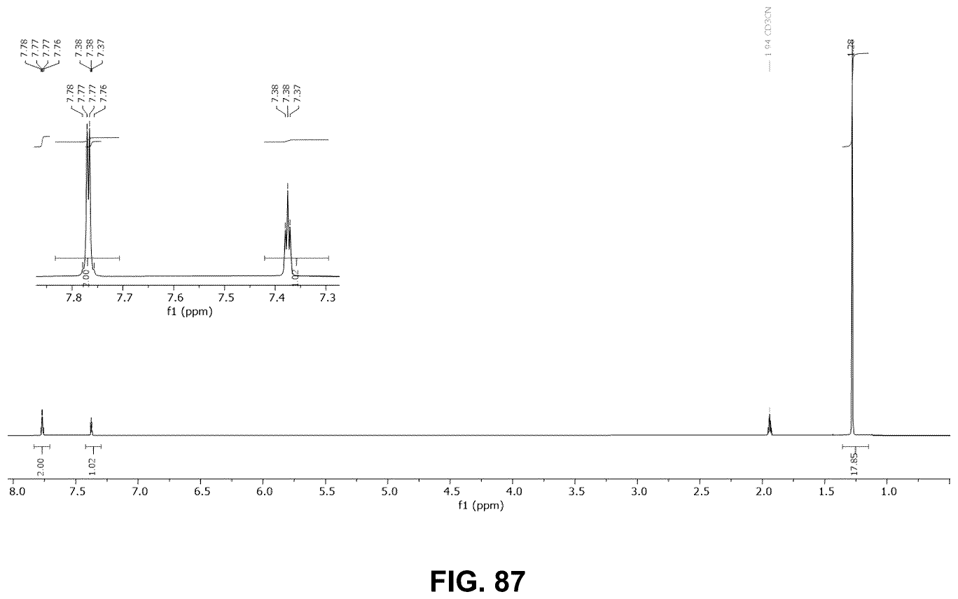

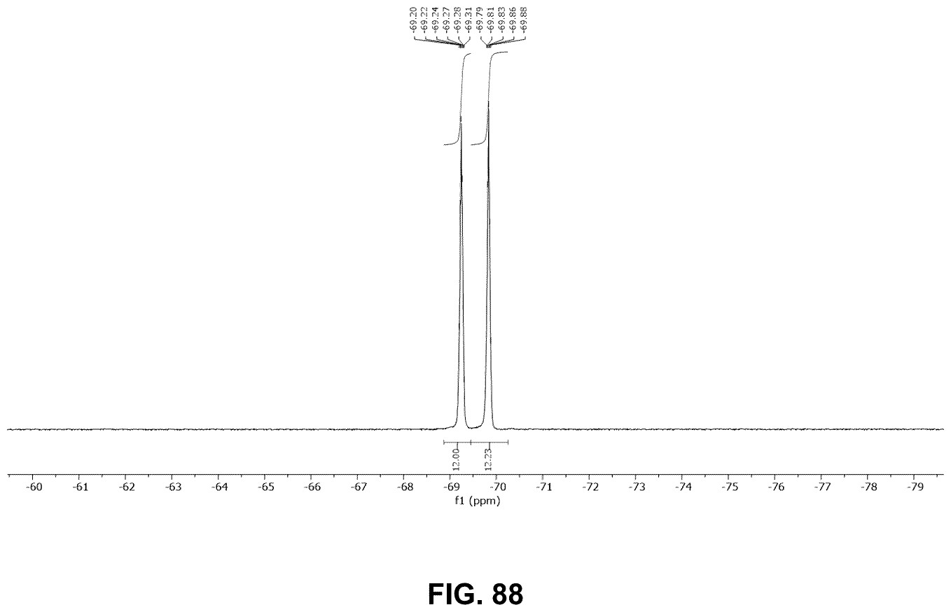

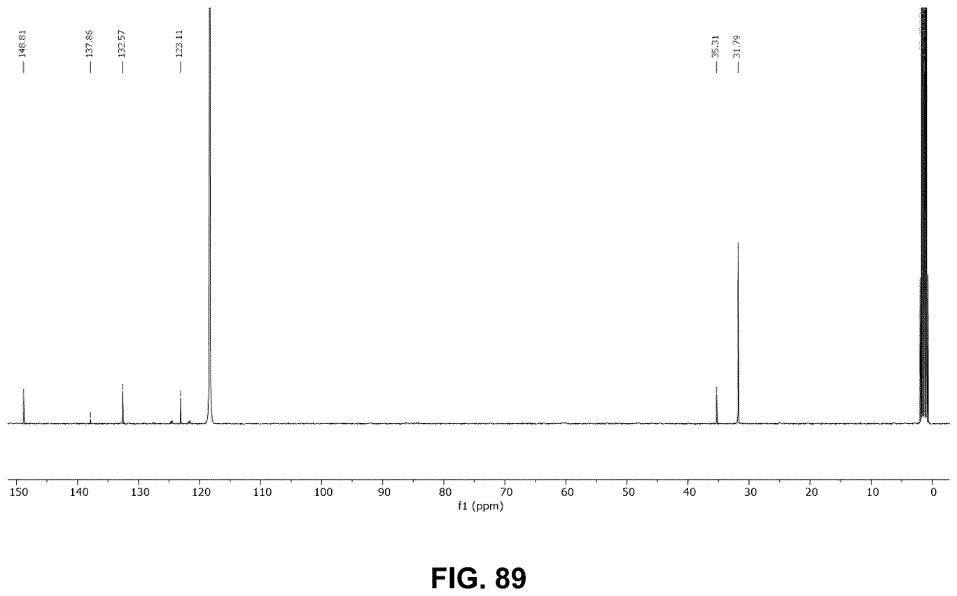

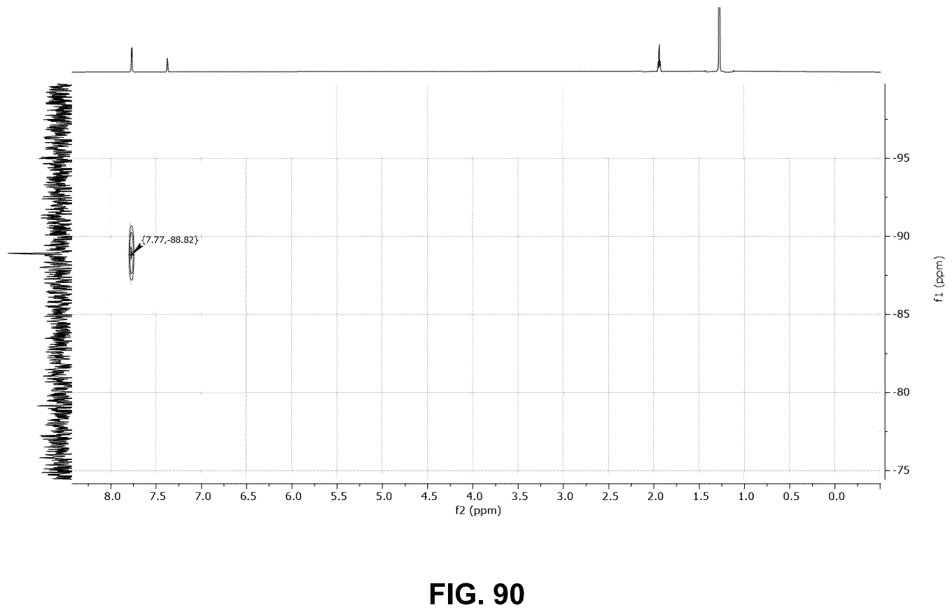

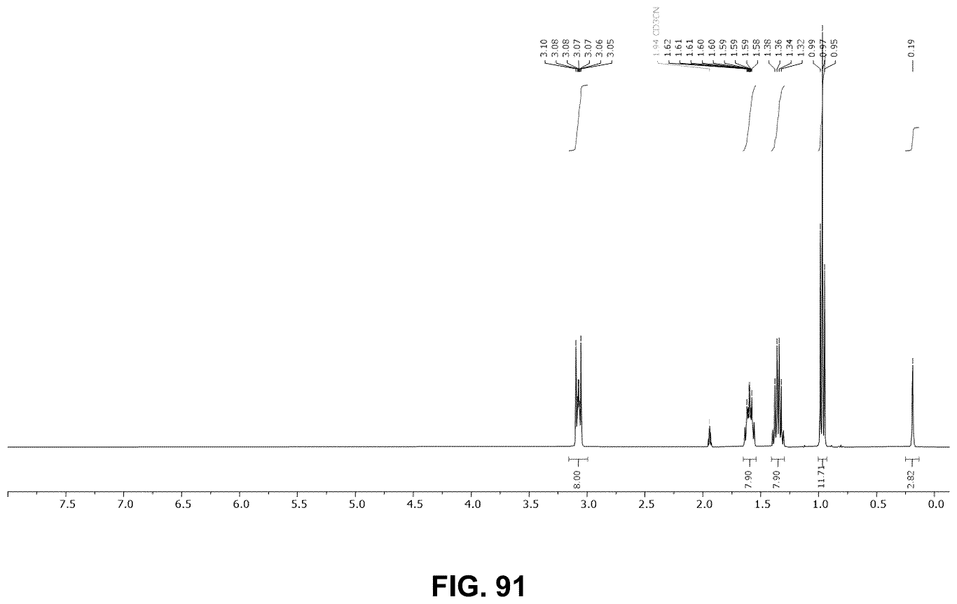

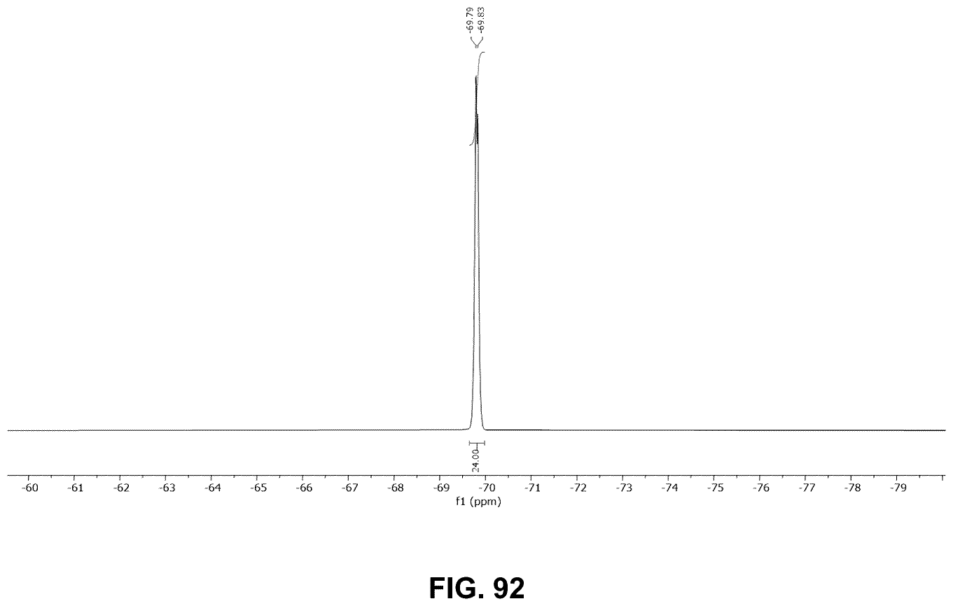

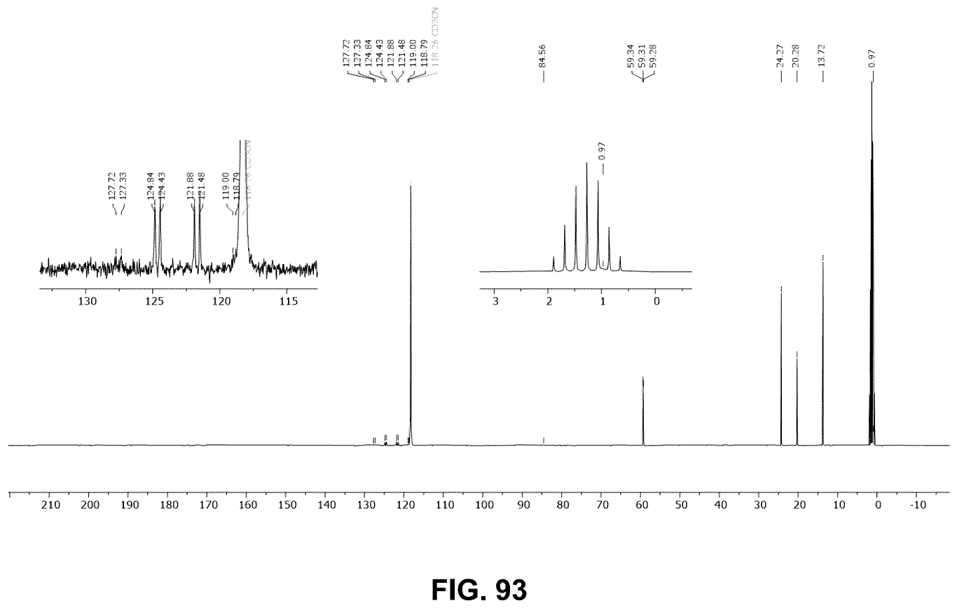

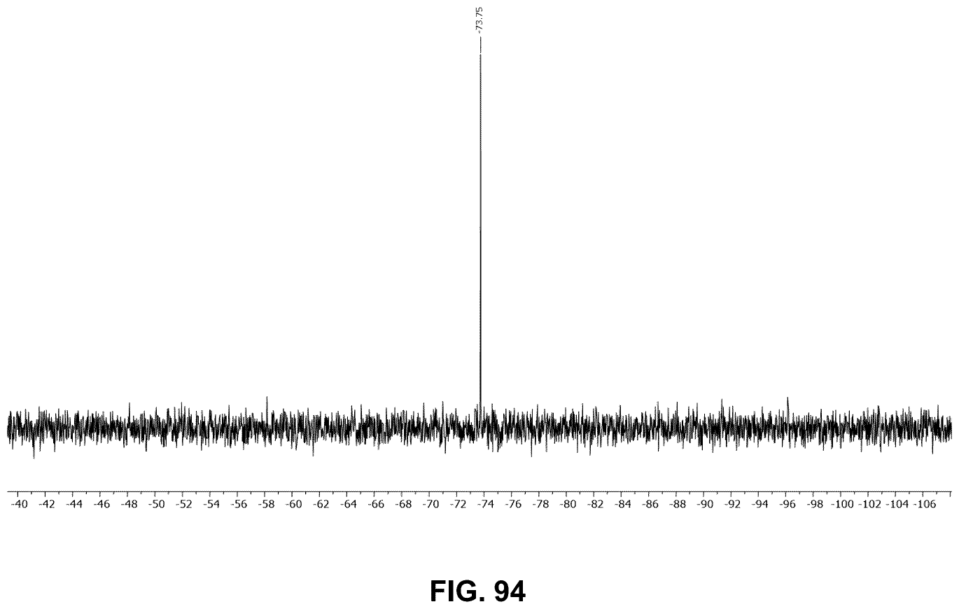

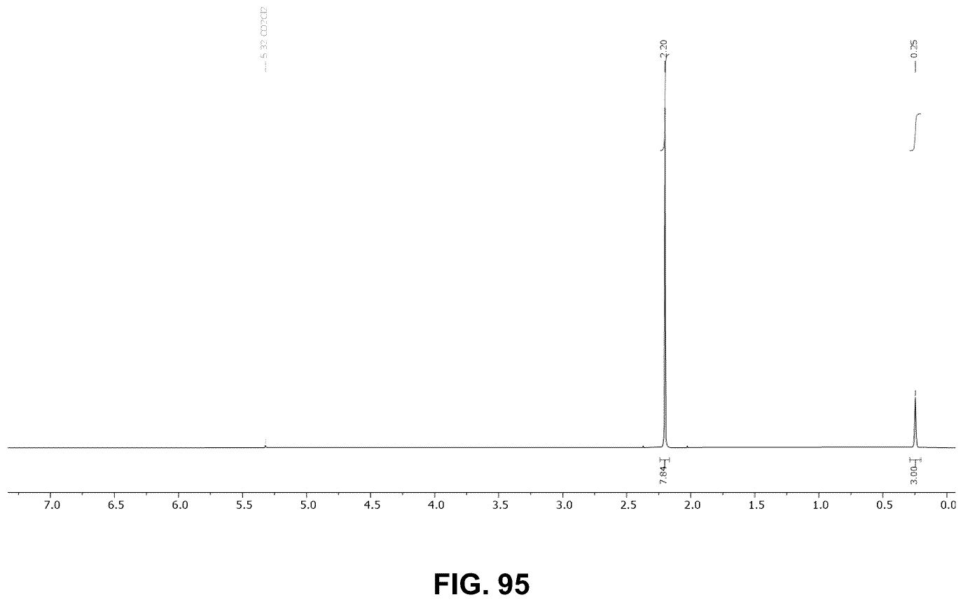

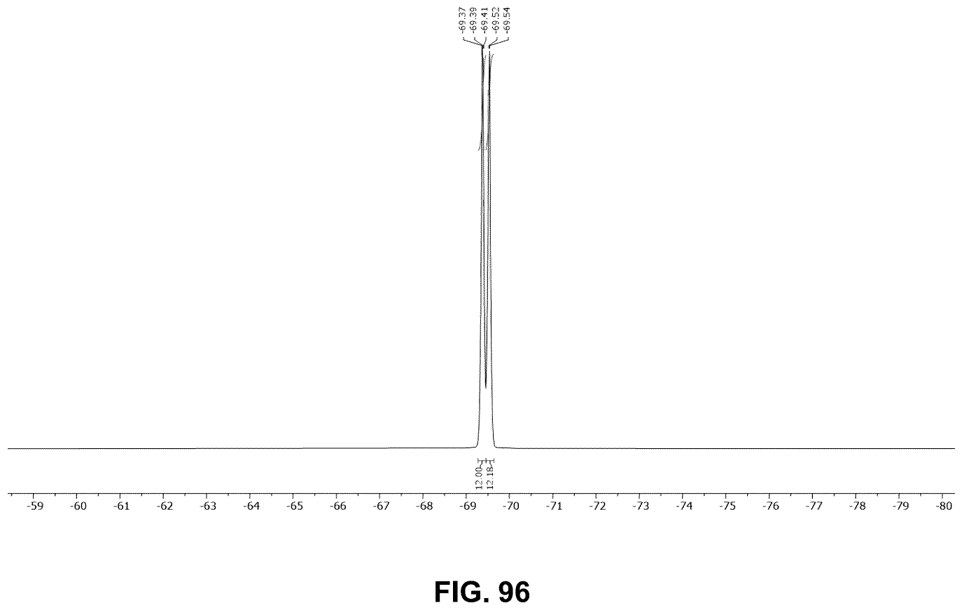

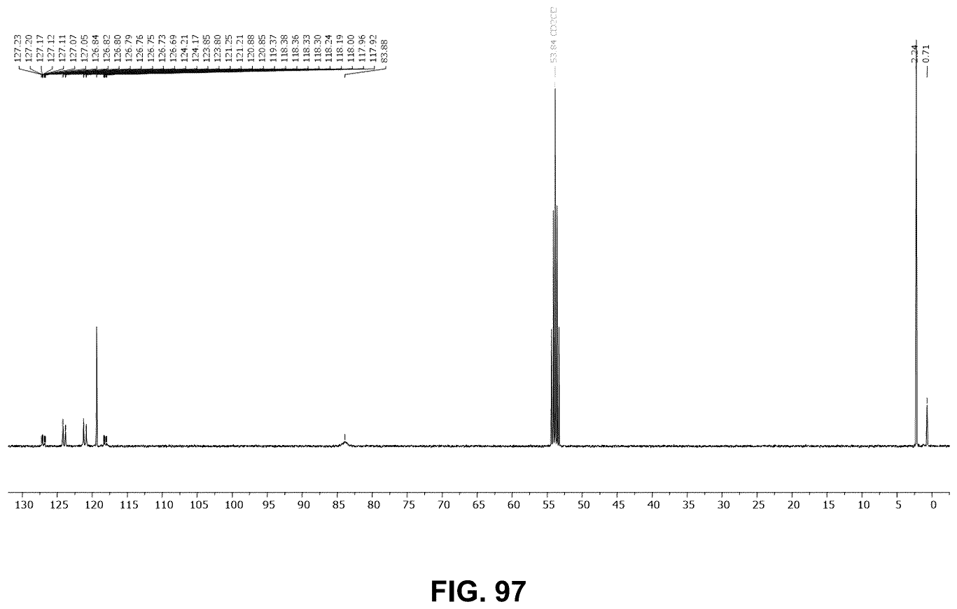

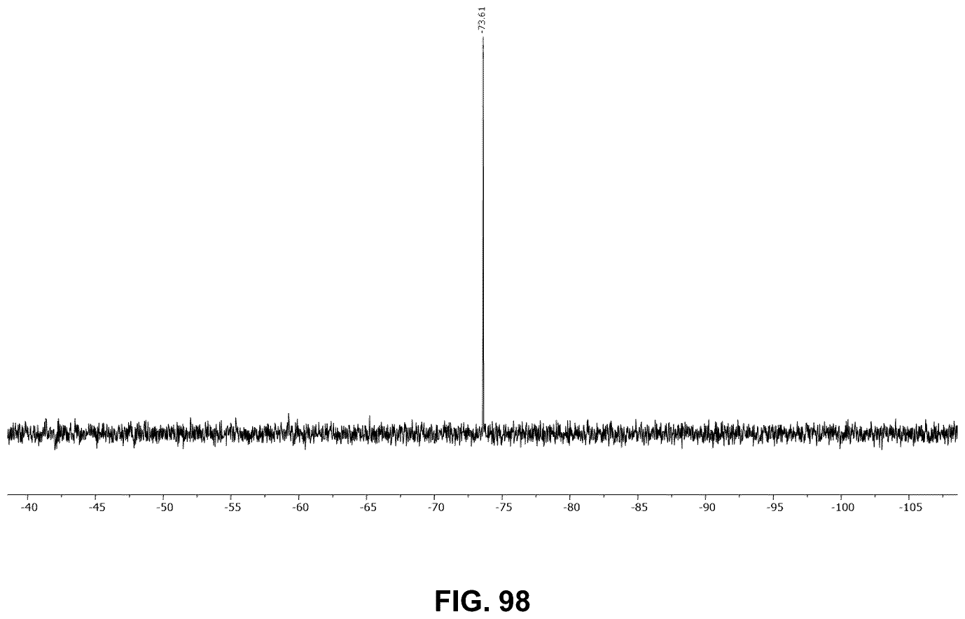

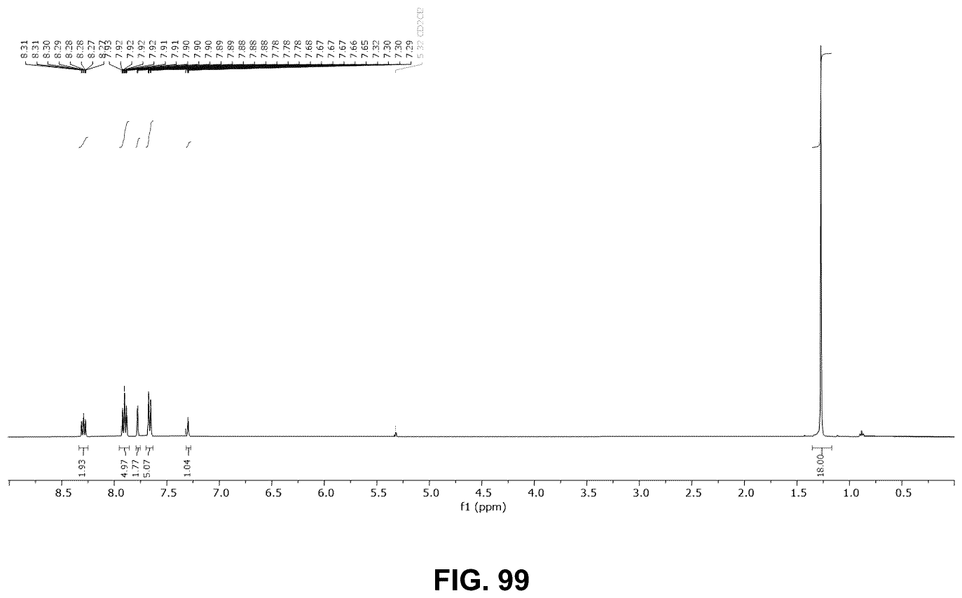

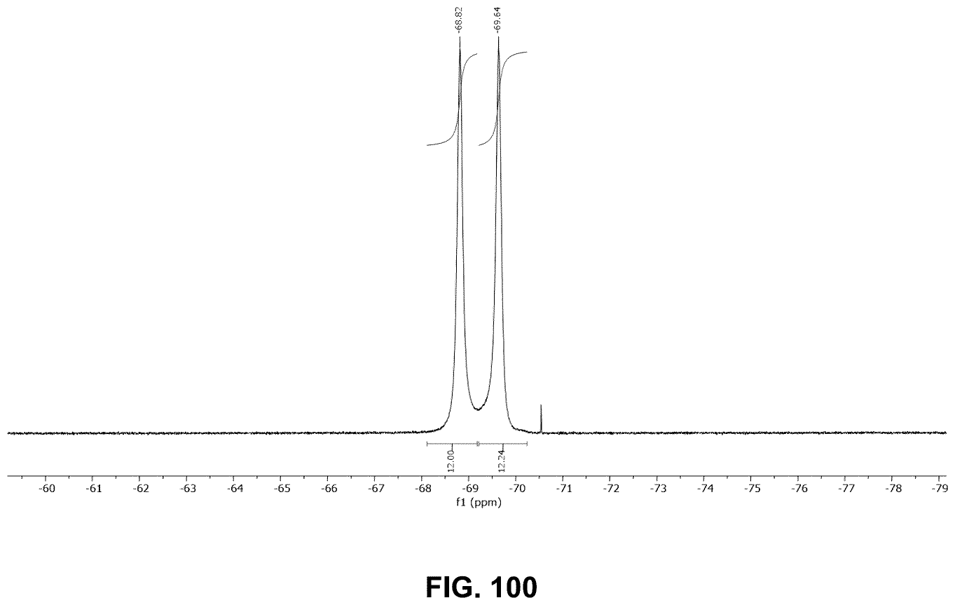

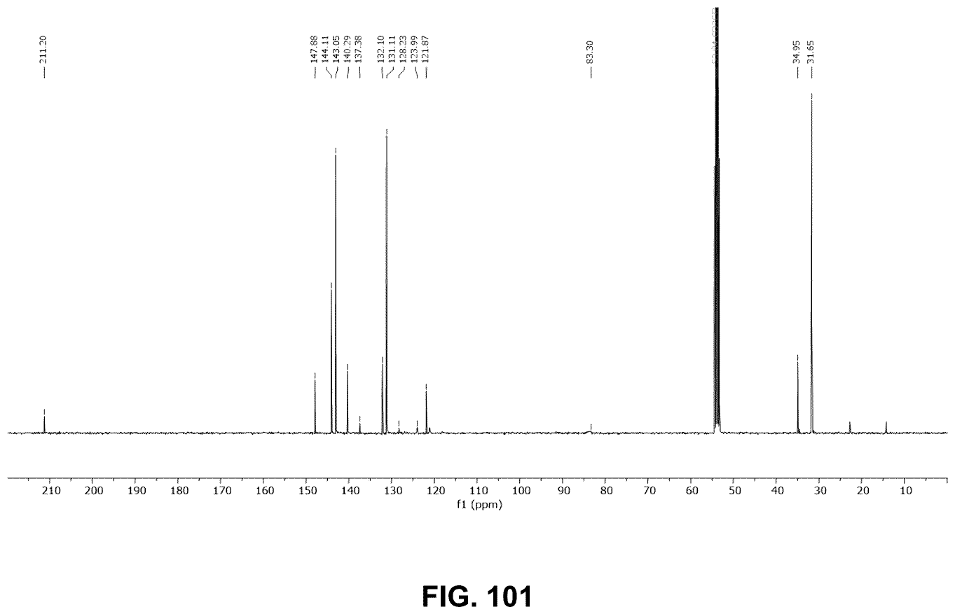

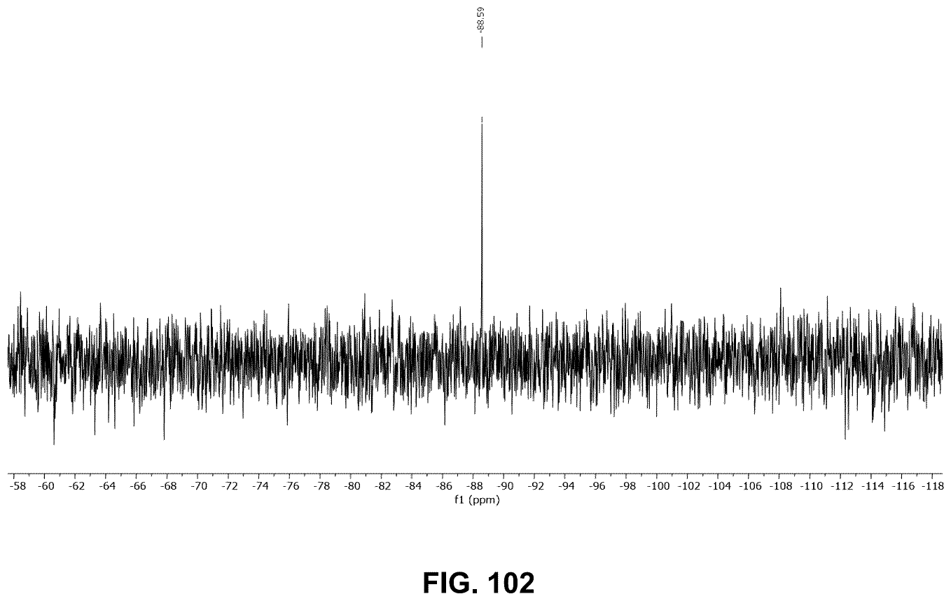

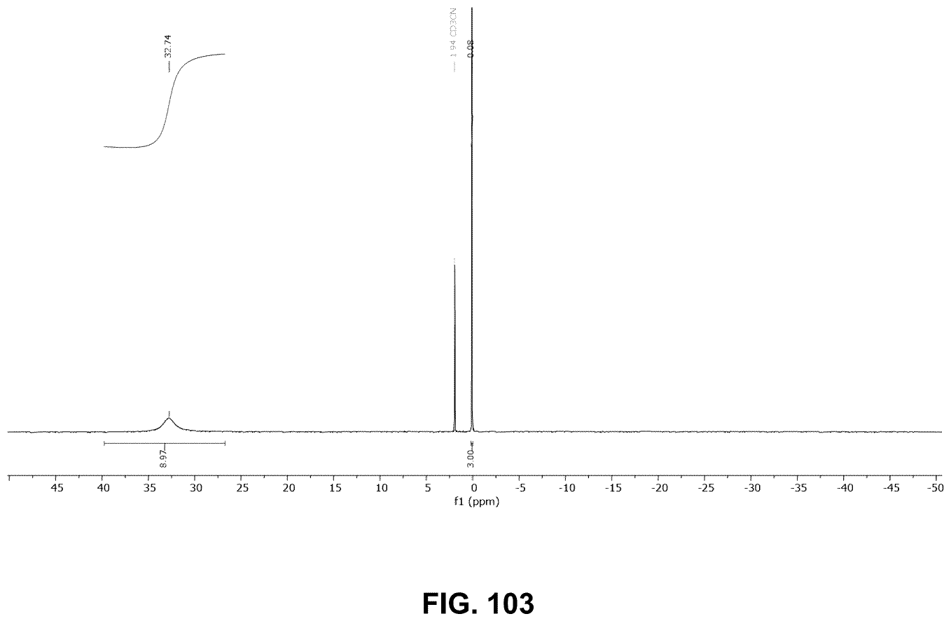

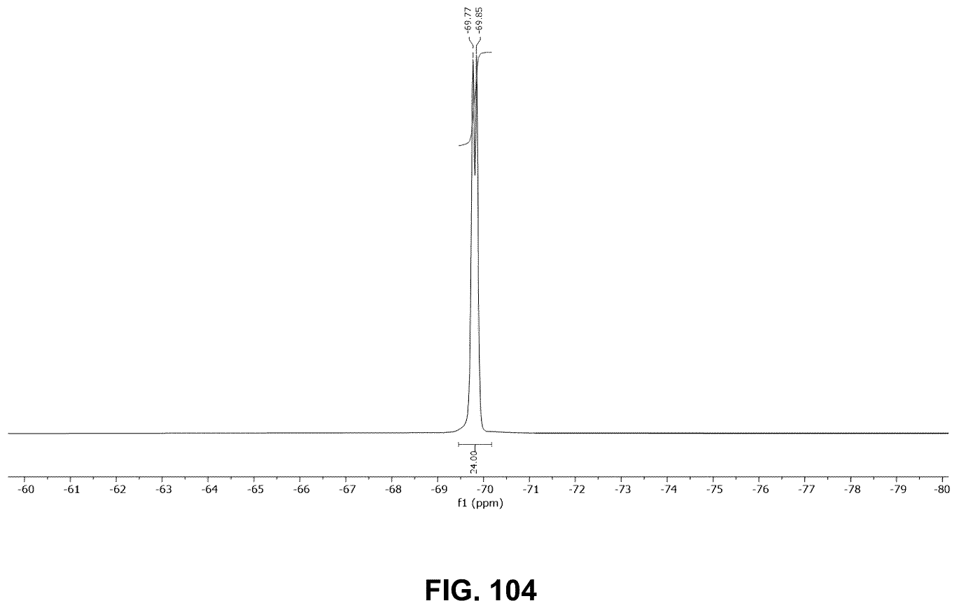

Because of the wide stability window of the [^{Me}Si^{F}₂₄]⁻ anion, a Mg²⁺ salt, 1-[Mg(DME)₃], was targeted to serve as a potential Mg battery electrolyte with high oxidative stability. Treating 1-[Et₃NH] with a slight excess of Me₂Mg affords 1-[Mg(DME)₃](FIG. 13). The ¹H NMR spectrum of 1-[Mg(DME)₃] in CD₃CN is consistent with three DME molecules coordinated to the Mg²⁺ cation, which is confirmed by the crystal structure (FIG. 10, right).⁵² Cyclic voltammetry experiments were performed to probe the electrochemical performance of 1-[Mg(DME)₃]. A 0.26 M solution of 1-[Mg(DME)₃] showed reversible deposition and stripping of Mg from cycle 1, with moderate conditioning during the first few cycles (FIG. 20). Modification of electrochemical conditions by addition of 10 mM Me₂Mg showed remarkably stable, conditioning-free Mg deposition and stripping from cycle 1 with very little cycle-to-cycle variation (FIGS. 14A-14C). The deposition overpotential is ca. −420 mV vs. Mg/Mg²⁺. and the coulombic efficiencies ca. 97%, with very little cycle-to-cycle variation (FIG. 14C). With an oxidative stability of >4.2 V vs. Mg/Mg²⁺ in DME (FIG. 14D), 1-[Mg(DME)₃] is one of the most oxidatively stable Mg electrolytes to date.²¹-24,26,29,39,68

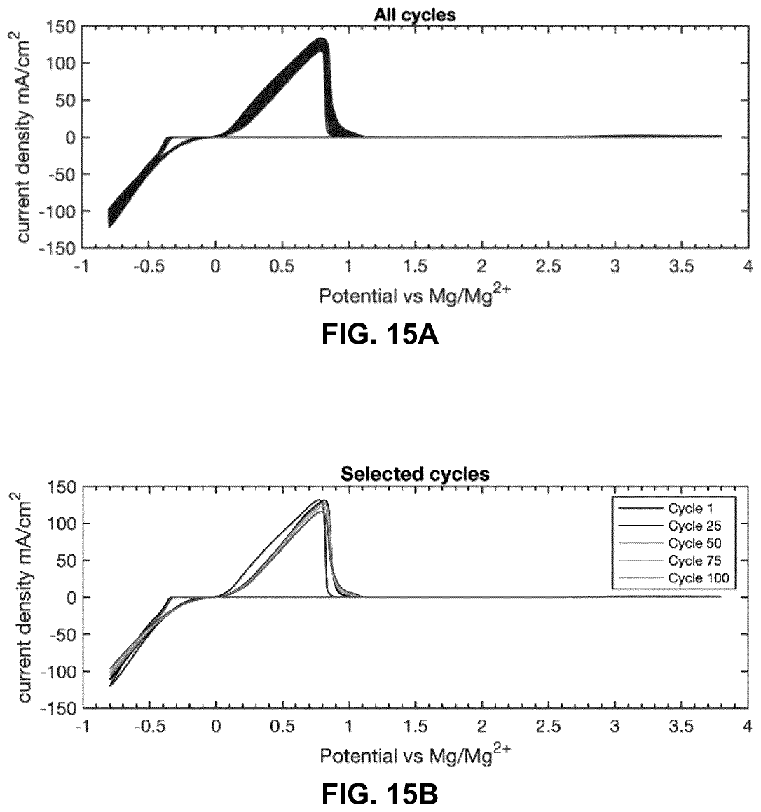

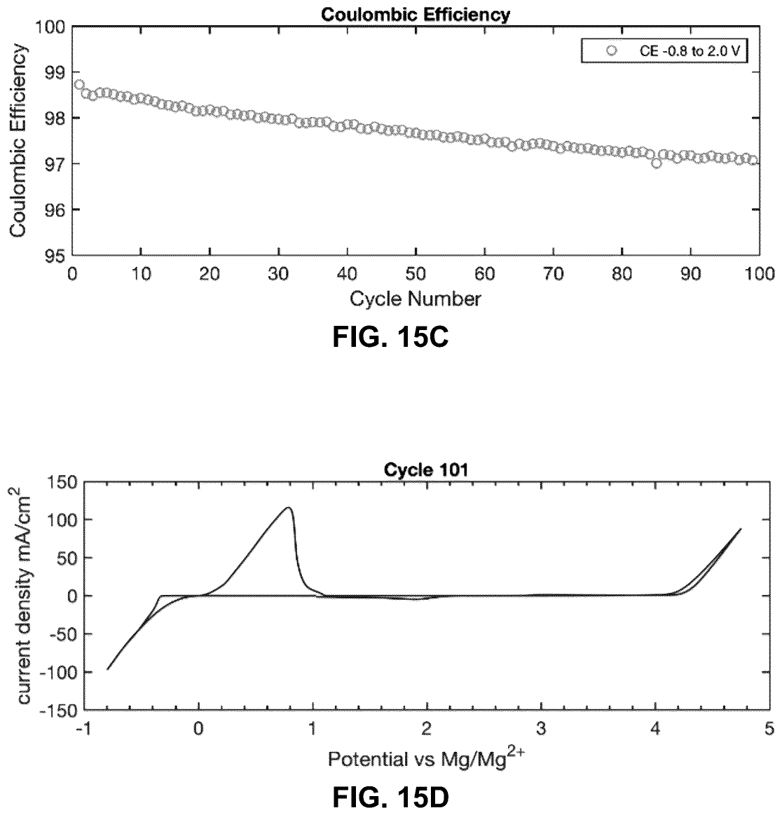

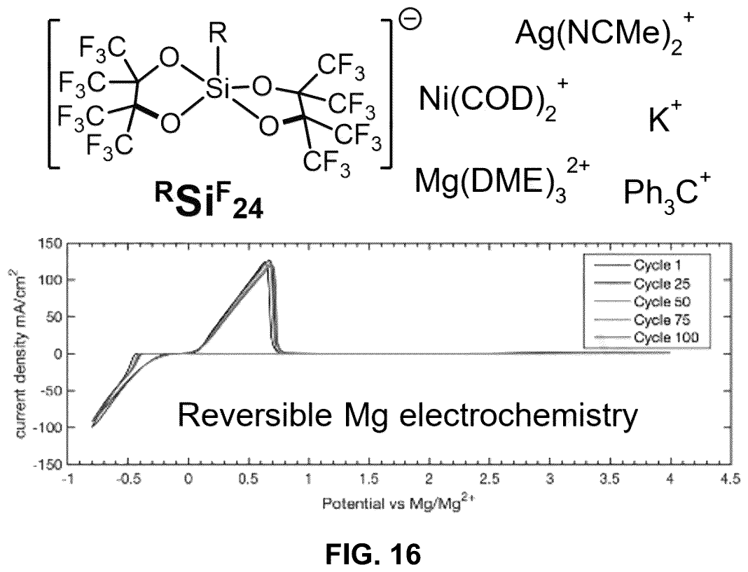

Given the promising Mg electrochemistry of 1-[Mg(DME)₃], it was expected that a diverse portfolio of R-substituents would allow for optimizing electrochemical performance. For example, Lavallo et al. have reported that functionalizing the [HC₁₁B₁₁]⁻ with a neopentyl substituent at the carbon vertex improves the solubility of the Mg salt, resulting in higher conductivity and higher oxidative stability in DME.⁴¹ In addition, the R-substituent could potentially influence the electronic properties of the anion (FIGS. 15A-15D).

As shown in FIGS. 15A-15D, while the electrochemical performance of 2-[Mg(DME)₃] is similar to that of 1-[Mg(DME)₃], the deposition of 2-[Mg(DME)₃] is lower at ca. −350 mV vs. Mg/Mg²⁺. The coulombic efficiency of 2-[Mg(DME)₃] starts at ca. 99%, but steadily drops with cycling. The most marked difference was that 2-[Mg(DME)₃] decomposes at ca. 4.05 V vs. Mg/Mg²⁺, whereas 1-[Mg(DME)₃] is stable to 4.2 V vs. Mg/Mg²⁺. The differences in electrochemical performances highlight the utility of having access to a range of [^{R}Si^{F}₂₄] anions (albeit only two variants discussed herein) for structure-functional studies that will be detailed in a forthcoming manuscript.

Because of the concerns pertaining to reproducibility of Mg deposition/stripping supported by WCA-based Mg electrolytes,³⁶ care was taken to ensure that the reported Mg deposition/stripping performances were reproduced at least thrice. It was found that Mg deposition/stripping is exceedingly sensitive: while reversible Mg deposition/stripping was observed with 0.26 M 1-[Mg(DME)₃] and 10 mM Me₂Mg, the shape of the CV is sensitive to slight variations in the quality of glovebox atmosphere, quality of Pt wire WE, and solvent purity. The CV traces shown in FIGS. 14A-14D are representative of the “best” performing CV experiments. A detailed discussion pertaining to the shape of Mg CV traces is included below.

In summary, a new class of WCAs was developed featuring, for example, a pseudo-trigonal bipyramidal silicate. The synthetic routes reported have allowed access to a variety of [^{R}Si^{F}₂₄] structures. Cations relevant to coordination, organometallic, and catalytic chemistry supported by these anions were prepared. The electrochemical stability window of the [^{Me}Si^{F}₂₄] anion was found to be 7.5 V in MeCN, surpassing that of [Bu₄N][PF₆] by ca. 1 V oxidatively. Conditioning-free reversible Mg deposition and stripping supported by the [^{Me}Si^{F}₂₄] anion was demonstrated. The [^{Me}Si^{F}₂₄] anion showed an exceptional oxidative stability of ca. 4.2 V vs. Mg/Mg²⁺, which makes it one of the most oxidatively stable Mg electrolyte to date. Together, these results demonstrate that the [^{R}Si^{F}₂₄] anion platform not only supports coordination chemistry, but also may be employed in electrolytes for next-generation batteries beyond Li-ion. The tunability of this platform also allows development of anions with tailored performance for these fields.

### REFERENCES CORRESPONDING TO EXAMPLE 1

1. Beck, W.; Suenkel, K., Metal complexes of weakly coordinating anions. Precursors of strong cationic organometallic Lewis acids. Chem. Rev. 1988, 88 (7), 1405-1421. http://dx.doi.org/10.1021/cr00089a017
2. Chen, E. Y.-X.; Marks, T. J., Cocatalysts for Metal-Catalyzed Olefin Polymerization: Activators, Activation Processes, and Structure-Activity Relationships. Chem. Rev. 2000, 100 (4), 1391-1434. http://dx.doi.org/10.1021/cr980462j
3. Reed, C. A., Carboranes: A New Class of Weakly Coordinating Anions for Strong Electrophiles, Oxidants, and Superacids. Acc. Chem. Res. 1998, 31 (3), 133-139.
4. Strauss, S. H., The search for larger and more weakly coordinating anions. Chem. Rev. 1993, 93 (3), 927-942. http://dx.doi.org/10.1021/cr00019a005
5. Riddlestone, I. M.; Kraft, A.; Schaefer, J.; Krossing, I., Taming the Cationic Beast: Novel Developments in the Synthesis and Application of Weakly Coordinating Anions. Angew. Chem. Int. Ed. 2018, 57 (43), 13982-14024.
6. Rosenthal, M. R., The myth of the non-coordinating anion. J. Chem. Educ. 1973, 50 (5), 331. http://dx.doi.org/10.1021/ed050p331
7. Connelly, N. G.; Geiger, W. E., Chemical Redox Agents for Organometallic Chemistry. Chem. Rev. 1996, 96 (2), 877-910. http://dx.doi.org/10.1021/cr940053x
8. Krossing, I.; Raabe, I., Noncoordinating Anions—Fact or Fiction?A Survey of Likely Candidates. Angew. Chem. Int. Ed. 2004, 43 (16), 2066-2090. http://dx.doi.org/10.1002/anie.200300620
9. Fisher, S. P.; Tomich, A. W.; Lovera, S. O.; Kleinsasser, J. F.; Guo, J.; Asay, M. J.; Nelson, H. M.; Lavallo, V., Nonclassical Applications of closo-Carborane Anions: From Main Group Chemistry and Catalysis to Energy Storage. Chem. Rev. 2019, 119 (14), 8262-8290. http://dx.doi.org/10.1021/acs.chemrev.8b00551
10. Krossing, I.; Reisinger, A., Chemistry with weakly-coordinating fluorinated alkoxyaluminate anions: Gas phase cations in condensed phases?Coord. Chem. Rev. 2006, 250 (21), 2721-2744. https://doi.org/10.1016/j.ccr.2005.10.023
11. Barrière, F.; Geiger, W. E., Use of Weakly Coordinating Anions to Develop an Integrated Approach to the Tuning of ΔE_{1/2} Values by Medium Effects. J. Am. Chem. Soc. 2006, 128 (12), 3980-3989. http://dx.doi.org/10.1021/ja058171x
12. Boudjouk, P.; Bahr, S. R., Trityl tetrakis[3,5-bis(trifluoromethyl)phenyl]borate: a new hydride abstraction reagent. J. Org. Chem. 1992, 57 (20), 5545-5547. http://dx.doi.org/doi.org/10.1021/jo00046a048
13. Kalhoff, J.; Eshetu, G. G.; Bresser, D.; Passerini, S., Safer Electrolytes for Lithium-Ion Batteries: State of the Art and Perspectives. ChemSusChem 2015, 8 (13), 2154-2175.
14. Goikolea, E.; Palomares, V.; Wang, S.; de Larramendi, I. R.; Guo, X.; Wang, G.; Rojo, T., Na-Ion Batteries-Approaching Old and New Challenges. Adv. Energy Mater. 2020, 10 (44), 2002055. https://doi.org/10.1002/aenm.202002055
15. Liu, Y.; Gao, C.; Dai, L.; Deng, Q.; Wang, L.; Luo, J.; Liu, S.; Hu, N., The Features and Progress of Electrolyte for Potassium Ion Batteries. Small 2020, 16 (44), 2004096. https://doi.org/10.1002/smll.202004096
16. Ould, D. M. C.; Menkin, S.; O'Keefe, C. A.; Coowar, F.; Barker, J.; Grey, C. P.; Wright, D. S., New Route to Battery Grade NaPF6 for Na-Ion Batteries: Expanding the Accessible Concentration. Angew. Chem. Int. Ed. 2021, 60 (47), 24882-24887. https://doi.org/10.1002/anie.202111215
17. Duncan, D. T.; Roy, B.; Piper, S. L.; Nguyen, C.; Howlett, P.; Forsyth, M.;
MacFarlane, D. R.; Sun, J.; Kar, M., High-Ionicity Electrolytes Based on Bulky Fluoroborate Anions for Stable Na-Metal Cycling. The Journal of Physical Chemistry C 2022, 126 (44), 18918-18930. http://dx.doi.org/10.1021/acs.jpcc.2c06187
18. Jin, Y.; Le, P. M. L.; Gao, P.; Xu, Y.; Xiao, B.; Engelhard, M. H.; Cao, X.; Vo, T. D.; Hu, J.; Zhong, L.; Matthews, B. E.; Yi, R.; Wang, C.; Li, X.; Liu, J.; Zhang, J.-G., Low-solvation electrolytes for high-voltage sodium-ion batteries. Nature Energy 2022, 7 (8), 718-725. http://dx.doi.org/10.1038/s41560-022-01055-0
19. Ould, D. M. C.; Menkin, S.; Smith, H. E.; Riesgo-Gonzalez, V.; Jónsson, E.; O'Keefe, C. A.; Coowar, F.; Barker, J.; Bond, A. D.; Grey, C. P.; Wright, D. S., Sodium Borates: Expanding the Electrolyte Selection for Sodium-Ion Batteries. Angew. Chem. Int. Ed. 2022, 61 (32), e202202133. https://doi.org/10.1002/anie.202202133
20. Tomich, A. W.; Park, J.; Son, S.-B.; Kamphaus, E. P.; Lyu, X.; Dogan, F.; Carta, V.; Gim, J.; Li, T.; Cheng, L.; Lee, E.; Lavallo, V.; Johnson, C. S., A Carboranyl Electrolyte Enabling Highly Reversible Sodium Metal Anodes via a “Fluorine-Free” SEI. Angew. Chem. Int. Ed. 2022, 61 (51), e202208158. https://doi.org/10.1002/anie.202208158
21. Carter, T. J.; Mohtadi, R.; Arthur, T. S.; Mizuno, F.; Zhang, R.; Shirai, S.; Kampf, J. W., Boron Clusters as Highly Stable Magnesium-Battery Electrolytes. Angew. Chem. Int. Ed. 2014, 53 (12), 3173-3177. https://doi.org/10.1002/anie.201310317
22. Ha, S.-Y.; Lee, Y.-W.; Woo, S. W.; Koo, B.; Kim, J.-S.; Cho, J.; Lee, K. T.; Choi, N.-S., Magnesium(II) Bis(trifluoromethane sulfonyl) Imide-Based Electrolytes with Wide Electrochemical Windows for Rechargeable Magnesium Batteries. ACS Appl. Mater. Interfaces 2014, 6 (6), 4063-4073. http://dx.doi.org/10.1021/am405619v
23. Baskin, A.; Prendergast, D., Exploration of the Detailed Conditions for Reductive Stability of Mg(TFSI)2 in Diglyme: Implications for Multivalent Electrolytes. The Journal of Physical Chemistry C 2016, 120 (7), 3583-3594. http://dx.doi.org/10.1021/acs.jpcc.5b08999
24. Keyzer, E. N.; Glass, H. F. J.; Liu, Z.; Bayley, P. M.; Dutton, S. E.; Grey, C. P.; Wright, D. S., Mg(PF₆)₂-Based Electrolyte Systems: Understanding Electrolyte-Electrode Interactions for the Development of Mg-lon Batteries. J. Am. Chem. Soc. 2016, 138 (28), 8682-8685. http://dx.doi.org/10.1021/jacs.6b04319
25. Li, Q.; Chen, J.; Fan, L.; Kong, X.; Lu, Y., Progress in electrolytes for rechargeable Li-based batteries and beyond. Green Energy & Environment 2016, 1 (1), 18-42. https://doi.org/10.1016/j.gee.2016.04.006
26. Ma, Z.; Kar, M.; Xiao, C.; Forsyth, M.; MacFarlane, D. R., Electrochemical cycling of Mg in Mg[TFSI]2/tetraglyme electrolytes. Electrochem. Commun. 2017, 78, 29-32. https://doi.org/10.1016/j.elecom.2017.03.018
27. Zhao-Karger, Z.; Gil Bardaji, M. E.; Fuhr, O.; Fichtner, M., A new class of non-corrosive, highly efficient electrolytes for rechargeable magnesium batteries. Journal of Materials Chemistry A 2017, 5 (22), 10815-10820. http://dx.doi.org/10.1039/C₇TA02237A
28. Hahn, N. T.; Seguin, T. J.; Lau, K.-C.; Liao, C.; Ingram, B. J.; Persson, K. A.; Zavadil, K. R., Enhanced Stability of the Carba-closo-dodecaborate Anion for High-Voltage Battery Electrolytes through Rational Design. J. Am. Chem. Soc. 2018, 140 (35), 11076-11084. https://doi.org//10.1021/jacs.8b05967
29. Jay, R.; Tomich, A. W.; Zhang, J.; Zhao, Y.; De Gorostiza, A.; Lavallo, V.; Guo, J., Comparative Study of Mg(CB11H12)2 and Mg(TFSI)2 at the Magnesium/Electrolyte Interface. ACS Appl. Mater. Interfaces 2019, 11 (12), 11414-11420. http://dx.doi.org/10.1021/acsami.9b00037
30. Li, Z.; Fuhr, O.; Fichtner, M.; Zhao-Karger, Z., Towards stable and efficient electrolytes for room-temperature rechargeable calcium batteries. Energy & Environmental Science 2019, 12 (12), 3496-3501. https://doi.org//10.1039/C9EE01699F
31. Shyamsunder, A.; Blanc, L. E.; Assoud, A.; Nazar, L. F., Reversible Calcium Plating and Stripping at Room Temperature Using a Borate Salt. ACS Energy Letters 2019, 4 (9), 2271-2276. https://doi.org//10.1021/acsenergylett.9b01550
32. Kisu, K.; Kim, S.; Shinohara, T.; Zhao, K.; Zuttel, A.; Orimo, S-i., Monocarborane cluster as a stable fluorine-free calcium battery electrolyte. Scientific Reports 2021, 11 (1), 7563. http://dx.doi.org/10.1038/s41598-021-86938-0
33. Muldoon, J.; Bucur, C. B.; Oliver, A. G.; Zajicek, J.; Allred, G. D.; Boggess, W. C., Corrosion of magnesium electrolytes: chlorides—the culprit. Energy Environ. Sci. 2013, 6 (2), 482-487. http://dx.doi.org/10.1039/C₂EE23686A
34. Gregory, T. D.; Hoffman, R. J.; Winterton, R. C., Nonaqueous Electrochemistry of Magnesium: Applications to Energy Storage. J. Electrochem. Soc. 1990, 137 (3), 775-780. https://doi.org//10.1149/1.2086553
35. Pavčnik, T.; Lozinšek, M.; Pirnat, K.; Vizintin, A.; Mandai, T.; Aurbach, D.; Dominko, R.; Bitenc, J., On the Practical Applications of the Magnesium Fluorinated Alkoxyaluminate Electrolyte in Mg Battery Cells. ACS Appl. Mater. Interfaces 2022, 14 (23), 26766-26774. http://dx.doi.org/10.1021/acsami.2c05141
36. Mandai, T., Critical Issues of Fluorinated Alkoxyborate-Based Electrolytes in Magnesium Battery Applications. ACS Appl. Mater. Interfaces 2020, 12 (35), 39135-39144. http://dx.doi.org/10.1021/acsami.0c09948
37. Luo, J.; Bi, Y.; Zhang, L.; Zhang, X.; Liu, T. L., A Stable, Non-Corrosive Perfluorinated Pinacolatoborate Mg Electrolyte for Rechargeable Mg Batteries. Angew. Chem. Int. Ed. 2019, 58 (21), 6967-6971. https://doi.org/10.1002/anie.201902009
38. Schmidt, A.; Koger, H.; Barthélemy, A.; Studer, G.; Esser, B.; Krossing, I., Is One of the Least Coordinating Anions Suitable to Serve as Electrolyte Salt for Magnesium-Ion Batteries?Batteries & Supercaps 2022, 5 (12), e202200340. http://dx.doi.org/10.1002/batt.202200340
39. McArthur, S. G.; Geng, L.; Guo, J.; Lavallo, V., Cation reduction and comproportionation as novel strategies to produce high voltage, halide free, carborane based electrolytes for rechargeable Mg batteries. Inorg. Chem. Front. 2015, 2 (12), 1101-1104. http://dx.doi.org/10.1039/C5QI00171D
40. Tutusaus, O.; Mohtadi, R.; Singh, N.; Arthur, T. S.; Mizuno, F., Study of Electrochemical Phenomena Observed at the Mg Metal/Electrolyte Interface. ACS Energy Letters 2017, 2 (1), 224-229. https://doi.org//10.1021/acsenergylett.6b00549
41. Tomich, A. W.; Chen, J.; Carta, V.; Guo, J.; Lavallo, V., Electrolyte Engineering with Carboranes for Next-Generation Mg Batteries. ACS Central Science 2024, 10 (2), 264-271. http://dx.doi.org/10.1021/acscentsci.3c01176
42. Tutusaus, O.; Mohtadi, R.; Arthur, T. S.; Mizuno, F.; Nelson, E. G.; Sevryugina, Y. V., An Efficient Halogen-Free Electrolyte for Use in Rechargeable Magnesium Batteries. Angew. Chem. Int. Ed. 2015, 54 (27), 7900-7904. https://doi.org/10.1002/anie.201412202
43. Liberman-Martin, A. L.; Bergman, R. G.; Tilley, T. D., Lewis Acidity of Bis(perfluorocatecholato)silane: Aldehyde Hydrosilylation Catalyzed by a Neutral Silicon Compound. J. Am. Chem. Soc. 2015, 137 (16), 5328-5331. http://dx.doi.org/10.1021/jacs.5b02807
44. Maskey, R.; Schädler, M.; Legler, C.; Greb, L., Bis(perchlorocatecholato)silane—A Neutral Silicon Lewis Super Acid. Angew. Chem. Int. Ed. 2018, 57 (6), 1717-1720. http://dx.doi.org/10.1002/anie.201712155
45. Hartmann, D.; Schädler, M.; Greb, L., Bis(catecholato)silanes: assessing, rationalizing and increasing silicon's Lewis superacidity. Chemical Science 2019, 10 (31), 7379-7388. http://dx.doi.org/10.1039/C₉SC02167A
46. Thorwart, T.; Roth, D.; Greb, L., Bis(pertrifluoromethylcatecholato)silane: Extreme Lewis Acidity Broadens the Catalytic Portfolio of Silicon. Chemistry—A European Journal 2021, 27 (40), 10422-10427. http://dx.doi.org/10.1002/chem.202101138
47. Tschernuth, F. S.; Thorwart, T.; Greb, L.; Hanusch, F.; Inoue, S., Bis(perfluoropinacolato)silane: A Neutral Silane Lewis Superacid Activates Si—F Bonds.
Angew. Chem. Int. Ed. 2021, 60 (49), 25799-25803. https://doi.org/10.1002/anie.202110980
48. Müller, L. O.; Himmel, D.; Stauffer, J.; Steinfeld, G.; Slattery, J.; Santiso-Quiñones, G.; Brecht, V.; Krossing, I., Simple Access to the Non-Oxidizing Lewis Superacid PhF→Al(ORF)₃ (R_{F}=C(CF₃)₃). Angew. Chem. Int. Ed. 2008, 47 (40), 7659-7663. https://doi.org/10.1002/anie.200800783
49. Frye, C. L., Pentacoordinate Silicon Derivatives. 11.1 Salts of Bis(o-arylenedioxy) organosiliconic Acids. J. Am. Chem. Soc. 1964, 86 (15), 3170-3171. http://dx.doi.org/10.1021/ja01069a054
50. Frye, C. L., Pentacoordinate silicon derivatives. IV. Alkylammonium siliconate salts derived from aliphatic 1,2-diols. J. Am. Chem. Soc. 1970, 92 (5), 1205-1210. http://dx.doi.org/10.1021/ja00708a016
51. Chuit, C.; Corriu, R. J. P.; Reye, C.; Young, J. C., Reactivity of penta- and hexacoordinate silicon compounds and their role as reaction intermediates. Chem. Rev. 1993, 93 (4), 1371-1448. http://dx.doi.org/10.1021/cr00020a003
52. Deposition numbers 2388672 (for 1-[Ni(COD)₂]), 2388673 (for 3-[Ph₃C]), 2388674 (for 1-[Ag(NCMe)₂]), 2388675 (for 1-[Fc]), 2388676 (for 1-[Et₃NH]), 2388677 (for 3-[Et₃NH]), 2388678 (for 7-[Et₃NH]), 2388679 (for 3-[K]), 2388680 (for 1-[Mg(DME)₃]) contain the supplementary crystallographic data for this paper. These data are provided free of charge by the joint Cambridge Crystallographic Data Centre and Fachinformationszentrum Karlsruhe Access Structures service.
53. Steiner, T., The Hydrogen Bond in the Solid State. Angew. Chem. Int. Ed. 2002, 41 (1), 48-76. https://doi.org/10.1002/1521-3773(20020104)41:1<48::AID-ANIE48>3.0.CO; 2-U
54. Chen, E. Y. X.; Lancaster, S. J., 1.24—Weakly Coordinating Anions: Highly Fluorinated Borates. In Comprehensive Inorganic Chemistry II (Second Edition), Reedijk, J.; Poeppelmeier, K., Eds. Elsevier: Amsterdam, 2013; pp 707-754.
55. Kays, D. L.; Rossin, A.; Day, J. K.; Ooi, L.-L.; Aldridge, S., Synthetic and reaction chemistry of heteroatom stabilized boryl and cationic borylene complexes. Dalton Trans. 2006, (2), 399-410. http://dx.doi.org/10.1039/B512275A
56. Scerba, M. T.; Leavitt, C. M.; Diener, M. E.; DeBlase, A. F.; Guasco, T. L.; Siegler, M. A.; Bair, N.; Johnson, M. A.; Lectka, T., NH+−F Hydrogen Bonding in a Fluorinated “Proton Sponge” Derivative: Integration of Solution, Solid-State, Gas-Phase, and Computational Studies. The Journal of organic chemistry 2011, 76 (19), 7975-7984. http://dx.doi.org/10.1021/jo2015328
57. Carreras, L.; Rovira, L.; Vaquero, M.; Mon, I.; Martin, E.; Benet-Buchholz, J.; Vidal-Ferran, A., Syntheses, characterisation and solid-state study of alkali and ammonium BArF salts. RSC Advances 2017, 7 (52), 32833-32841. http://dx.doi.org/10.1039/C7RA05928K
58. Dong, Z.; Pezzato, C.; Sienkiewicz, A.; Scopelliti, R.; Fadaei-Tirani, F.; Severin, K., SET processes in Lewis acid-base reactions: the tritylation of N-heterocyclic carbenes. Chemical Science 2020, 11 (29), 7615-7618. http://dx.doi.org/10.1039/DOSC01278E
59. Dasgupta, A.; Richards, E.; Melen, R. L., Frustrated Radical Pairs: Insights from EPR Spectroscopy. Angew. Chem. Int. Ed. 2021, 60 (1), 53-65. http://dx.doi.org/10.1002/anie.202010633
60. Newman-Stonebraker, S. H.; Raab, T. J.; Roshandel, H.; Doyle, A. G., Synthesis of Nickel(I)—Bromide Complexes via Oxidation and Ligand Displacement: Evaluation of Ligand Effects on Speciation and Reactivity. J. Am. Chem. Soc. 2023, 145 (35), 19368-19377. https://doi.org//10.1021/jacs.3c06233
61. Schmitt, M.; Mayländer, M.; Heizmann, T.; Richert, S.; Bülow, C.; Hirsch, K.; Zamudio-Bayer, V.; Lau, J. T.; Krossing, I., Isolation and Characterization of the Homoleptic Nickel(I) and Nickel(II) Bis-benzene Sandwich Cations. Angew. Chem. Int. Ed. 2022, 61 (50), e202211555. https://doi.org/10.1002/anie.202211555
62. Schmitt, M.; Maylander, M.; Radtke, V.; Heizmann, T.; Richert, S.; Krossing, I., [Ni(CO)₄]⁺ as Ni^{I} Synthon: Synthesis and Characterization of Ni^{I} Half-Sandwich and Sandwich Cations. Chemistry—A European Journal 2023, 29 (40), e202301419. https://doi.org/10.1002/chem.202301419
63. Schwab, M. M.; Himmel, D.; Kacprzak, S.; Kratzert, D.; Radtke, V.; Weis, P.; Ray, K.; Scheidt, E.-W.; Scherer, W.; de Bruin, B.; Weber, S.; Krossing, I., [Ni(cod)₂][Al(OR^{F})₄], a Source for Naked Nickel(I) Chemistry. Angew. Chem. Int. Ed. 2015, 54 (49), 14706-14709. https://doi.org/10.1002/anie.201506475
64. Drent, E.; Van Broekhoven, J. A. M.; Doyle, M. J., Efficient palladium catalysts for the copolymerization of carbon monoxide with olefins to produce perfectly alternating polyketones. J. Organomet. Chem. 1991, 417 (1), 235-251. https://doi.org/10.1016/0022-328X(91)80176-K
65. Drent, E.; Budzelaar, P. H. M., Palladium-Catalyzed Alternating Copolymerization of Alkenes and Carbon Monoxide. Chem. Rev. 1996, 96 (2), 663-682. http://dx.doi.org/10.1021/cr940282j
66. Ledford, J.; Shultz, C. S.; Gates, D. P.; White, P. S.; DeSimone, J. M.; Brookhart, M., Bond Angle Effects on the Migratory Insertion of Ethylene and Carbon Monoxide into Palladium(II)-Methyl Bonds in Complexes Bearing Bidentate Phosphine Ligands. Organometallics 2001, 20 (25), 5266-5276. http://dx.doi.org/10.1021/om010489k
67. Shultz, C. S.; Ledford, J.; DeSimone, J. M.; Brookhart, M., Kinetic Studies of Migratory Insertion Reactions at the (1,3-Bis(diphenylphosphino)propane)Pd(II) Center and Their Relationship to the Alternating Copolymerization of Ethylene and Carbon Monoxide. J. Am. Chem. Soc. 2000, 122 (27), 6351-6356. http://dx.doi.org/10.1021/ja994251n
68. Mohtadi, R.; Matsui, M.; Arthur, T. S.; Hwang, S.-J., Magnesium Borohydride: From Hydrogen Storage to Magnesium Battery. Angew. Chem. Int. Ed. 2012, 51 (39), 9780-9783. https://doi.org/10.1002/anie.201204913

### Example 2 Preparation of [Et₃NH][^{C6F5}Si^{F}₂₄]⁻, and Functionalization Via S_{N}Ar Thereafter

A perfluorinated silicate with no C—H bonds, [^{C6F5}Si^{F}₂₄]⁻, was prepared as an analog to the widely deployed [B(C₆F₅)₄]⁻ anion by reacting C₆F₅SiCl₃ with stoichiometric Et₃N and perfluoropinacol (Scheme 1):

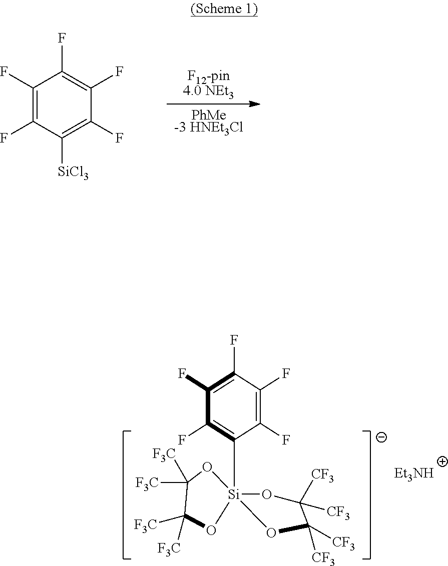

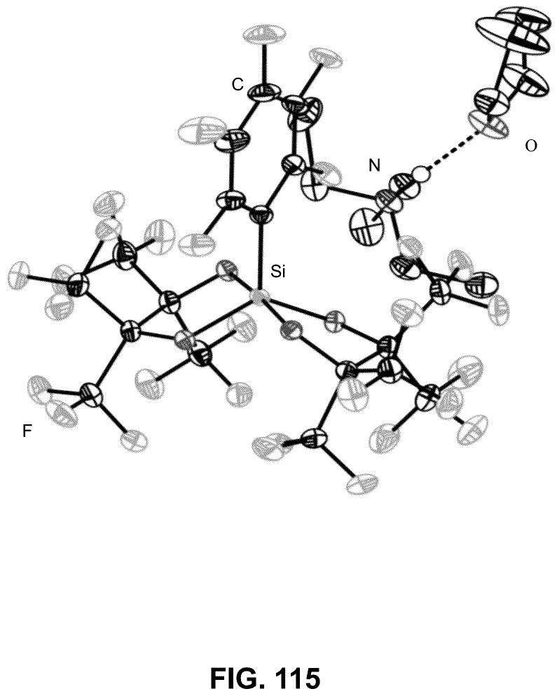

The X-ray crystal structure of [Et₃NH][^{C6F5}Si^{F}₂₄] is shown in FIG. 115.

The C₆F₅—motif provides a useful handle for further synthetic modification by nucleophilic aromatic substitution (S_{N}Ar) at the para position. Reactions of [^{C6F5}Si^{F}₂₄] with a variety of R—Li reagents readily affords functionalized [^{RC6F4}Si^{F}₂₄]⁻ anions (Scheme

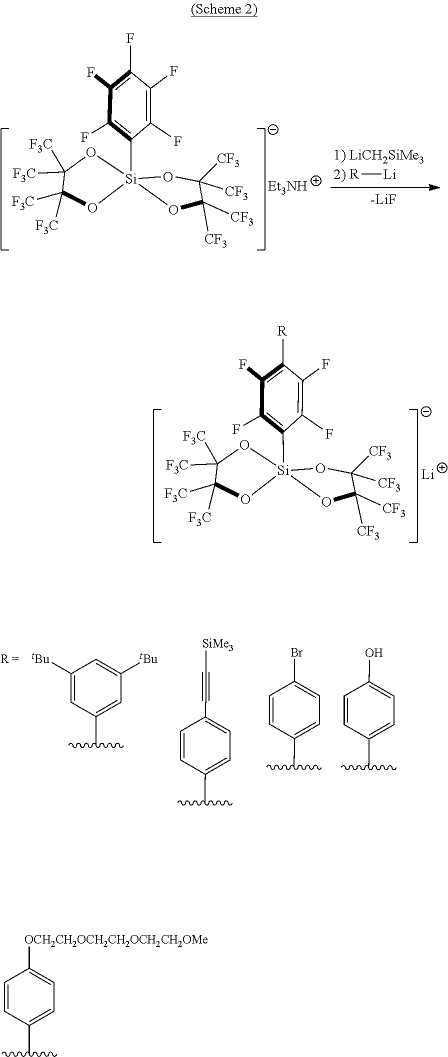

Preparations of these functionalized [^{RC6F4}Si^{F}₂₄] anions is expected to allow for installation of an anionic [^{RC6F4}Si^{F}₂₄] moiety on a variety of ligands and/or metal complexes. For example, Li-halogen exchange of [^{RC6F4}Si^{F}₂₄]⁻ (R=BrC₆H₄) readily affords the aryl lithium reagent, a useful synthon for cross-coupling and S_{N}Ar reactions

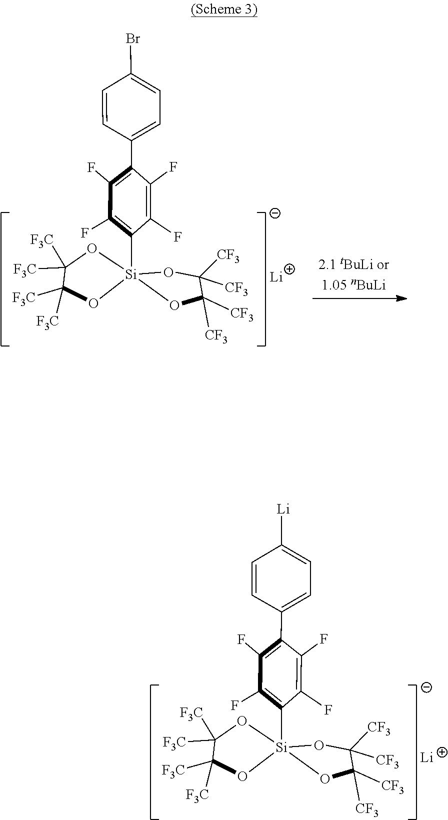

### Example 3—Preparation of Polyanionic [^{R}Si^{F}₂₄] Anions

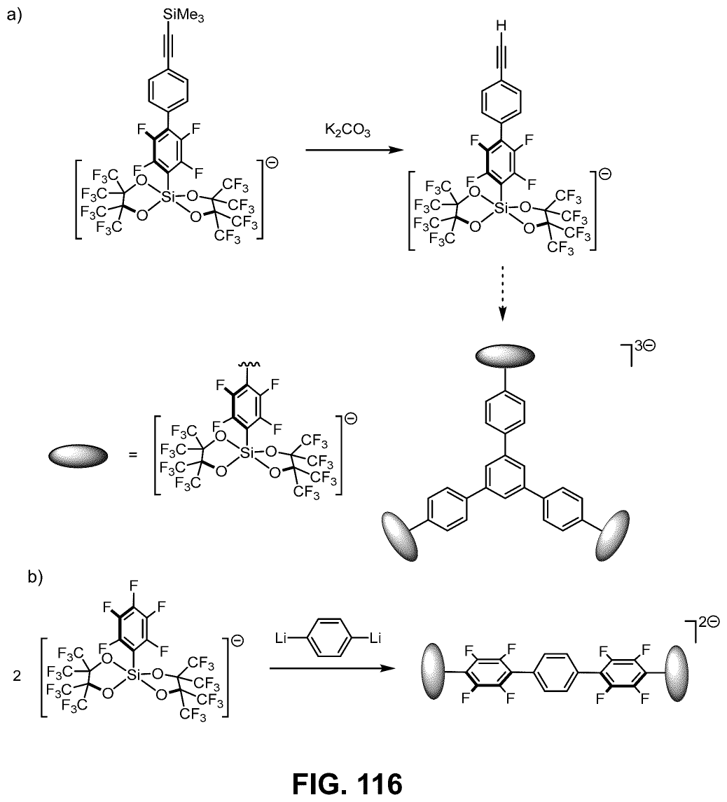

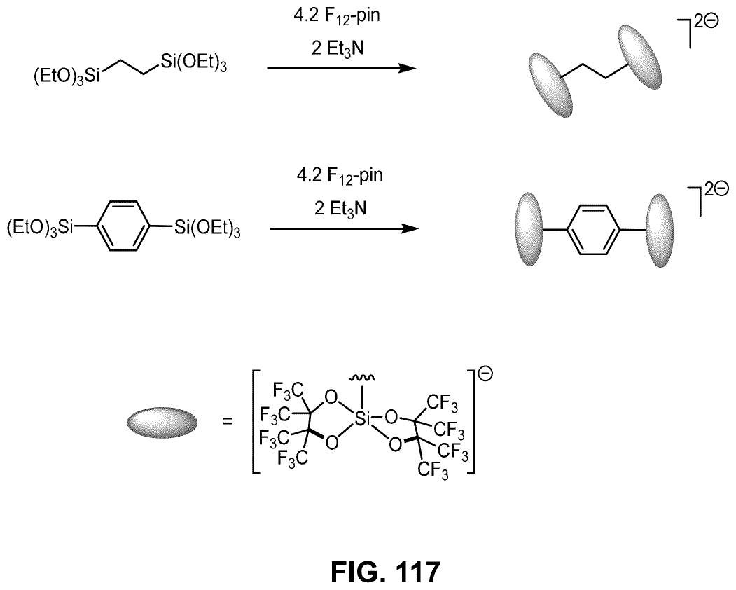

The alkyne functionalized [^{RC6F4}Si^{F}₂₄] anion serves as a useful synthon for accessing trianionic silicate motifs (FIG. 116; Scheme 4, a). The general functionalization of the [^{C6F5}Si^{F}₂₄]⁻ anion via S_{N}Ar can be applied to preparation of dianionic variants (Scheme 4, b) by reacting two equivalents of [^{C6F5}Si^{F}₂₄]⁻ with Li₂C₆H₄. Other dianionic variants can be readily accessed via commercially available ethoxysilane precursors per Scheme 4, as shown in FIG. 116.

### Example 4—Other Weakly Coordinating Anion Silicates with Different Fluorinated Ligands

In addition to the WCA silicates having two perfluoropinacolate ligands, as discussed above, other weakly coordinating anion silicates with different fluorinated ligands were developed. For example, one of more of the following diols may be selected:

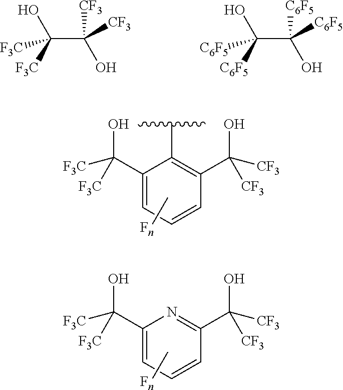

The resulting WCA silicates include the following non-limiting examples:

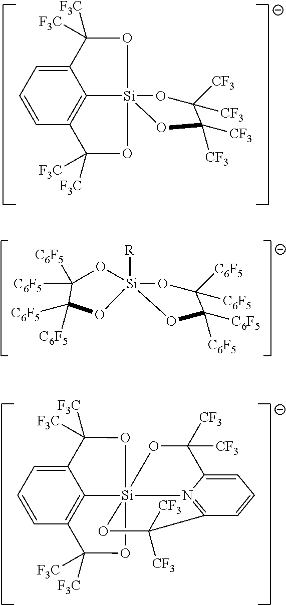

### General Considerations—Synthesis

Unless otherwise specified, all operations were carried out in an MBraun drybox under a nitrogen atmosphere or using standard Schlenk line or high vacuum techniques. Solvents for air- and moisture-sensitive reactions were dried with sodium mirror (1,4 dioxane), sodium benzophenone ketyl (THF, DME and Et₂O), or by the method of Grubbs (toluene, pentane, benzene).¹ DME used for electrochemistry experiments were either dried via sodium benzophenone ketyl or dried via passing through activated Al₂O₃ (180° C., 16 hours). Solvents, once dried and degassed, were vacuum transferred directly and stored under inert atmosphere over 3 Å molecular sieves. C₆D6, C₇D8, CD₃CN, CD₂Cl₂ were purchased from Cambridge Isotope Laboratories and vacuum transferred from sodium benzophenone ketyl (C₆D6, C₇D₈) or CaH₂ (CD₃CN, CD₂Cl₂) after three freeze-pump-thaw cycles. Et₃N was dried over CaH₂, degassed, and vacuum transferred prior to use. Perfluoropinacol was purchased from TCl America and used as received. Li₂(O₂(C(CF₃)₂)₂) was prepared according to literature procedures.² For the preparation of Li₂(O₂(C(CF₃)₂)₂), perfluoropinacol was dried over 3 Å molecular sieves at 40° C. for at least 16 hours and vacuum transferred. MeSi(OEt)₃ was purchased from Sigma-Aldrich and used as received. PhSi(OEt)₃ was purchased from Oakwood and used as received. SiCl₄ was purchased from Sigma-Aldrich, dried over CaH₂, and distilled immediately before use. Unless otherwise noted, RSiCl₃ precursors were purchased from commercial vendors, freeze-pump-thawed thrice, and bump-degassed before use.

Unless otherwise noted, all other chemicals were purchased from commercial vendors and used as received. ¹H, ¹³C, ¹⁹F, and ²⁹Si NMR spectra were either recorded on a Varian 400 MHz spectrometer or a Bruker 400 MHz spectrometer with chemical shifts reported in parts per million (ppm). ¹H NMR spectra were referenced to residual solvent peaks.¹ Multiplicities are abbreviated as follows: s=singlet, d=doublet, t=triplet, dd=doublet of doublets, dt=doublet of triplets, td=triplet of doublets, m=multiplet, br=broad, and app=apparent.

General Considerations—Electrochemical characterization

Linear sweep voltammetry experiments of 1-[Bu₄N] and [Bu₄N][PF₆] were performed under an N2 atmosphere using a Pine Instrument Company AFCBP1 bipotentiostat using the AfterMath software package. Linear sweep voltammograms were recorded in the glovebox at 25° C. with an auxiliary Pt-coil counter electrode, Ag-wire reference electrode, and 3.0 mm glassy carbon working electrode (BASI). The electrolyte solution was 0.1 M of the corresponding tetra-n-butylammonium salt in MeCN. All reported values are referenced to an internal ferrocene/ferrocenium couple.

Cyclic voltammetry experiments of 1-[Mg(DME)₃] were run in an empty N2-filled glovebox fitted with a purifier system that consists of a purifier cartridge (ca. 50% activated 4 Å molecular sieves and activated Cu catalyst) and a circulator fan, no solvent or chemicals were stored in the glovebox. Electrolyte solutions were prepared in a separate glovebox by dissolving 1-[Mg(DME)₃] in 500 μL of DME and stirred with a new Teflon stir bar until complete dissolution. DME and 1-[Mg(DME)₃] were only used with the glovebox circulation purifier turned off after extensive (minimum 20 minutes at 4.0 bar above atmospheric pressure to ensure full atmosphere exchange) purging of the glovebox atmosphere to avoid cross-contamination with other atmospheric solvents. Upon complete dissolution of the electrolyte, the electrolyte solution was sealed and transported to the electrochemistry glovebox immediately before electrochemical experiments were performed.

Mg electrodes (99.9%, MTI) were polished with a razor blade immediately before use. Pt electrodes (wire, 0.5 mm diameter, 99.995%, Thermo Scientific) were soaked in concentrated HNO₃ for at least 72 hours, rinsed with deionized water at least thrice, annealed with an H₂ torch, and immediately brought into the glovebox in a flame-dried 20 mL scintillation vial while hot. Cyclic voltammetry experiments of 1-[Mg(DME)₃] were performed in glass cells with 0.5 mL of electrolyte. A Pt wire served as the working electrode (WE), and Mg foils were the counter and reference electrodes (CE and RE). Experiments of 1-[Mg(DME)₃] were conducted on either a Biologic SP150 potentiostat or a Biologic VSP-300 potentiostat.

Synthesis of [Et₃NH][^{Me}Si^{F}₂₄]/1-[Et₃NH]

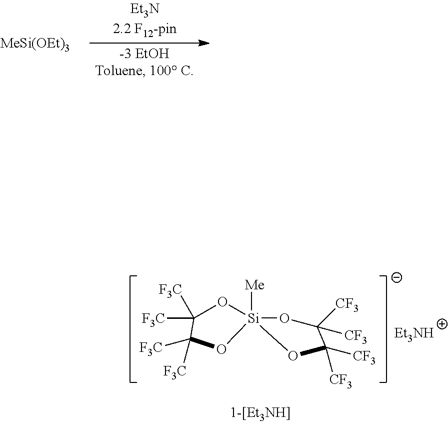

In an N₂-filled glovebox, a 250 mL Schlenk tube fitted with a Teflon screw-in stopper was charged with a Teflon stir bar, Et₃N (8.9 g, 0.09 mol), and PhMe (100 mL). The Schlenk tube was sealed and connected to a Schlenk line. Under a heavy Ar counterflow, the Teflon screw-in stopper was replaced with a septum. Stirring was initiated. MeSi(OEt)₃ (15.7 g, 0.09 mol) and F₁₂-pin (65 g, 0.20 mol) were added via syringe sequentially. (The addition of F₁₂-pin to the reaction mixture is extremely exothermic and smoking is normally observed. For larger-scale reactions, it is recommended to cool the reaction with an ice bath). Once smoking of the reaction mixture ceased, the septum was replaced with the Teflon screw-in stopper and heated to 100° C. for 16 hours. After 16 hours, the light-yellow suspension was concentrated in vacuo to −20 mL, and anhydrous pentane (ca. 500 mL) was cannula transferred to the reaction mixture, further precipitating the product as a white solid. The Schlenk tube was shaken vigorously, and the suspension was stirred for 10 minutes. The supernatant was decanted off via cannula and the resulting white solids were dried in vacuo. Anhydrous toluene (˜250 mL) was cannula transferred to the white solids. The solids were stirred vigorously overnight, collected over a medium porosity sintered glass frit, and washed with additional toluene (3×70 mL) and pentane (40 mL) to yield analytically pure 1-[Et₃NH](64.4 g, 94%).

¹H (CD₃CN, 400 MHz): 6.57 (br app t, 1H, N—H), 3.14 (q, 6H, NCH₂CH₃), 1.24 (t, 9H, NCH₂CH₃), 0.20 (s, 3H, SiCH₃).

¹⁹F (CD₃CN, 376 MHz): −69.83 (app s, 12 F, CF₃), −69.86 (app s, 12 F, CF₃).

¹³C{¹H}(CD₃CN, 101 MHz): 123.79 (q app m, CF₃), 84.56 (br s, OC(CF₃)₂), 48.10 (s, NCH₂CH₃), 9.11 (s, NCH₂CH₃), 1.05 (s, SiCH₃).

²⁹Si (CD₃CN, 80 MHz): −73.75 (s). Anal. Calcd. for C₁₉H₁₉F₂₄NO₄Si (%): C, 28.19; H, 2.37; N, 1.73. Found: C: 28.30; H 2.37; N, 1.65.

The preparation of 1-[Et₃NH] can be carried out with less rigorous exclusion of air and moisture where benchtop chemicals were used unless otherwise noted: A 100 mL round bottom flask was charged with MeSi(OEt)₃ (2.2 g, 12 mmol), Et₃N (2.75 g, 27 mmol), anhydrous PhMe (10 mL, sealed in a vial and brought out of an N₂-filled dry box and poured into the round bottom flask in air prior to setting up the reaction), a Teflon stir bar, and F₁₂-pin (9.1 g, 27 mmol). A reflux condenser was connected to the round bottom flask and gentle N₂ flow was initiated without further degassing the reaction vessel. The mixture was stirred at 105° C. for 16 hours, resulting in a brown, homogeneous viscous solution. The solution was concentrated to ca. 5 mL in vacuo and then poured into 150 mL of pentane with stirring, precipitating a white solid coated in brown oil. The yellow supernatant was decanted. The solids were dissolved in Et₂O and precipitated with hexanes once more. The solids were collected on a medium porosity frit and quickly washed with Et₂O until a colorless solid was obtained. The solids were stirred in ca. 120 mL of PhMe for 10 minutes and collected with a medium porosity sintered glass frit. The solids were washed with PhMe (ca. 150 mL) and hexanes (ca. 20 mL) sequentially and dried. 1-[Et₃NH] prepared this way was analytically identical to the compound prepared with exclusion of air and moisture as described above, but a low yield was obtained (1.2 g, 12%).

[Et₃NH][^{Ph}Si^{F}₂₄]/2-[Et₃NH] is prepared in an analogous manner to 1-[Et₃NH], utilizing PhSi(OEt)₃ instead. Yield: (64.8 g, 81%).

¹H NMR (CD₃CN, 400 MHz): 7.80 (app dd, 2H, aryl-H), 7.24 (overlapping m, 3H, aryl-H), 6.53 (app br t, 1H, N—H), 3.13 (q, 6H, —NCH₂CH₃), 1.24 (t, —NCH₂CH₃).

¹⁹F NMR (CD₃CN, 376 MHz): −69.49 (app s, 12 F, CF₃), −69.91 (app s, 12 F, CF₃).

¹³C{¹H}(CD₃CN, 101 MHz): 140.08 (s, aryl-C), 137.17 (s, aryl-C), 129.26 (s, aryl-C), 127.33 (s, aryl-C), 123.55 (q app m, CF₃), 84.24 (app s, OC(CF₃)₂), 48.04 (s, NCH₂CH₃), 9.12 (s, NCH₂CH₃).

²⁹Si (CD₃CN, 80 MHz): −89.33 (s).

Ana. Calcd. for C₂₄H₂₁F₂₄NO₄Si (%): C, 33.08; H, 2.43; N, 1.61. Found: C, 33.02; H, 2.28; N, 1.50.

1-[Me₂NHPh]/2-[Me₂NHPh] is prepared in an analogous manner to 1-[Et₃NH] and 2-[Et₃NH], utilizing Me₂NPh instead of Et₃N.

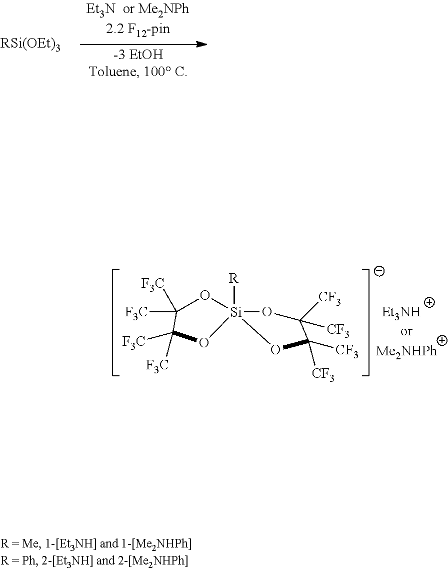

1-[Me₂NHPh](10.5 g, 53%).

¹H (CD₃CN, 400 MHz): 8.86 (s, N—H), 7.58 (overlapping m, 5H, Me₂N(C₆H₅)), 3.23 (s, 6H, (CH₃)₂NPh), 0.19 (s, 3H, —SiCH₃).

¹⁹F NMR (CD₃CN, 376 MHz): −69.84 (overlapping app br s, 24 F, —CF₃).

¹³C{¹H}(CD₃CN, 101 MHz): 143.05 (s, aryl-C), 131.60 (s, aryl-C), 131.55 (s, aryl-C), 123.14 (q app m, —CF₃), 123.44 (s, aryl-C), 84.52 (br s, OC(CF₃)₂), 47.87 (s, (CH₃)₂NPh), 0.97 (s, SiCH₃).

²⁹Si (CD₃CN, 80 MHz): −73.74 (s).

Anal. Calcd. for C₂₁H₁₅F₂₄NO₄Si (%): C, 30.41; H, 1.82; N, 1.69; Found: C, 30.34; H, 1.68; N, 1.57.

2-[Me₂NHPh](4.57 g, 65%).

¹H (CD₃CN, 400 MHz): 8.85 (s, N—H), 7.80 (m, 2H, Si—C₆H₅), 7.57 (overlapping m, 5H, Me₂N(C₆H₅)), 7.23 (overlapping m, 3H, Si—C₆H₅), 3.23 (s, 6H, (CH₃)₂NPh).

¹⁹F NMR (CD₃CN, 376 MHz): −69.49 (app m, 12 F, —CF₃), −69.90 (app m, 12 F, —CF₃).

¹³C{¹H}(CD₃CN, 101 MHz): 143.13 (s, Me₂N(C₆H₅)), 140.06 (s, Si—C₆H₅), 137.14 (s, Si—C₆H₅), 131.53 (s, Me₂N(C₆H₅)), 131.46 (s, Me₂N(C₆H₅)), 129.25 (s, Si—C₆H₅), 127.32 (s, Si—C₆H₅), 123.50 (q app m, —CF₃), 121.36 (s, Me₂N(C₆H₅)), 84.22 (br s, OC(CF₃)₂), 47.80 (s, (CH₃)₂NPh).

²⁹Si (CD₃CN, 80 MHz): −89.34 (s).

Anal. Calcd. for C₂₆H₁₇F₂₄NO₄Si (%): C, 35.03; H, 1.92; N, 1.57; Found: C, 34.87; H, 1.89; N, 1.48.

Synthesis of (3,5-^{t}Bu₂C₆H₃)SiCl₃

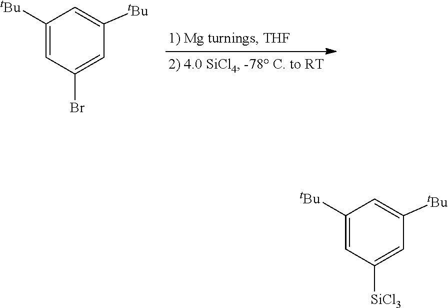

In an N₂-filled glovebox, Mg turnings (5 equiv) were transferred to a Schlenk tube and suspended in 200 mL of THF. 1-Bromo-3,5-di-tert-butylbenzene (11.5 g, 1 equiv) was dissolved in 50 mL of THF and added dropwise while maintaining vigorous stirring. Upon complete addition of the aryl bromide, the Grignard was stirred for 30 min at RT. A separate Schlenk tube was filled with 200 mL of THF and cycled onto the Schlenk line and 15 mL of SiCl₄ (21.73 g, 4 equiv) was transferred via syringe. The flask was then cooled to −78° C., and the Grignard solution was transferred dropwise (1 drop/second) via cannula to the chilled SiCl₄ solution. After complete addition, the reaction continued to stir in the chilled bath for 16 hr, slowly warming to RT. The volatiles were concentrated in vacuo, and the desired product was extracted with pentane and filtered to remove the salts. The product was isolated as a clear, colorless oil and used in subsequent steps without further purification. 4-tert-butyl-phenyl-SiCl₃ and styrene-SiCl₃ can be prepared analogously beginning from 1-bromo-4-tert-butylbenzene and 4-bromostyrene, respectively, and used without further purification.

Synthesis of [Et₃H][^{tBu2Ar}Si^{F}₂₄]/3-[Et₃NH]

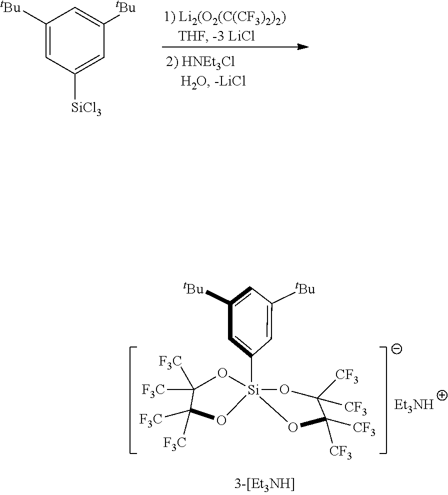

In an N₂-filled glovebox, Li₂(O₂(C(CF₃)₂)₂) (16.7 g, 48.4 mmol, 2.0 equiv) was dissolved in MeCN (100 mL). (3,5 di^{t}Bu)SiCl₃ was dissolved in MeCN and added to the stirring solution, with precipitation of LiCl within 5 minutes. The reaction was stirred for an additional 30 min at RT, and the LiCl was subsequently removed by filtration. The solvent was removed in vacuo, and the thick oil was suspended in DI H₂O with excess HNEt₃Cl. The suspension was stirred at RT for 1 hr, and the solids were subsequently collected by filtration. The solid was washed extensively with DI water to remove excess HNEt₃Cl. The solid was dried for 16 hr under vacuum before being transferred to a N₂-filled and washed with anhydrous toluene. 3-[Et₃NH] was isolated as a fine white powder. Yield: (15.8 g, 66%).

[Et₃NH][^{tBu2Ar}Si^{F}₂₄]/3-[Et₃NH]

¹H (CD₃CN, 400 MHz): 7.77 (d, 2H, Ar—H), 7.38 (t, 1H, Ar—H), 6.51 (br s, 1H, N—H), 3.14 (q, 6H, NCH₂CH₃), 1.28 (s, 18H, C(CH₃)₃), 1.24 (t, 9H, NCH₂CH₃).

¹⁹F (CD₃CN, 376 MHz): −69.24 (app m, 12 F, CF₃), −69.83 (app m, 12 F, CF₃).

¹³C{¹H}(CD₃CN, 101 MHz): 148.81 (s, Ar—C), 137.86 (s, Ar—C), 132.57 (s, Ar—C), 123.12 (s, Ar—C), 123.12 (q app m, CF₃), 84.36 (br s, OC(CF₃)₂), 48.08 (s, NCH₂CH₃), 35.31 (s, C(CH₃)₃), 31.80 (s, C(CH₃)₃), 9.20 (s, NCH₂CH₃).

²⁹Si (CD₃CN, 80 MHz): −88.91 (s).

Anal. Calcd. for C₃₂H₃₇F₂₄NO₄Si (%): C, 39.07; H, 3.79; N, 1.42. Found: C, 39.04; H, 3.83; N, 1.23.

[Et₃NH][^{CH2CH2(CF2)5CF3}Si^{F}₂₄]/4-[Et₃NH], [Et₃NH][^{Decyl}Si^{F}₂₄]/5-[Et₃NH], [Et₃NH][^{Sty}Si^{F}₂₄]/6-[Et₃NH], [Et₃NH][^{Vinyl}Si^{F}₂₄]/7-[Et₃NH], [Et₃NH][^{tBuAr}Si^{F}₂₄]/8-[Et₃NH], [Et₃NH][^{Cy}Si^{F}₂₄]/9- [Et₃NH] and [Et₃NH][^{CH2CH2CF3}Si^{F}₂₄]/10-[Et₃NH] can be prepared analogously using the corresponding RSiCl₃ reagent.

[Et₃NH][^{CH2CH2(CF2)5CF3}Si^{F}₂₄]/4-[Et₃NH](7.1 g, 87%)

¹H (CD₃CN, 400 MHz): 6.52 (br app. t, 1H, N—H), 3.14 (q, 6H, NCH₂CH₃), 2.21 (m, 2H, SiCH₂CH₂(CF₂)₅CF₃), 1.24 (t, 9H, NCH₂CH₃), 1.02 (m, 2H, SiCH₂CH₂(CF₂)₅CF₃).

¹⁹F (CD₃CN, 376 MHz): −69.84 (app m, 12 F, CF₃), −70.13 (app m, 12 F, CF₃), −81.68 (tt, 3 F, SiCH₂CH₂(CF₂)₅CF₃), −116.99 (m, 2 F, SiCH₂CH₂(CF₂)₅CF₃), −122.53 (m, 2 F, SiCH₂CH₂(CF₂)₅CF₃), −123.46 (m, 2 F, SiCH₂CH₂(CF₂)₅CF₃), −124.51 (m, 2 F, SiCH₂CH₂(CF₂)₅CF₃), −126.71 (m, 2 F, SiCH₂CH₂(CF₂)₅CF₃).

¹³C{¹H}(CD₃CN, 101 MHz): 122.03 (q app m, CF₃), 117.19 (indirectly detected by ¹⁹F-¹³C HSQC, SiCH₂CH₂(CF₂)₅CF₃), 118.95 (indirectly detected by ¹⁹F⁻¹³C HSQC, SiCH₂CH₂(CF₂)₅CF₃), 111.45 (indirectly detected by ¹⁹F⁻¹³C HSQC, SiCH₂CH₂(CF₂)₅CF₃), 111.09 (indirectly detected by ¹⁹F⁻¹³C HSQC, SiCH₂CH₂(CF₂)₅CF₃), 110.31 (indirectly detected by ¹⁹F⁻¹³C HSQC, SiCH₂CH₂(CF₂)₅CF₃), 108.52 (indirectly detected by ¹⁹F⁻¹³C HSQC, SiCH₂CH₂(CF₂)₅CF₃) 84.50 (br s, OC(CF₃)₂), 48.10 (s, NCH₂CH₃), 27.30 (t, SiCH₂CH₂(CF₂)₅CF₃), 9.19 (s, NCH₂CH₃), 7.36 (s, SiCH₂CH₂(CF₂)₅CF₃).

²⁹Si (CD₃CN, 80 MHz): −78.01 (s).

Anal. Calcd. for C₂₆H₂₀F₃₇NO₄Si (%): C, 27.36; H, 1.77; N, 1.23. Found: C, 27.46; H, 1.72; N, 1.46.

[Et₃NH][^{Decyl}Si^{F}₂₄]/5-[Et₃NH](6.3 g, 80%)

¹H (CD₃CN, 400 MHz): 6.59 (br s, 1H, N—H), 3.14 (q, 6H, NCH₂CH₃), 1.38 (m, 2H, alkyl-H), 1.30 (br. app. s, 14H, alkyl-H), 1.27 (t, 9H, NCH₂CH₃), 0.91 (t, 3H, alkyl-H), 0.79 (t, 2H, alkyl-H).

¹⁹F (CD₃CN, 376 MHz): −69.75 (app s, 12 F, CF₃), −69.86 (app s, 12 F, CF₃).

¹³C{¹H}(CD₃CN, 101 MHz): 123.25 (q app m, CF₃), 84.56 (br s, OC(CF₃)₂), 48.12 (s, NCH₂CH₃), 34.04 (s, alkyl-C), 32.70 (s, alkyl-C), 30.42 (s, alkyl-C), 30.32 (s, alkyl-C), 30.16 (s, alkyl-C), 30.14 (s, alkyl-C) 25.07 (s, alkyl-C), 23.45 (s, alkyl-C), 18.39 (s, alkyl-C), 14.42 (s, alkyl-C), 9.20 (s, NCH₂CH₃).

²⁹Si (CD₃CN, 80 MHz): −75.44 (s).

Anal. Calcd. for C₂₈H₃₇F₂₄NO₄Si (%): C, 35.94; H, 3.99; N, 1.50. Found: C, 36.05; H, 3.96; N, 1.27.

[Et₃NH][^{Sty}Si^{F}₂₄]/6-[Et₃NH](3.6 g, 72%)

¹H (CD₃CN, 400 MHz): 7.75 (d, 2H, Ar—H), 7.31 (d, 2H, Ar—H), 6.73 (dd, 1H, Ar—CH═CH₂), 6.54 (br s, 1H, N—H), 5.80 (dd, 1H, Ar—CH═CH,H), 5.22 (dd, 1H, Ar—CH═CH,H), 3.13 (q, 6H, NCH₂CH₃), 1.23 (t, 9H, NCH₂CH₃).

¹⁹F (CD₃CN, 376 MHz): −69.47 (app m, 12 F, CF₃), −69.91 (app m, 12 F, CF₃).

¹³C{¹H}(CD₃CN, 101 MHz): 140.01 (s, Ar—C), 138.35 (s, Ar—C), 138.06 (s, Ar—CH═CH₂), 137.58 (s, Ar—C), 125.20 (s, Ar—C), 123.09 (q app m, CF₃), 114.26 (s, Ar—CH═CH₂), 48.08 (s, NCH₂CH₃), 9.19 (s, NCH₂CH₃).

²⁹Si (CD₃CN, 80 MHz): −89.54 (s).

Anal. Calcd. for C₂₆H₂₃F₂₄NO₄Si—·0.12 THF (based on residual solvent in NMR) (%): C, 35.12; H, 2.61; N, 1.55. Found: C, 35.42; H, 2.60; N, 1.46.

[Et₃NH][^{Vinyl}Si^{F}₂₄]/7-[Et₃NH](1.0 g, 73%)

¹H (CD₃CN, 400 MHz): 6.60 (br s, 1H, N—H), 5.88 (m, 3H, vinyl-H) 3.13 (q, 6H, NCH₂CH₃), 11.24 (t, 9H, NCH₂CH₃).

¹⁹F (CD₃CN, 376 MHz): −69.59 (app m, 12 F, CF₃), −69.79 (app m, 12 F, CF₃).

¹³C{¹H}(CD₃CN, 101 MHz): 138.55 (s, vinyl-C), 135.76 (s, vinyl-C), 123.16 (q app m, CF₃), 84.42 (br s, OC(CF₃)₂), 48.07 (s, NCH₂CH₃), 9.19 (s, NCH₂CH₃).

²⁹Si (CD₃CN, 80 MHz): −90.39 (s).

Anal. Calcd. for C₂₀H₁₉F₂₄NO₄Si (%): C, 29.24; H, 2.33; N, 1.71. Found: C, 29.36; H, 2.23; N, 1.57.

[Et₃NH][t^{BuAr}Si^{F}₂₄]/8-[Et₃NH](4.8 g, 77%)

¹H (CD₃CN, 400 MHz): 7.74 (dt, 2H, Ar—H), 7.27 (dt, 2H, Ar—H), 6.53 (br s, 1H, N—H), 3.14 (q, 6H, NCH₂CH₃), 1.29 (s, 9H, -^{t}Bu), 1.27 (t, 9H, NCH₂CH₃).

¹⁹F (CD₃CN, 376 MHz): −69.48 (app m, 12 F, CF₃), −69.81 (app m, 12 F, CF₃).

¹³C{¹H}(CD₃CN, 101 MHz): 152.02 (s, Ar—C), 137.42 (s, Ar—C), 136.45 (s, Ar—C), 124.21 (s, Ar—C), 123.26 (q app m, CF₃), 84.29 (br s, OC(CF₃)₂), 48.09 (s, NCH₂CH₃), 35.07 (s, C(CH₃)₃), 31.60 (s, C(CH₃)₃), 9.19 (s, NCH₂CH₃).

²⁹Si (CD₃CN, 80 MHz): −89.08 (s).

Elemental Calcd. for C₂₈H₂₉F₂₄NO₄Si—·0.38 THF (based on residual solvent in NMR) (%): C, 37.18; H, 3.23; N, 1.47. Found: 37.17, 3.35, 1.83.

[Et₃NH][^{Cy}Si^{F}₂₄]/9-[Et₃NH](130 mg, 10%)

¹H (CD₃CN, 400 MHz): 6.60 (br s, 1H, N—H), 3.13 (q, 6H, NCH₂CH₃), 1.81-1.05 (overlapping m, 11H, Cy-H), 1.24 (t, 9H, NCH₂CH₃).

¹⁹F (CD₃CN, 376 MHz): −69.26 (app m, 12 F, CF₃), −69.41 (app m, 12 F, CF₃).

¹³C{¹H}(CD₃CN, 101 MHz): 124.28 (q app m, —CF₃), 85.24 (app s, OC(CF₃)₂), 48.06 (s, NCH₂CH₃), 30.25 (s, Cy-C), 29.67 (s, Cy-C), 28.32 (s, Cy-C), 27.93 (s, Cy-C), 9.19 (s, NCH₂CH₃).

²⁹Si (CD₃CN, 80 MHz): −78.17 (s).

Anal. Calcd. for C₂₄H₂₇F₂₄NO₄Si (%): C, 32.85; H, 3.10; N, 1.60. Found: C, 32.55; H, 3.01; N, 1.49.

[Et₃NH][^{CH2CH2CF3}Si^{F}₂₄]/10-[Et₃NH](290 mg, 21%)

¹H (CD₃CN, 400 MHz): 6.87 (br s, 1H, N—H), 3.13 (q, 6H, —NCH₂CH₃), 2.17 (m, 2H, CF₃CH₂CH₂), 1.24 (t, 9H, NCH₂CH₃), 0.99 (app t, CF₃CH₂CH₂).

¹⁹F (CD₃CN, 376 MHz): −69.55 (app m, 3 F, CF₃CH₂CH₂), −69.81 (app m, 12 F, OC(CF₃)₂), −70.09 (app m, 12 F, OC(CF₃)₂).

¹³C{¹H}(CD₃CN, 101 MHz): 129.50 (q, CF₃CH₂CH₂), 123.01 (q app m, OC(CF₃)₂), 84.63 (app s, OC(CF₃)₂), 48.00 (s, NCH₂CH₃), 29.90 (q, CF₃CH₂CH₂), 9.77 (br s, CF₃CH₂CH₂), 9.17 (s, NCH₂CH₃).

²⁹Si (CD₃CN, 80 MHz): −78.17 (s).

Anal. Calcd. for C₂₁H₂₀F₂₇NO₄Si (%): C, 28.29; H, 2.26; N, 1.57. Found: C, 28.14; H, 2.17; N, 1.64.

Synthesis of [Mg(DME)₃][^{Me}Si^{F}₂4]₂/1—[Mg]

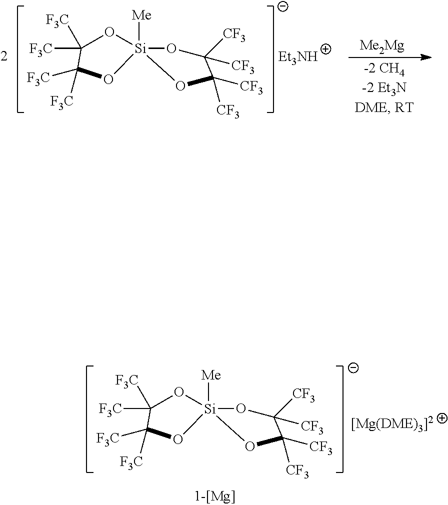

In an N₂-filled glovebox, solid Me₂Mg·0.75 (dioxane) (1.4 g, 11.9 mmol) was slowly added to a vigorously stirring solution of [Et₃NH][^{Me}Si^{F}₂₄](16.1 g, 19.9 mmol) in DME (40 mL), resulting in a slight color change to yellow. Caution: protonolysis of Me₂Mg is exothermic. Solid Me₂Mg is pyrophoric and must be handled with caution. An aliquot was drawn and analyzed via ¹H NMR spectroscopy to confirm complete consumption of the starting material as evidenced by the presence of excess Me₂Mg. The mixture was concentrated in vacuo until a waxy solid was obtained. The solids were triturated with Et₂O(30 mL×2), affording a white solid. The solid was extracted into minimal DME (ca. 80 mL on this scale) and then layered with Et₂O. The microcrystalline solid was collected, rinsed with additional Et₂O, and dried in vacuo. Yield=10.6 g (62.3%)

¹H (CD₃CN, 400 MHz): 3.58 (s, 12H, CH₃₀CH₂CH₂OCH₃), 3.38 (s, 18H, CH₃₀CH₂CH₂OCH₃), 0.19 (s, 6H, SiCH₃).

¹⁹F (CD₃CN, 376 MHz): −69.84 (app s, 12 F, CF₃), −69.87 (app s, 12 F, CF₃).

¹³C{¹H}: (CD₃CN, 101 MHz): 123.65 (q app m, CF₃), 84.47 (br s, OC(CF₃)₂), 71.93 (s, CH₃₀CH₂CH₂OCH₃), 59.46 (s, CH₃₀CH₂CH₂OCH₃), 0.97 (s, SiCH₃).

²⁹Si (CD₃CN, 80 MHz): −73.76 (s).

Anal. Calcd. for C₃₈H₃₆F₄₈MgO₁₄Si₂ (%): C, 26.71; H, 2.12; Found: C: 26.61; H: 1.93.

[Mg(DME)₃][^{Ph}Si^{F}₂₄]2/2—[Mg] can be prepared using the analogous procedure beginning from [Et₃NH][^{Ph}Si^{F}₂₄]/2-[Et₃NH].

[Mg(DME)₃][^{Ph}Si^{F}₂₄]2/2—[Mg]

¹H (CD₃CN, 400 MHz): 7.80 (app dd, 4H, Ar—H), 7.30-7.20 (overlapping m, 6H, Ar—H), 3.57 (s, 18H, CH₃OCH₂CH₂OCH₃), 3.38 (s, 12H, CH₃OCH₂CH₂OCH₃).

¹⁹F (CD₃CN, 376 MHz): −69.47 (app m, 24 F, CF₃), −69.90 (app m, 24 F, CF₃).

¹³C{¹H}(CD₃CN, 101 MHz): 140.19 (s, Ar—C), 137.27 (s, Ar—C), 129.38 (s, Ar—C), 127.49 (s, Ar—C), 123.08 (q app m, CF₃), 84.37 (br s, OC(CF₃)₂), 72.14 (s, CH₃₀CH₂CH₂OCH₃), 59.49 (s, CH₃₀CH₂CH₂OCH₃).

²⁹Si (CD₃CN, 80 MHz): −89.33 (s).

Anal. Calcd. For C₄₈H₄₀F₄₈MgO₁₄Si₂ (%): C, 31.45; H, 2.20. Found: C, 31.36; H, 2.06.

Synthesis of [K][^{Me}Si^{F}₂₄]/1—[K]

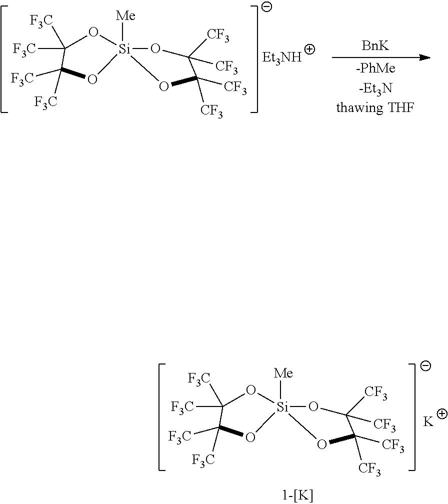

In an N₂-filled glovebox, KBn (754 mg, 5.80 mmol) was dissolved in 10 mL of THF. In a 250 mL recovery flask, [Et₃NH][^{Me}Si^{F}₂₄](4.69 g, 5.80 mmol) was dissolved in 20 mL of THF and frozen in a LN₂-chilled cold well. The KBn solution was added slowly to the thawing solution of [Et₃NH][^{Me}Si^{F}₂₄] with vigorous stirring. The solution was allowed to warm to room temperature, and the solvent was removed in vacuo, furnishing a white powder. The white powder was suspended in 40 mL of PhMe and collected on a medium porosity sintered glass frit. The filtrate was discarded, and the white powder was extracted into minimal Et₂O and diffused with pentane to yield the desired product.

Yield=(3.0 g, 70%).

¹H NMR (CD₃CN, 400 MHz): 0.20 (s, 3H, SiCH₃).

¹⁹F (CD₃CN, 376 MHz): −69.87 (overlapping app br s, 24 F, —CF₃).

¹³C{¹H}(CD₃CN, 101 MHz): 123.12 (q app m, CF₃), 84.42 (br s, OC(CF₃)₂), 0.90 (s, SiCH₃, overlapping with solvent residual signal)

²⁹Si (CD₃CN, 80 MHz): −73.71 (s).

Anal. Calcd. for C₁₃H₃F₂₄KO₄Si (%): C, 20.92; H, 0.41. Found: C, 20.82; H, 0.36.

Synthesis of [Na][^{tBu2Ar}Si^{F}₂₄]/3—[Na]

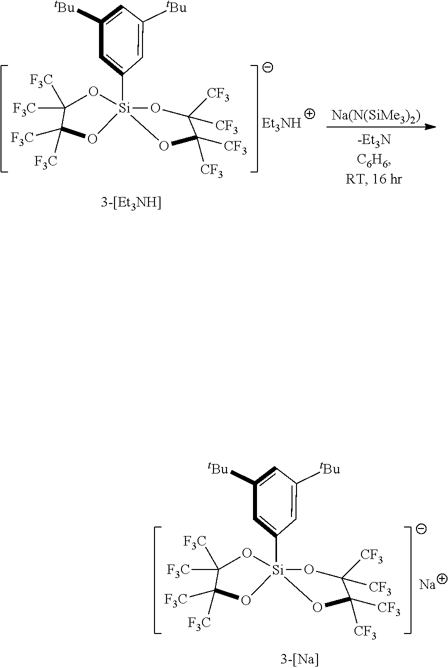

In an N₂-filled glovebox, 3-[Et₃NH](1 g, 1.016 mmol, 1 equiv) was suspended in C₆H₆ (30 mL) and Na(N(SiMe₃)₂ (243.3 mg, 1.22 mmol, 1.2 equiv) was added as a solid. The solution was stirred for 16 hr at RT before collecting the product by filtration. The solid was further washed with additional C₆H₆ and dried under vacuum. The product was isolated as a white solid (0.890 g, 97%).

Note: The alkali cation readily coordinates trace ethereal solvents (THF, Et₂O), so all compounds must be handled appropriately to avoid unwanted solvent coordination.

3-[K] can be prepared analogously using KHMDS (0.895 g, 95%). [Na][^{tBu2Ar}Si^{F}₂₄]/3—[Na]

¹H (CD₃CN, 400 MHz): 7.77 (d, 2H, Ar—H), 7.38 (t, 1H, Ar—H), 1.28 (s, 18H, C(CH₃)₃).

¹⁹F (CD₃CN, 376 MHz): −69.26 (app m, 12 F, CF₃), −69.83 (app m, 12 F, CF₃).

¹³C{¹H}(CD₃CN, 101 MHz): 148.81 (s, Ar—C), 137.86 (s, Ar—C), 132.56 (s, Ar—C), 123.11 (s, Ar—C), 123.11 (q app m, CF₃), 84.36 (br s, OC(CF₃)₂), 35.31 (s, C(CH₃)₃), 31.79 (s, C(CH₃)₃).

²⁹Si (CD₃CN, 80 MHz): −88.82 (s, indirectly detected by ¹H-²⁹Si HMBC).

Anal. Calcd. For C₂₆H₂₁ F₂₄NaO₄Si (%): C, 34.53; H, 2.34. Found: C, 35.55; H, 2.31. [K][^{tBu2Ar}Si^{F}₂₄]/3—[K]

¹H (CD₃CN, 400 MHz): 7.77 (d, 2H, Ar—H), 7.38 (t, 1H, Ar—H), 1.28 (s, 18H, C(CH₃)₃).

¹⁹F (CD₃CN, 376 MHz): −69.25 (app m, 12 F, CF₃), −69.83 (app m, 12 F, CF₃).

¹³C{¹H}(CD₃CN, 101 MHz): 148.81 (s, Ar—C), 137.86 (s, Ar—C), 132.57 (s, Ar—C), 123.12 (s, Ar—C), 123.12 (q app m, CF₃), 84.36 (br s, OC(CF₃)₂), 35.31 (s, C(CH₃)₃), 31.79 (s, C(CH₃)₃).

²⁹Si (CD₃CN, 80 MHz): −88.82 (s).

Anal. Calcd. For C₂₆H₂₁ F₂₄KO4Si (%): C, 33.92; H, 2.30. Found: C, 33.90; H, 2.31.

Synthesis of [Bu₄N][^{Me}Si^{F}₂₄]/1-[Bu₄N]

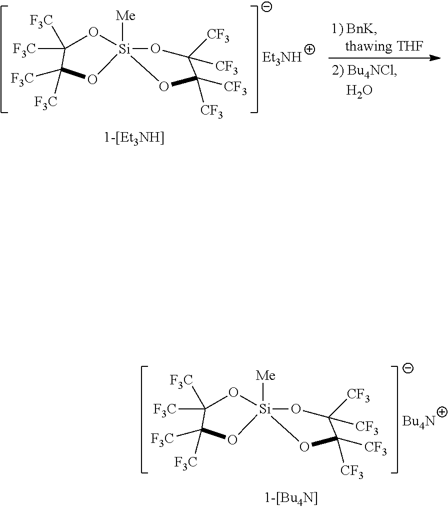

In an N₂-filled glovebox, 1-[Et₃NH](6.14 g, 7.60 mmol) and BnK (1.19 g, 9.14 mmol) were combined in a 250 mL Schlenk tube with a Teflon stir bar. The Schlenk tube was cycled onto a high vacuum line manifold, and ca. 60 mL of THF from a Na/benzophenone pot was condensed directly onto the solid reactants at −196° C. The Schlenk tube was allowed to thaw and stirring was initiated. After the reaction mixture warmed up to room temperature, the mixture was dried in vacuo. [Bu₄N][CI](ca. 15 g, ˜54 mmol) was dissolved in ca. 200 mL of H₂O and poured into the Schlenk tube on the bench. The suspension was stirred under air for 16 hours and the solids were collected on a medium porosity sintered glass frit. The solids were washed with ca. 2 L of H₂O and dried over CaSO₄ under high vacuum for 16 hours. The resulting off-white solids were redissolved in CH₂Cl₂, filtered over a glass fiber filter paper, and layered with pentane. The resulting microcrystalline solids were collected on a medium porosity sintered glass frit and washed with 50 mL of pentane. The solids were once again dried under high vacuum for 16 hours to yield analytically pure 1-[Bu₄N](4.3 g, 60%).

¹H (CD₃CN, 400 MHz): 3.07 (m, 8H, NCH₂CH₂CH₂CH₃), 1.60 (m, 8H, NCH₂CH₂CH₂CH₃), 1.35 (m, 8H, NCH₂CH₂CH₂CH₃), 0.97 (t, 12H, NCH₂CH₂CH₂CH₃), 0.19 (s, 3H, SiCH₃)

¹⁹F (CD₃CN, 376 MHz): −69.79 (overlapping app br s, 12 F, —CF₃), −69.83 (overlapping app br s, 12 F, —CF₃).

¹³C{¹H}(CD₃CN, 101 MHz): 123.7 (q app m, CF₃), 84.5 (br s, OC(CF₃)₂), 59.3 (t, NCH₂CH₂CH₂CH₃), 24.3 (s, NCH₂CH₂CH₂CH₃), 20.3 (t, NCH₂CH₂CH₂CH₃), 13.7 (s, NCH₂CH₂CH₂CH₃), 1.0 (s, SiCH₃)

²⁹Si (CD₃CN, 80 MHz): −73.8 (s)

Anal. Calcd. for C₂₉H₃₉F₂₄NO₄Si (%): C, 36.68; H, 4.14; N, 1.47. Found: C, 36.64; H, 4.08; N, 1.20.

Synthesis of [Ag][^{Me}Si^{F}₂4]/1—[Ag]

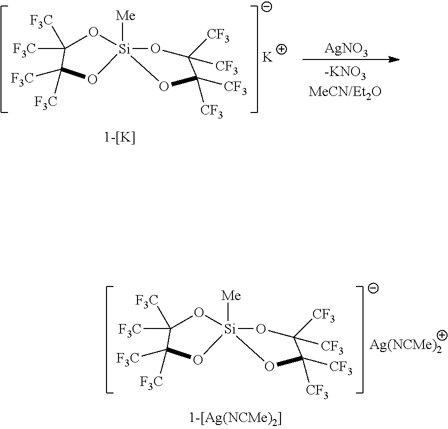

In an N₂-filled glovebox, 1-[K](2.0 g, 2.8 mmol) was dissolved in ca. 10 mL of MeCN. With vigorous stirring, a solution of AgNO₃ (514 mg, 3.0 mmol) in ca. 10 mL of MeCN was added dropwise, precipitating a white solid. Upon complete addition, the suspension was stirred for 10 minutes and Et₂O (ca. 40 mL) was added to further precipitate KNO₃. The suspension was filtered over a thick pad of celite and dried in vacuo. The white residue was extracted into minimal o-DFB (ca. 20 mL on this scale) and diffused with pentane to yield 1-[Ag(NCMe)₂] as large, colorless plates (1.7 g, 66

¹H (CD₂Cl₂, 400 MHz): 2.20 (s, 6H, Ag(NCCH₃)₂, 0.25 (s, 3H, SiCH₃)

¹⁹F (CD₂Cl₂, 376 MHz): −69.38 (m, 12 F, CF₃), −69.53 (m, 12 F, CF₃)

¹³C{¹H}(CD₂Cl₂, 101 MHz): 122.19 (q app m, CF₃), 119.37 (s, Ag(NCCH₃)₂), 83.88 (s, OC(CF₃)₂), 2.24 (s, Ag(NCCH₃)₂), 0.71 (s, SiCH₃).

²⁹Si (CD₂Cl₂, 80 MHz): −73.61 (s)

Despite extensive drying in vacuo, ca. 1 equivalent of cocrystallized MeCN remained in the sample. Calculated elemental analysis (vide infra) was reported for [Ag(NCMe)₃][^{Me}Si^{F}₂₄], although only two MeCN molecules were coordinated to Ag in the crystal structure.

Anal. Calcd. for C₁₉H₁₂AgF₂₄N₃₀₄Si (%): C, 24.32; H, 1.29; N, 4.48; Found: C, 24.14; H, 1.32; N, 4.65.

Synthesis of [Ph₃C][^{tBu2Ar}Si^{F}₂₄]/3-[Ph₃C]

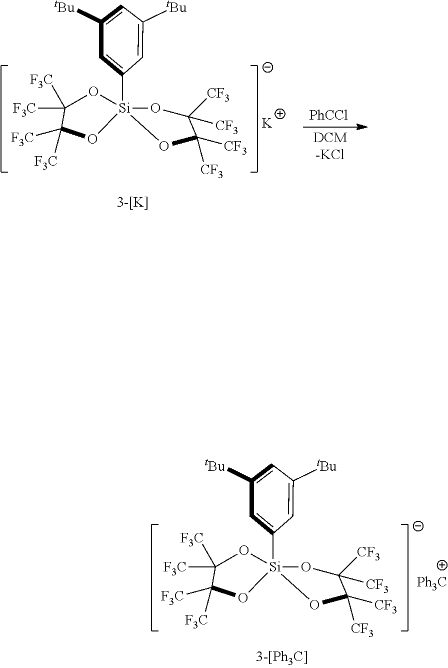

In an N₂-filled glovebox, 3-[K](400 mg, 0.434 mmol, 1 equiv) and Ph₃CCl (157.5 mg, 1.26 mmol, 2.9 equiv) were transferred to a 100 mL round bottom flask connected to a swivel frit. Note: 3-[K] must not have coordinated Et₂O or THF. The glassware was cycled onto a high vacuum line, and anhydrous DCM (10 mL) was vacuum transferred onto the reactants at −196° C. The reaction was warmed to RT and stirred for 16 hr.

Upon completion, the mixture was filtered to remove KCl; the product was extracted 3× with DCM. Volatiles were removed in vacuo, and the product was washed thoroughly with pentane. The product was dried and transferred to a glovebox. Recrystallization from layered DCM and pentane afforded a dark orange solid. Due to the extreme sensitivity of the product (3-[Ph₃C]), a reaction yield was not obtained.

¹H (CD₂Cl₂, 400 MHz): 8.29 (t, 3H, Ar—H), 7.90 (t, 6H, Ar—H), 7.78 (d, 2H, ^{t}Bu₂Ar—H), 7.67 (d, 6H, Ar—H), 7.30 (t, 1H, ^{t}Bu₂Ar—H), 1.27 (s, 18H, C(CH₃)₃).

¹⁹F (CD₂Cl₂, 376 MHz): −68.83 (m, 12 F, CF₃), −69.63 (m, 12 F, CF₃)

¹³C{¹H}(CD₂Cl₂, 101 MHz): 211.20 (s, Ph₃C+), 147.88 (s, ^{t}Bu₂Ar—C), 144.11 (s, Ph-C), 143.05 (s, Ph-C), 140.29 (s, Ph-C), 137.38 (^{t}Bu₂Ar—C), 132.10 (s, ^{t}Bu₂Ar—C), 131.11 (s, Ph-C), 128.23 (s, ^{t}Bu₂Ar—C), 122.42 (q app m, CF₃), 121.87 (^{t}Bu₂Ar—C), 83.30 (s, OC(CF₃)₂), 34.95 (s, C(CH₃)₃), 31.65 (C(CH₃)₃).

²⁹Si (CD₂Cl₂, 80 MHz): −88.59 (s) Anal. Calcd. for C₄₅H₃₆F₂₄₀₄Si (%): C, 48.05; H, 3.23. Found: C: 47.97; H, 2.92.

Synthesis of [Fc][^{Me}Si^{F}₂₄]/1-[Fc]

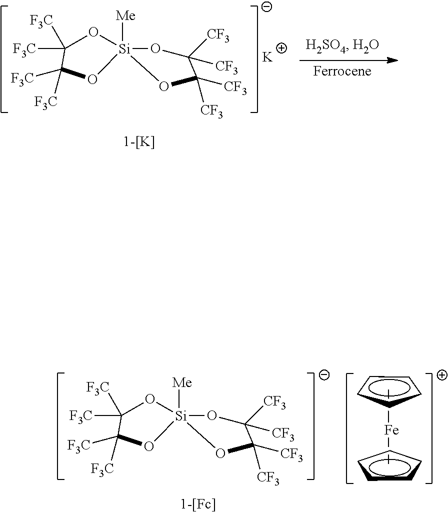

Ferrocene (1.84 g, 9.9 mmol) was dissolved in 37.5 mL of concentrated H₂SO₄ and stirred for 2 hours. The deep blue solution was poured into 180 mL of water and then filtered to remove precipitated sulfur. The filtrate was transferred to a round bottom flask charged with a stir bar and sparged with N₂ for 30 minutes. [K][^{Me}Si^{F}₂₄](2.4 g, 3.3 mmol) was added against an N₂ counterflow, and the round bottom flask was sealed with a 24/40 ground glass stopper and left to stir for 24 hours. The blue precipitate was collected over a medium porosity frit and washed with water (2×20 mL) until the filtrate ran clear. The dark blue solids were dried under high vacuum for 16 hours and then recrystallized twice with THF/Et₂O vapor diffusion in an N₂-filled glovebox (473 mg, 16%). The lower yield is presumably caused by repeated recrystallization from THF/Et₂O vapor diffusion.

¹H (CD₃CN, 400 MHz): 32.8 (vbr s, 10H, (C₅H₅)₂Fe), 0.14 (s, 3H, SiCH₃)

¹⁹F (CD₃CN, 376 MHz): −69.5, −69.9 (overlapping vbr s, 24 F)

²⁹Si (CD₃CN, 80 MHz): −73.99 (s) Anal. Calcd. for C₂₃H₁₃F₂₄FeO₄Si (%): C, 30.93; H, 1.47; Found: C, 30.89; H, 1.29.

Synthesis of [Ni(COD)₂][MeSi^{F}₂₄]/1—[Ni(COD)₂]

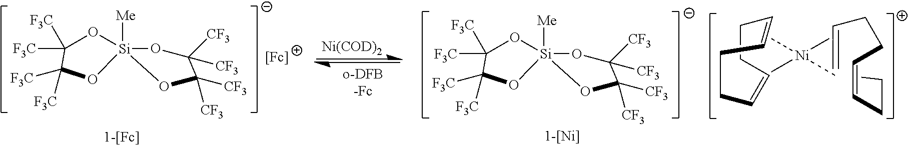

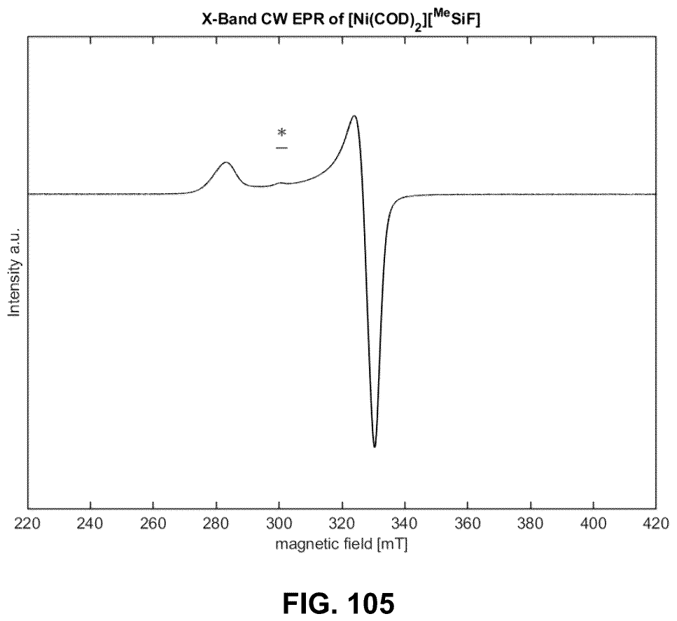

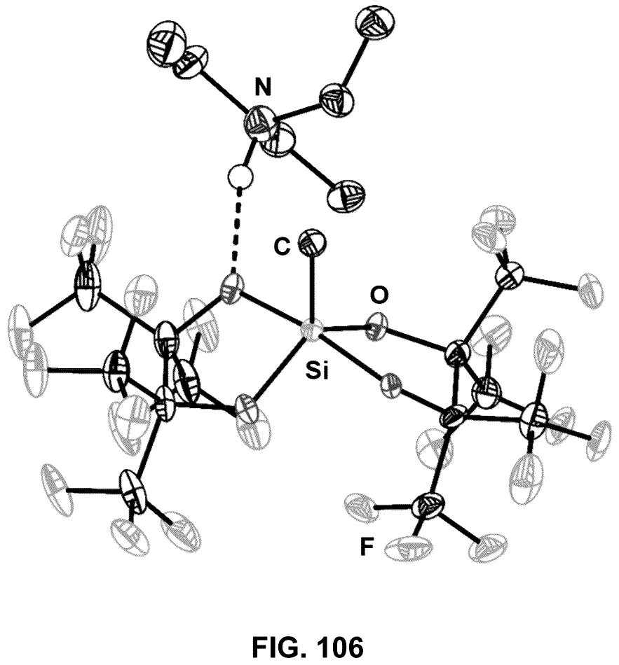

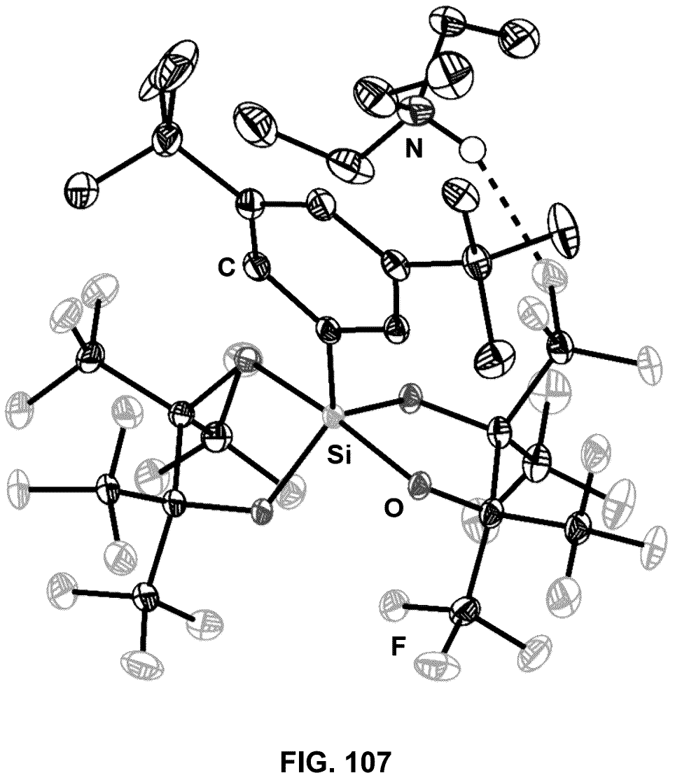

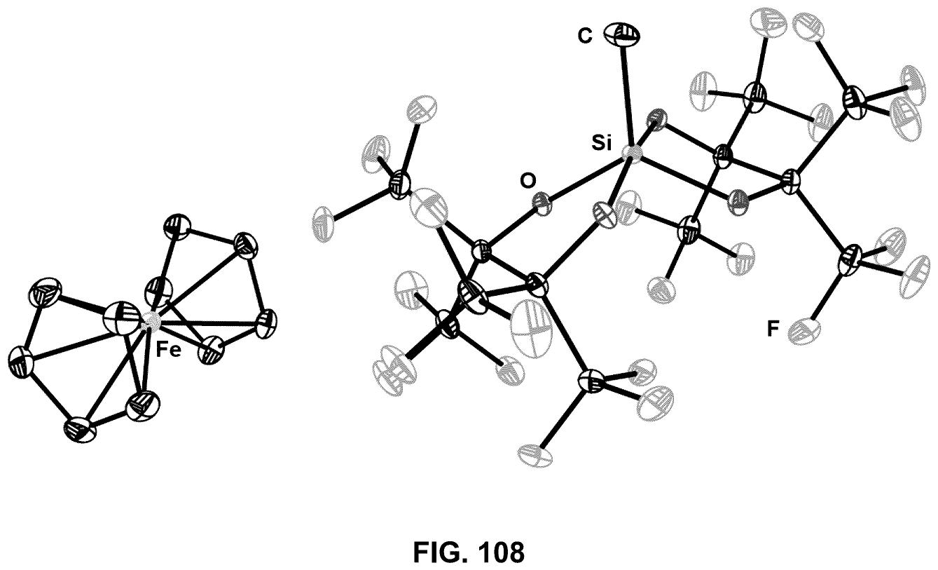

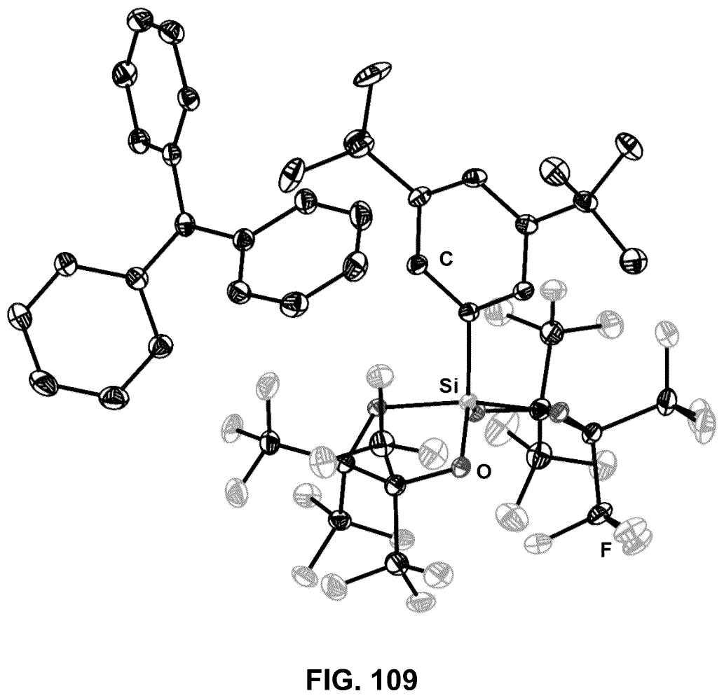

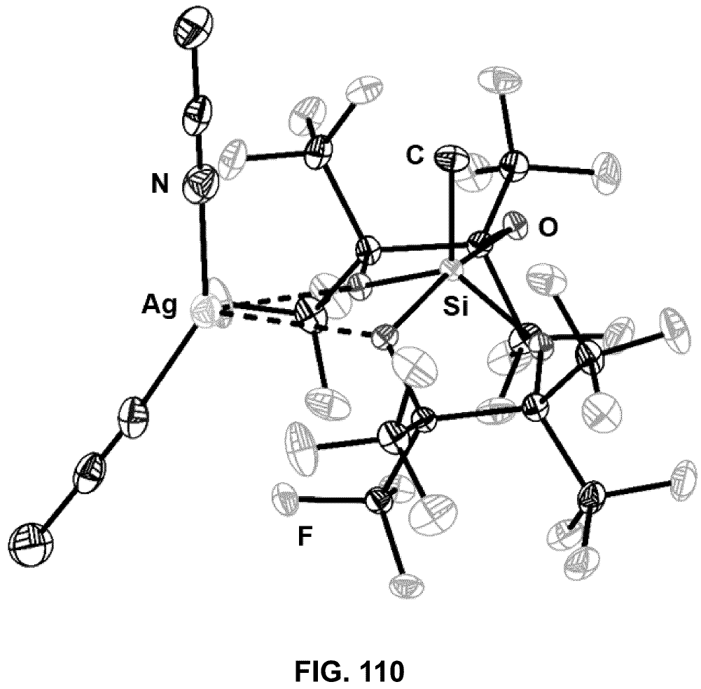

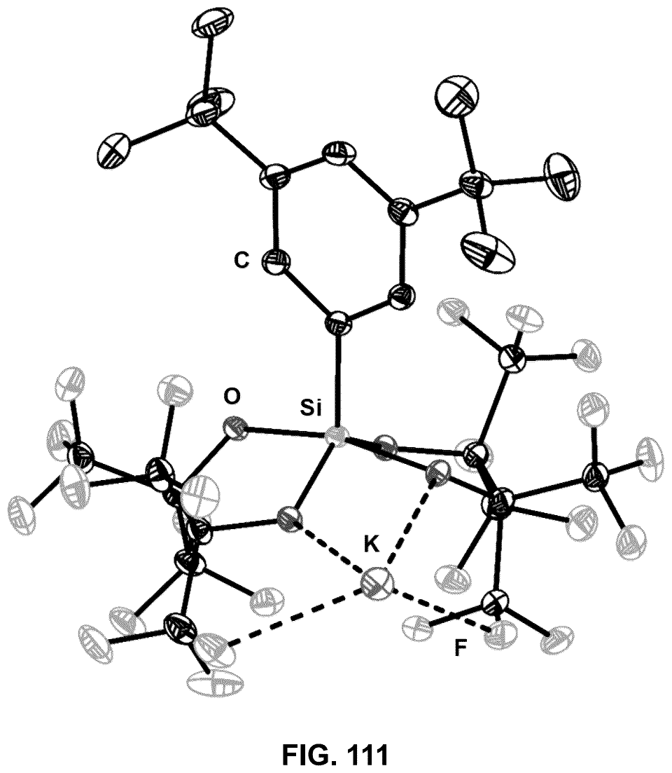

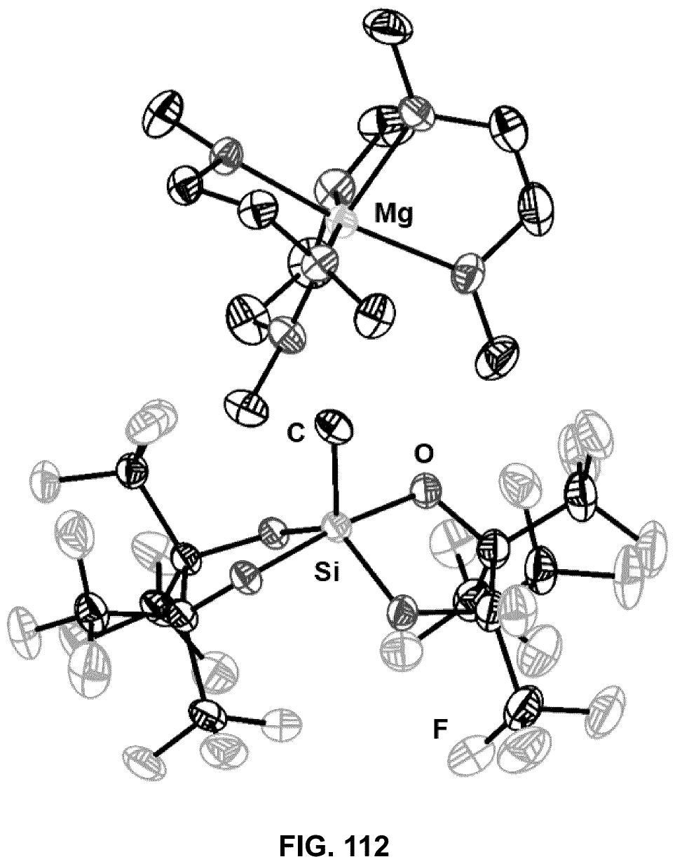

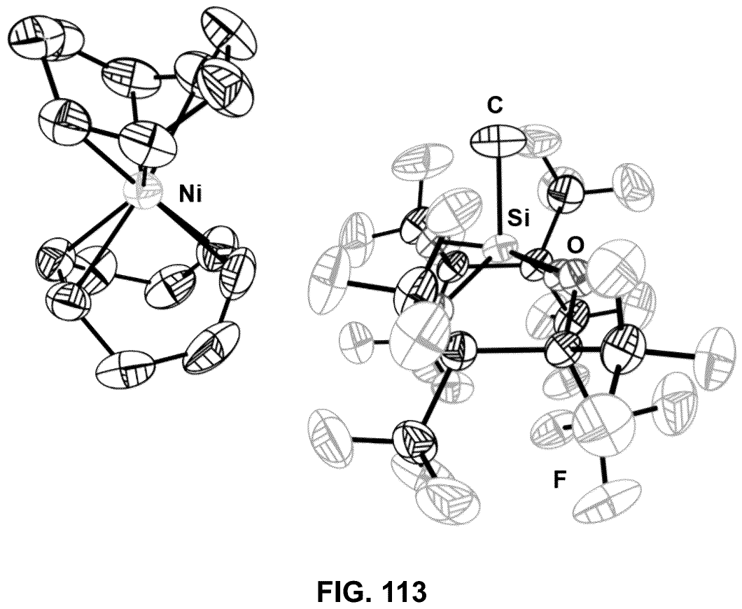

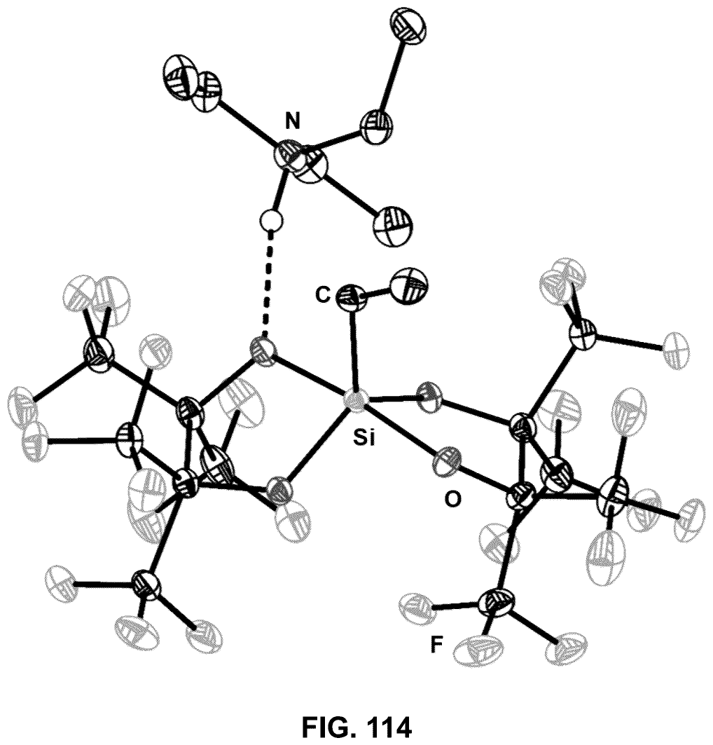

To a rapidly stirring suspension of Ni(COD)₂ (29.2 mg, 0.11 mmol) in 4 mL of o-DFB, [Fc][^{Me}Si^{F}₂₄]/1-[Fc](94.8 mg, 0.11 mmol) was added as a solid in one portion, affording a light yellow suspension, which darkened to a persistent green after stirring for 16 hours at RT. The suspension was filtered and diffused with pentane, affording a mixture of orange/yellow crystals and blue crystals (unreacted [Fc][^{Me}Si^{F}₂₄]/1-[Fc]). The orange/yellow crystals were crystallographically identified as [Ni(COD)₂][^{Me}Si^{F}₂₄]/1—[Ni(COD)₂]. EPR characterization of the mixture of crystals at 77 K revealed signals consistent with [Ni(COD)₂]⁺ being the only paramagnetic Ni^{I} species (FIG. 105) with the [Fc]⁺ cation being effectively EPR-silent at 77 K due to its fast relaxation properties.

Synthesis of [Pd(dppe)(NCMe)Me][^{tBu2Ar}Si^{F}_{24]/3}—[Pd(dppe)(NCMe)Me]

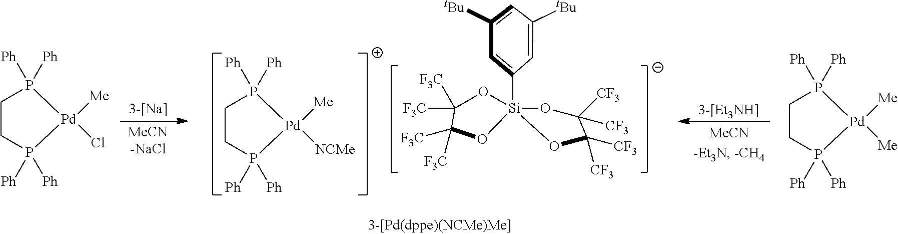

Procedure beginning from Pd(dppe)MeCl

In an N₂-filled glovebox, Pd(dppe)MeCl (40 mg, 0.075 mmol, 1.0 equiv) was dissolved in CH₂Cl₂ (5 mL), followed by the addition of 3-[Na](68 mg, 0.075 mmol, 1.0 equiv) and MeCN (1 mL). The reaction was stirred for 16 hr at RT, followed by concentration in vacuo. The product was extracted with CH₂Cl₂ and filtered. Removal of solvent afforded the product as a yellow solid. NMR characterization is consistent with previously reported [Pd(dppe)(NCMe)Me][BAr^{F}₂₄]. (54 mg, 50%)¹H (CD₃CN, 400 MHz): 7.74 (d, 2H, Ar—H, ^{Ar}Si^{F}₂₄), 7.69-7.47 (multiple peaks overlapping, 20H, Ar—H, dppe), 7.35 (t, 1H, Ar—H, ^{Ar}Si^{F}₂₄), 2.61 (m, 2H, Ph₂PCH₂CH₂PPh₂), 2.30 (m, 2H, Ph₂PCH₂CH₂PPh₂), 1.25 (s, 18H, C(CH₃)₃, ^{Ar}Si^{F}₂₄), 0.59 (dd, 3H, PdCH₃). ¹⁹F (CD₃CN, 376 MHz): −69.2 (app. m, 12 F, CF₃), −69.8 (app. m, 12 F, CF₃). ³¹p{¹H}NMR (CD₃CN, 162 MHz): 60.97 (d), 39.23 (br. d).

Procedure beginning from Pd(dppe)Me₂

In an N₂-filled glovebox, Pd(dppe)Me₂ (40 mg, 0.075 mmol, 1.0 equiv) was suspended in MeCN (5 mL), followed by the addition of 3-[Et₃NH](74 mg, 0.075 mmol, 1.0 equiv). During the course of the reaction, the reaction became homogeneous. The reaction was stirred for 16 hr at RT, followed by concentration in vacuo, and the mixture was triturated 3× with MeCN. The product was extracted with MeCN and filtered. Removal of solvent afforded the product as a yellow solid. NMR characterization is consistent with previously reported [Pd(dppe)(NCMe)Me][BAr^{F}₂₄]. (62 mg, 57%). NMR characterization is identical to material prepared from Pd(dppe)MeCl and 3-[Na](discussed above)

### Polymerization Trials

In a N₂ glovebox, Pd catalyst (10 μmol) was dissolved in toluene (10 mL) was transferred to a Fisher-Porter vessel. The reactor was removed from the glovebox and connected to a C₂H₄/CO gas feed. The N₂ atmosphere was replaced with a 1:1 mixture of C₂H₄/CO (flow rate 300 sccm for each gas) by pressurizing the vessel to 100 psi and venting 3×. After pressurizing to 100 psi, polymerization was run for 3 hr at RT. The reaction was quenched upon exposure to air, and the polymer was precipitated by stirring with acidic methanol (0.6 mL HCl/10 mL MeOH). The polymer was collected and dried under vacuum overnight.

NMRs were recorded in a mixture of 1, 1, 1, 3, 3, 3-hexafluoro-2-propanol and C₆D₆ (4:1) at RT.

Polymer yield and activity are shown in Table 2, below.

TABLE 2

| | Polymer | Activity |
|---|---|---|
| Catalyst | Yield | (g mol⁻¹ hr⁻¹) |
| [Pd(dppe)(NCMe)Me]⁺[BAr^{F}₂₄]⁻ | 68.6 | 2.28 |
| [Pd(dppe)(NCMe)Me]⁺[^{tBu2Ar}Si^{F}₂₄] | 50.2 | 1.67 |
| [Pd(dppe)(NCMe)Me]⁺[^{Me}Si^{F}₂₄] | 31.9 | 1.06 |

### Procedure for Determining Solubility

3-[Na], 3-[K], and 1-[K](˜50 mg each) were suspended in C₆D₆ and stirred vigorously for 16 hr. Each sample was filtered, and 600 μL was transferred to a new vial. Fluorobenzene (5 μL) was added as an internal standard to the filtered solution and mixed thoroughly via pipette. Concentration was determined by ¹⁹F NMR by integrating the fluorobenzene peak (1 F) at −112.9 ppm (in benzene) or −114.0 ppm (in dichloromethane) vs. the silicate (24 F) at −68-70 ppm.

### Special Considerations for Mg Deposition/Stripping Electrochemistry

### Statement of Reproducibility

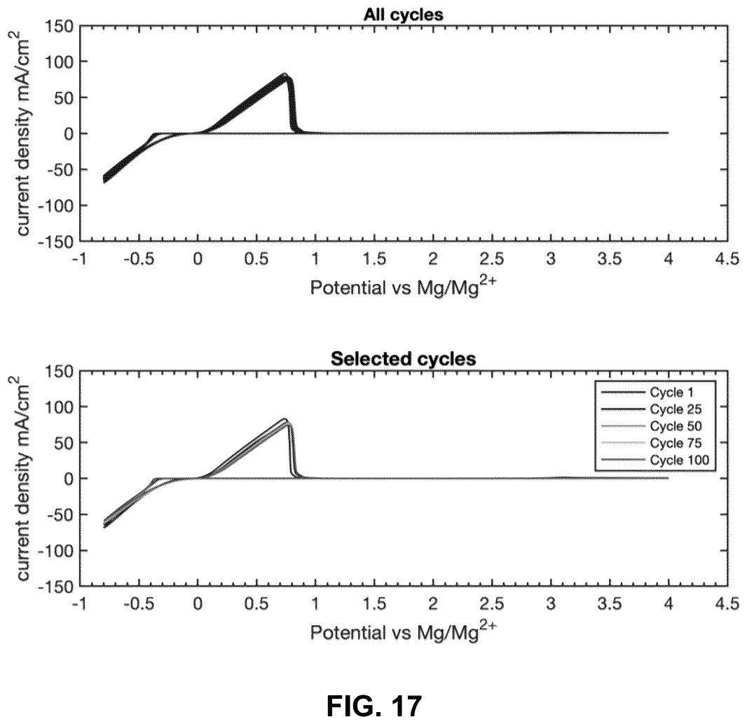

All electrochemistry data pertaining to Mg deposition/stripping data presented in this manuscript have been reproduced at least thrice across multiple batches of 1-[Mg(DME)₃]. While Mg deposition/stripping supported by 1-[Mg(DME)₃] have been observed in all instances in the presence of 10 mM Me₂Mg, different shapes of Mg deposition/stripping have been observed (FIGS. 17-19).

### Factors Affecting Shapes of Mg Deposition/Stripping Curves

The shape of Mg deposition/stripping curve was found to be impacted by the quality of glovebox atmosphere, Pt wire WE, and solvent purity. While the effects of such conditions were difficult to deconvolute, slight variations of these conditions had a pronounced impact on the quality of Mg deposition/stripping. The following section briefly discusses the variations in Mg deposition/stripping observed throughout the course of this study in the contexts of these conditions. For consistent Mg deposition/stripping performance, experiments were run in a glovebox that is solely dedicated to electrochemical experiments. No solvent or chemical is stored in the glovebox.

### Most Stable Mg Deposition/Stripping

While chemical indicators (titanocene indicator and ZnEt₂) have failed to detect the differences in the quality of glovebox atmosphere before and after a purifier was placed in the glovebox, the most stable Mg deposition/stripping curves (FIG. 17) were only achieved after a glovebox purifier had been in place for a minimum of 4 weeks.

### Typical Mg Deposition/Stripping

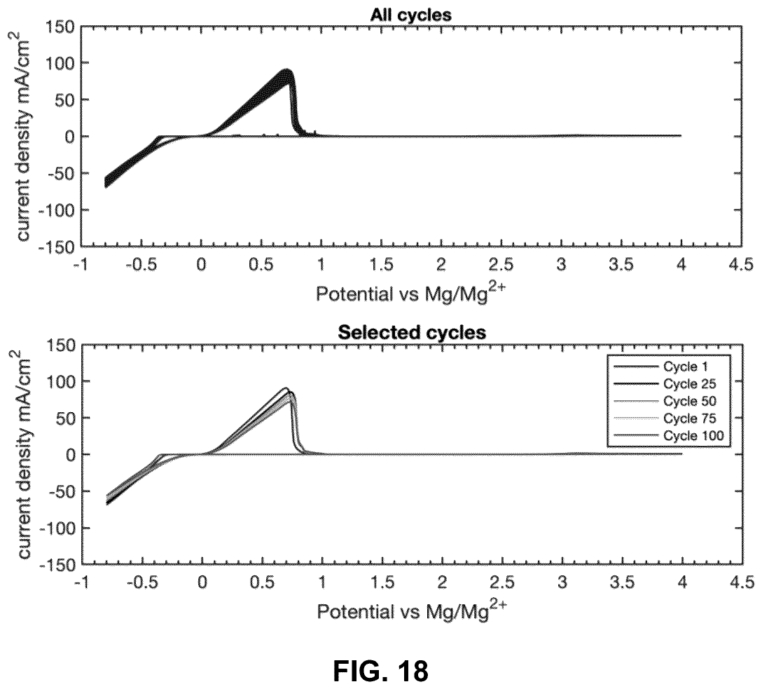

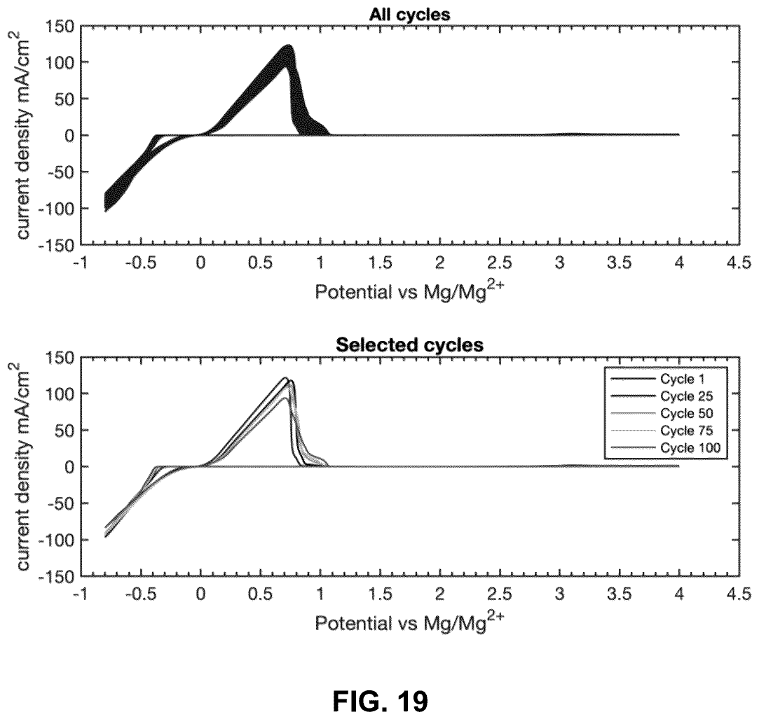

Depending on the quality of the Pt wire, quality of the glovebox atmosphere, and DME purity, not all CV experiments were as stable as the one shown in FIGS. 14A-14D in the main text and FIG. 17. Prolonged drying of DME (>3 months) over sodium benzophenone ketyl typically results in decomposition of DME into NaOMe and methyl vinyl ether (CH₃₀CH═CH₂), which, in conjunction with other factors, results in highly unstable Mg deposition/stripping. Reversible Mg deposition/stripping was consistently observed with DME that is free of methyl vinyl ether. However, different Pt wires gave slightly different shapes of deposition/stripping (FIGS. 18-19).

### Mg Deposition/Stripping at 0 mM Me₂Mg

While the incorporation of 10 mM Me₂Mg consistently resulted in reversible Mg deposition/stripping, Me₂Mg was not required for reversible Mg deposition/stripping. A CV experiment of 0.26 M 1-[Mg(DME)₃] is shown in FIG. 20. In the absence of Me₂Mg, a high initial reductive overpotential was observed. The reductive overpotential decreased over continuous cycling and stabilized at ca. 400 mV; the coulombic efficiency (FIG. 22) increased with cycling and stabilized at ca. 96% (−0.8 to 2.0 V vs. Mg/Mg²⁺). It should be noted that Mg deposition/stripping in the absence of Me₂Mg was found to be exceedingly moisture sensitive: if the experiment was set up in a glovebox that has not yet been rigorously dried, Mg deposition/stripping was not observed.

Coulombic Efficiencies for 0.26 M 1-[Mg(DME)₃] with 10 mM MgMe₂ and 0 mM MgMe₂
Determination of Trigonal Bipyramidal Vs. Square Pyramidal Geometry

As representative examples, bond angles for 1-[Et₃NH] and 3-[Et₃NH] were examined to determine geometry.

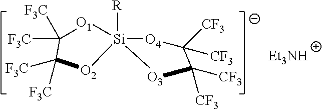

An index parameter was developed to calculate the distorted geometry, where τ=0 for perfectly square pyramidal and τ=1 for perfectly trigonal bipyramidal.³

$$τ = \frac{( β - α )}{60}$$

For the disclosed complexes, β is the O₁—Si—O₃ angle and α is the O₂—Si—O₄, O₂—Si—R, O₄—Si—R angles. For both 1-[Et₃NH] and 3-[Et₃NH], the geometry is trigonal bipyramidal, as shown in Table 3, below.

TABLE 3
[Et₃NH][^{Me}Si^{F}₂₄]/1 − [Et₃NH]

| | | |
|---|---|---|
| O₁—Si—O₃ | 171.00(7) | τ = 0.83-0.88 |
| O₂—Si—O₄ | 120.90(7) | |
| O₂—Si—R | 118.07(9) | |
| O₄—Si—R | 121.03(8) | |

[Et₃NH][^{tBu2Ar}Si^{F}₂₄]/3 − [Et₃NH]

| | | |
|---|---|---|
| O₁—Si—O₃ | 171.06(9) | τ = 0.84-0.86 |
| O₂—Si—O₄ | 120.13(9) | |
| O₂—Si—R | 120.4(1) | |
| O₄—Si—R | 119.5(1) | |

### NMR Spectra

### EPR Spectrum of 1-[Ni(COD)₂]

### Crystallography Refinement Details

Refinement Details-In each case, crystals were mounted on a glass fiber or MiTeGen loop using Paratone oil, then placed on the diffractometer under a nitrogen stream. Low temperature (100 K or 200 K) X-ray data were obtained on a Bruker KAPPA APEXII CCD based diffractometer (Mo fine-focus sealed X-ray tube, K_{α}=0.71073 Å) or a Bruker D8 VENTURE Kappa Duo PHOTON 100 CMOS based diffractometer (Mo I_{μ} S HB micro-focus sealed X-ray tube, K_{α}=0.71073 Å). All diffractometer manipulations, including data collection, integration, and scaling were carried out using the Bruker APEXIII software.⁵ Absorption corrections were applied using SADABS.⁶ Space groups were determined on the basis of systematic absences and intensity statistics and the structures were solved in the Olex 2 software interface by intrinsic phasing using XT (incorporated into SHELXTL) and refined by full-matrix least squares on F².^{7,8} All non-hydrogen atoms were refined using anisotropic displacement parameters. Hydrogen atoms were placed in the idealized positions and refined using a riding model, unless noted otherwise. The structure was refined (weighed least squares refinement on F²) to convergence. Graphical representation of structures with 50% probability thermal ellipsoids were generated using the Diamond3 visualization software.

### Special Refinement Details

For compound 1-[Mg(DME)₃], solvent mask (the implementation of SQUEEZE in Olex2)⁹ was employed to remove residual electron densities of two heavily disordered, co-crystallized DME molecules.

TABLE 5
Crystal and refinement data for crystal structures reported herein

| | [Et₃NH][^{Me}Si^{F}₂₄] | [Mg(DME)₃][^{Me}Si^{F}₂₄]₂ | [Ag(NCMe)₂][^{Me}Si^{F}₂₄] | [Fc][^{Me}Si^{F}₂₄] |
|---|---|---|---|---|
| CCDC Deposition | 2388676 | 2388680 | 2388674 | 2388675 |
| Number | | | | |
| Empirical formula | C₁₃H₁₉F₂₄O₄SiC₆N | C₃₈H₃₆F₄₈MgO₁₄Si₂ | C₁₇H₉AgF₂₄N₂O₄Si | C₂₃H₁₃F₂₄FeO₄Si |
| Formula weight | 809.44 | 1709.16 | 897.22 | 893.27 |
| T (K) | 100 | 100 | 100 | 100 |
| a, Å | 12.3379(7) | 19.1669(9) | 11.7181(4) | 11.9513(5) |
| b, Å | 19.0038(10) | 18.4147(8) | 16.6099(5) | 12.8461(5) |
| c, Å | 12.1078(11) | 20.7628(9) | 28.4743(9) | 18.9755(7) |
| α, ° | 90 | 90 | 90 | 90 |
| β, ° | 99.494(2) | 102.095(2) | 90 | 98.713(2) |
| γ, ° | 90 | 90 | 90 | 90 |
| Volume, Å³ | 2800.0(3) | 7165.6(6) | 5542.1(3) | 2879.6(2) |
| Z | 4 | 4 | 8 | 4 |
| Crystal system | Monoclinic | Monoclinic | Orthorhombic | Monoclinic |
| Space group | Cc | P2₁/n | Pbca | P2₁/n |
| d_{calc}, g/cm³ | 1.920 | 1.584 | 2.151 | 2.060 |
| θ range, ° | 1.987 to 35.668 | 2.854 to 72.424 | 3.104 to 72.424 | 1.921 to 31.366 |
| μ, mm⁻¹ | 0.275 | 2.185 | 8.115 | 0.755 |
| Abs. Correction | Multi-scan | Multi-scan | Multi-scan | Multi-scan |
| GOF | 1.051 | 1.047 | 1.158 | 1.046 |
| R₁,^{a} wR₂^{b} | 0.0494, 0.1271 | 0.0436, 0.1110 | 0.0319, 0.0759 | 0.0288, 0.0690 |
| [I > 2 σ(I)] | | | | |
| Radiation Type | Mo K_{α} | Cu K_{α} | Cu K_{α} | Mo K_{α} |

^{a}R₁ = Σ||Fₒ] − |F_{c}||/Σ|Fₒ|.
^{b}wR₂= [Σ[w(Fₒ² − F_{c}²)²]/Σ[w(Fₒ²)²]^{1/2}.

TABLE 5
Crystal and refinement data for crystal structures reported herein (continued)

| | [Ni(COD)₂][^{Me}Si^{F}₂₄] | [Et₃NH][^{tBu2Ar}Si^{F}₂₄] | [K][^{tBu2Ar}Si^{F}₂₄] | [Et₃NH][^{Vinyl}Si^{F}₂₄] |
|---|---|---|---|---|
| CCDC Deposition | 2388672 | 2388677 | 2388679 | 2388678 |
| Number | | | | |
| Empirical formula | C₂₉H₂₇F₂₄NiO₄Si | C₃₂H₃₇F₂₄NO₄Si | C₆₁H₅₀F₄₈K₂O₈Si₂ | C₂₀H₁₉F₂₄NO₄Si |
| Formula weight | 982.30 | 983.70 | 1957.39 | 821.45 |
| T (K) | 100 | 100 | 100 | 100 |
| a, Å | 11.168(2) | 27.756(3) | 12.5486(8) | 12.2552(10) |
| b, Å | 11.407(2) | 19.1647(17) | 14.7156(12) | 18.553(2) |
| c, Å | 14.752(3) | 19.0790(17) | 22.537(2) | 12.8226(15) |
| α, ° | 80.856(7) | 90 | 74.584(6) | 90 |
| β, ° | 85.111(7) | 130.208(2) | 87.270(4) | 95.263(7) |
| γ, ° | 71.273(7) | 90 | 68.875(4) | 90 |
| Volume, Å³ | 1755.9(6) | 7750.7(12) | 3736.9(6) | 2903.2(5) |
| Z | 2 | 8 | 4 | 4 |
| Crystal system | Triclinic | Monoclinic | Triclinic | Monoclinic |
| Space group | P1̅ | C2/c | P1̅ | P2₁/n |
| d_{calc}, g/cm³ | 1.858 | 1.686 | 1.945 | 1.879 |
| θ range, ° | 3.036 to 72.977 | 3.109 to 67.679 | 2.036 to 74.686 | 4.203 to 72.135 |
| μ, mm⁻¹ | 2.679 | 1.983 | 13.486 | 2.497 |
| Abs. Correction | Multi-scan | Multi-scan | Multi-scan | Multi-scan |
| GOF | 1.030 | 1.082 | 0.913 | 0.958 |
| R₁,^{a} wR₂^{b} | 0.0549, 0.1566 | 0.0521, 0.1493 | 0.0361, 0.1087 | 0.0325, 0.1093 |
| [I > 2 σ(I)] | | | | |
| Radiation Type | Cu K_{α} | Cu K_{α} | Cu K_{α} | Cu K_{α} |

| | [Ph₃C][^{tBu2Ar}Si^{F}₂₄] |
|---|---|
| CCDC Deposit Number | 2388673 |
| Empirical formula | C₄₅H₃₆F₂₄O₄Si |
| Formula weight | 1124.83 |
| T (K) | 100 |
| a, Å | 12.0592(9) |
| b, Å | 12.4407(10) |
| c, Å | 16.2264(11) |
| α, ° | 89.738(7) |
| β, ° | 88.738(7) |
| γ, ° | 78.830(6) |
| Volume, Å³ | 2387.6(3) |
| Z | 2 |
| Crystal system | Triclinic |
| Space group | P1̅ |
| d_{calc}, g/cm³ | 1.565 |
| θ range, ° | 2.724 to 72.156 |
| μ, mm⁻¹ | 1.693 |
| Abs. Correction | Multi-scan |
| GOF | 1.037 |
| R₁,^{a} wR₂^{b} | 0.0287, 0.0719 |
| [I > 2 σ(I)] | |
| Radiation Type | Cu K_{α} |

1. Pangborn, A. B.; Giardello, M. A.; Grubbs, R. H.; Rosen, R. K.; Timmers, F. J., Safe and Convenient Procedure for Solvent Purification. Organometallics 1996, 15 (5), 1518-1520. http://dx.doi.org/10.1021/om9503712
2. Maskey, R.; Schädler, M.; Legler, C.; Greb, L., Bis(perchlorocatecholato)silane-A Neutral Silicon Lewis Super Acid. Angew. Chem. Int. Ed. 2018, 57 (6), 1717-1720. https://doi.org/10.1002/anie.201712155
3. Crans, D. C.; Tarlton, M. L.; McLauchlan, C. C., Trigonal Bipyramidal or Square Pyramidal Coordination Geometry?Investigating the Most Potent Geometry for Vanadium Phosphatase Inhibitors. Eur. J. Inorg. Chem. 2014, 2014 (27), 4450-4468. https://doi.org/10.1002/ejic.201402306
4. Schwab, M. M.; Himmel, D.; Kacprzak, S.; Kratzert, D.; Radtke, V.; Weis, P.; Ray, K.; Scheidt, E.-W.; Scherer, W.; de Bruin, B.; Weber, S.; Krossing, I., [Ni(cod)2][Al(ORF)4], a Source for Naked Nickel(I) Chemistry. Angew. Chem. Int. Ed. 2015, 54 (49), 14706-14709. https://doi.org/10.1002/anie.201506475
5. APEX3, Version 1 User Manual, M86-EXX229, Bruker Analytical X-ray Systems, Madison, WI, May 2016.
6. Sheldrick, G. M. “SADABS (version 2008/1): Program for Absorption Correction for Data from Area Detector Frames”, University of Gottingen, 2008.
7. Dolomanov, O. V.; Bourhis, L. J.; Gildea, R. J.; Howard, J. A. K.; Puschmann, H., OLEX2: a complete structure solution, refinement and analysis program. J. Appl. Cryst. 2009, 42 (2), 339-341. http://dx.doi.org/doi:10.1107/S0021889808042726
8. Sheldrick, G., A short history of SHELX. Acta Crystallogr., Sect. A: Found. Adv. 2008, 64 (1), 112-122. http://dx.doi.org/doi:10.1107/S0108767307043930
9. Spek, A., PLATON SQUEEZE: a tool for the calculation of the disordered solvent contribution to the calculated structure factors. Acta Crystallogr., Sect. C: Struct. Chem. 2015, 71 (1), 9-18. http://dx.doi.org/doi:10.1107/S2053229614024929

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX—YY” (wherein XX and YY refer to claim numbers) is intended to provide a multiple dependent claim in the alternative form, and in some embodiments is interchangeable with the expression “as in any one of claims XX—YY.”

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Certain molecules disclosed herein may contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every device, system, formulation, combination of components, or method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. An electrochemical cell comprising:
an anode;
a cathode; and
an electrolyte in contact with the anode and the cathode, the electrolyte comprising a cation and a weakly coordinating anion in a solvent, the weakly coordinating anion having the formula:
[(R¹)ₘ—Si(Z)₂]⁻ (FX1)
or salts thereof;
wherein each Z is independently: 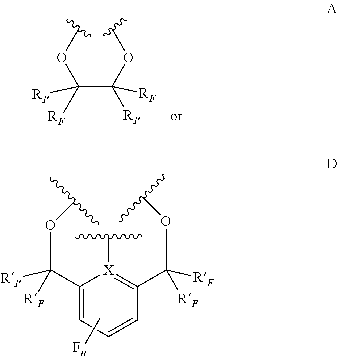
wherein:
m is 1 when both of Z are A, or m is zero;
X is C or N;
Fₙ represents one, two or three F on the indicated ring;
R_{F} is fluoroalkyl having 1-3 carbon atoms and two to seven fluorine atoms or fluorophenyl having 2-5 fluorine atoms on the ring;
R′_{F} is fluoroalkyl having 1-3 carbon atoms and two to seven fluorine atoms or fluorophenyl having 2-5 fluorine atoms on the ring;
R¹ is substituted or unsubstituted alkyl having 1-30 carbon atoms, substituted or unsubstituted alkenyl having 2-30 carbon atoms, substituted or unsubstituted cycloalkyl having 3-30 carbon atoms and at least one carbocyclic ring, substituted or unsubstituted heterocyclic having 3-30 carbon atoms, 1-4 heteroatoms and at least one heterocyclic ring, substituted or unsubstituted aryl having 1 or 2 aromatic rings which are optionally fused rings and having 5-30 carbon atoms, substituted or unsubstituted heteroaryl having 1 or 2 rings of which at least one is aromatic and which are optionally fused and having 3-30 carbon atoms and 1-4 heteroatoms, or substituted or unsubstituted alkoxyalkyl having 2-12 carbon atoms.

2. A method of performing a chemical reaction, the method comprising: providing a solution comprising a cation and a weakly coordinating anion reagent of the formula:
[(R¹)ₘ—Si(Z)₂]⁻ (FX1)
wherein each Z is independently: 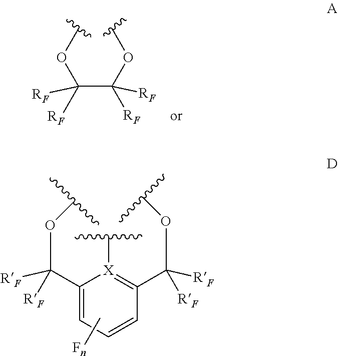
wherein:
m is 1 when both of Z are A, or m is zero;
X is C or N;
Fₙ represents one, two or three F on the indicated ring;
R_{F} is fluoroalkyl having 1-3 carbon atoms and two to seven fluorine atoms or fluorophenyl having 2-5 fluorine atoms on the ring;
R′_{F} is fluoroalkyl having 1-3 carbon atoms and two to seven fluorine atoms or fluorophenyl having 2-5 fluorine atoms on the ring;
R¹ is substituted or unsubstituted alkyl having 1-30 carbon atoms, substituted or unsubstituted alkenyl having 2-30 carbon atoms, substituted or unsubstituted cycloalkyl having 3-30 carbon atoms and at least one carbocyclic ring, substituted or unsubstituted heterocyclic having 3-30 carbon atoms, 1-4 heteroatoms and at least one heterocyclic ring, substituted or unsubstituted aryl having 1 or 2 aromatic rings which are optionally fused rings and having 5-30 carbon atoms, substituted or unsubstituted heteroaryl having 1 or 2 rings of which at least one is aromatic and which are optionally fused and having 3-30 carbon atoms and 1-4 heteroatoms, or substituted or unsubstituted alkoxyalkyl having 2-12 carbon atoms; and
contacting in the solution one or more reactants with the weakly coordinating anion reagent, and/or the cation, thereby resulting in formation of one or more products.

3. The electrochemical cell of claim 1 where R¹ is a substituted or unsubstituted C₁-C₂₀ alkyl, substituted or unsubstituted C₂-C₂₀ alkenyl, substituted or unsubstituted C₂-C₂₀ alkynyl, and substituted or unsubstituted C₄-C₂₀ aryl.

4. The electrochemical cell of claim 1, where R¹ is a substituted or unsubstituted alkyl having 1-4 carbon atoms, a substituted or unsubstituted substituted alkenyl having 2-4 carbon atoms, a substituted or unsubstituted phenyl or benzyl group, or an alkoxyalkyl group having 2-12 carbon atoms.

5. The electrochemical cell of claim 1, wherein R¹ is substituted with one or more halogens, one or more substituted or unsubstituted alkyl groups having 1-20 carbon atoms, one or more substituted or unsubstituted —OR¹ groups having 1 to 20 carbon atoms, one or more substituted or unsubstituted alkenyl groups having 1-6 carbon atoms, and/or one or more substituted or unsubstituted alkynyl groups having 1-6 carbon atoms.

6. The electrochemical cell of claim 1, wherein R¹ is fully fluorinated.

7. The electrochemical cell of claim 1, wherein R¹ is selected from the group consisting of methyl, pentafluorophenyl, CH₂CH₂(CF₂)₅CF₃, decyl, styrene, vinyl, 4-^{t}Bu-C₆H₄, CH₂CH₂CF₃,

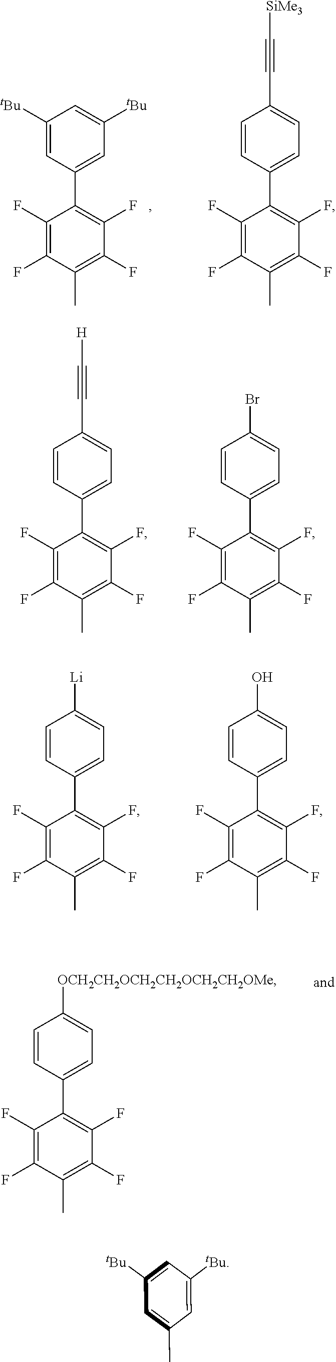

8-10. (canceled)

11. The electrochemical cell of claim 1, the weakly coordinating anion having the structure: 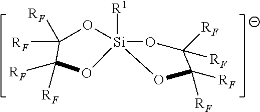
wherein R_{F} is fluoroalkyl having 1-3 carbon atoms and two to seven fluorine atoms or fluorophenyl having 2-5 fluorine atoms on the ring.

12. The electrochemical cell of claim 1, the weakly coordinating anion having the structure:

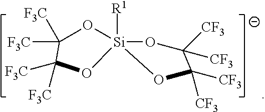

13. The electrochemical cell of claim 1, wherein the weakly coordinating anion is coordinated to a cation, wherein the cation is a group 1 metal cation, group 2 metal cation, group 13 metal cation, transition metal cation, lanthanide cation, actinide cation, organic acid cation, and/or weakly coordinating cation.

14. The electrochemical cell of claim 1, wherein the weakly coordinating anion is coordinated to a cation, wherein the cation comprises Mg²⁺, Ca²⁺, Na¹⁺, K¹⁺, Li¹⁺ Rb⁺, Cs⁺, Zn²⁺, Al³⁺, [Et₃NH]⁺, [Me₂NHPh]⁺, [Fe(C₅H₅)₂]⁺, [Ph₃C]⁺, [Bu₄N]⁺, [Ag(NCMe)₂]⁺, [Mg(DME)₃]⁺, [Ni(COD)₂]⁺, and/or [Fe(C₅H₅)₂]⁺, wherein H may in each case be substituted for any alkyl, alkenyl, alkynyl, aryl, heteroatom, and non-H functional groups.

15-17. (canceled)

18. The electrochemical cell of claim 1, wherein the solvent comprises: MeCN, toluene, Et₂O, THF, hydrocarbons, ethers, amines, carbonates, esters, amides, polymers, ionic liquids, and/or a solvent of the general formula CₙHₘXₗ, wherein X is any heteroatom or any combination of heteroatoms, n is any non-zero integer, m is any integer, and l is any integer.

19. The method of claim 2, wherein said formation comprises a catalytic reaction.

20. The method of claim 2, wherein said formation comprises cation/anion exchange, halide abstraction, metalation, halide abstraction, chemical oxidation, dehydrofluorination, protonation and/or and any reactions that involve carbocations.

21. The method of claim 2, wherein the cation is a precatalyst cation, comprising:
activating the precatalyst cation by contacting the precatalyst cation with the weakly coordinating anion to form an activated catalyst; and
contacting the activated catalyst with the one or more reactants.

22. The method of claim 21, wherein the activated catalyst is a catalytically active cation.

23. The method of claim 22, wherein the catalytically active cation comprises a metal coordination complex.

24. The method of claim 2, wherein the one or more reactants comprise monomers and wherein the product comprises a polymer.

25. The method of claim 2, wherein the reactants comprise at least two different monomers and wherein the product comprises a copolymer.

26. A weakly coordinating anion of the formula:
[(R¹)ₘ—Si(Z)₂]⁻ (FX1)
or salts thereof;
wherein each Z is independently: 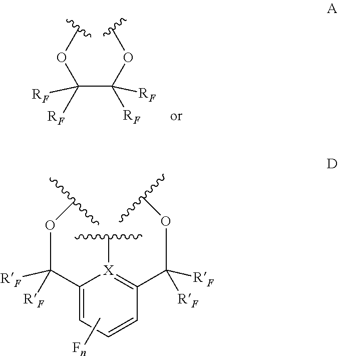
wherein:
m is 1 when both of Z are A, or m is zero;
X is C or N;
Fₙ represents one, two or three F on the indicated ring;
R_{F} is fluoroalkyl having 1-3 carbon atoms and two to seven fluorine atoms or fluorophenyl having 2-5 fluorine atoms on the ring;
R′_{F} is fluoroalkyl having 1-3 carbon atoms and two to seven fluorine atoms or fluorophenyl having 2-5 fluorine atoms on the ring; and
R¹ is substituted or unsubstituted alkyl having 1-30 carbon atoms, substituted or unsubstituted alkenyl having 2-30 carbon atoms, substituted or unsubstituted cycloalkyl having 3-30 carbon atoms and at least one carbocyclic ring, substituted or unsubstituted heterocyclic having 3-30 carbon atoms, 1-4 heteroatoms and at least one heterocyclic ring, 8 of 12 substituted or unsubstituted aryl having 1 or 2 aromatic rings which are optionally fused rings and having 5-30 carbon atoms, substituted or unsubstituted heteroaryl having 1 or 2 rings of which at least one is aromatic and which are optionally fused and having 3-30 carbon atoms and 1-4 heteroatoms, or substituted or unsubstituted alkoxyalkyl having 2-12 carbon atoms;
with the proviso that when m equals 1, each Z is A, and each R_{F} is a fluoroalkyl having 1 carbon atom and three fluorine atoms then R¹ is not unsubstituted phenyl.

27. A weakly coordinating dianion or trianion of the formula:
[Y-(E)_{N}]^{N-} (FX2)
or salts thereof;
wherein:
N is 2 or 3;
Y is substituted or unsubstituted alkyl having 1-30 carbon atoms, substituted or unsubstituted alkenyl having 2-30 carbon atoms, substituted or unsubstituted cycloalkyl having 3-30 carbon atoms and at least one carbocyclic ring, substituted or unsubstituted heterocyclic having 3-30 carbon atoms, 1-4 heteroatoms and at least one heterocyclic ring, substituted or unsubstituted aryl having 1-4 aromatic rings which are optionally fused rings and having 5-30 carbon atoms, substituted or unsubstituted heteroaryl having 1-4 rings of which at least one is aromatic and which are optionally fused and having 3-30 carbon atoms and 1-4 heteroatoms, or substituted or unsubstituted alkoxyalkyl having 2-12 carbon atoms; and
E is an anionic group having the structure: 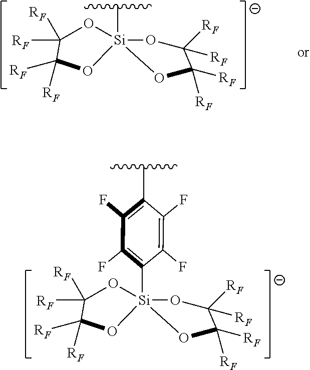
wherein R_{F} is fluoroalkyl having 1-3 carbon atoms and two to seven fluorine atoms or fluorophenyl having 2-5 fluorine atoms on the ring.
